(19) United States
(12) Patent Application Publication
(10) Pub. No.: US 2022/0188699 A1
(43) Pub. Date: Jun. 16, 2022

(54) MACHINE LEARNING TECHNIQUES FOR WEB RESOURCE FINGERPRINTING

(71) Applicant: BOMBORA, INC., New York, NY (US)

(72) Inventors: Erik G. MATLICK, Miami Beach, FL (US); Robert J. ARMSTRONG, Reno, NV (US); Nicholaus E. HALECKY, Reno, NV (US); Benny LIN, New York, NY (US)

(73) Assignee: BOMBORA, INC., New York, NY (US)

(21) Appl. No.: 17/199,268

(22) Filed: Mar. 11, 2021

Related U.S. Application Data
(63) Continuation-in-part of application No. 16/435,382, filed on Jun. 7, 2019, now abandoned.
Application No. 16/435,382 is a continuation-in-part of application No. 16/109,648, filed on Aug. 22, 2018, now abandoned.
(60) Provisional application No. 62/549,812, filed on Aug. 24, 2017.

(51) Int. Cl. G06N 20/00; G06N 5/04

(52) U.S. Cl. CPC G06N 20/00; G06F 21/6245; G06N 5/04

(57) ABSTRACT

Disclosed embodiments include a resource classification system (RCS) identifies one or more features in information objects (InObs) and uses the features to classify the InObs. The features may be based on structural semantics of the InObs, content semantics of InObs, content interaction behavior with the InObs, types of users accessing the InObs, and/or the like. The RCS may generate vectors that represent the different features. The vectors may be used to train a machine learning model to predict resource classifications of the InObs. The predicted resource classifications provide more accurate intent, consumption, and surge score predictions than existing solutions. Other embodiments may be described and/or claimed.

### RELATED APPLICATIONS

The present application is a continuation-in-part (CIP) of U.S. app. Ser. No. 16/435,382 filed on Jun. 7, 2019, which is a CIP of U.S. app. Ser. No. 16/109,648 filed Aug. 22, 2018, which claims priority to U.S. Provisional App. No. 62/549,812 filed Aug. 24, 2017, the contents of each of which are hereby incorporated by reference in their entireties.

### TECHNICAL FIELD

Embodiments described herein generally relate to machine learning (ML) and artificial intelligence (AI), and in particular, ML/AI techniques for classifying web resources.

### BACKGROUND

Users receive a random variety of different information from a random variety of different businesses. For example, users may constantly receive promotional announcements, advertisements, information notices, event notifications, etc. Users request some of this information. For example, a user may register on a company website to receive sales or information announcements. However, much of the information is of little or no interest to the user. For example, the user may receive emails announcing every upcoming seminar, regardless of the subject matter. The user may also receive unsolicited information. For example, a user may register on a website to download a white paper on a particular subject. A lead service then may sell the email address to companies that send the user unsolicited advertisements. Users end up ignoring most or all of these emails since most of the information has no relevance or interest. Alternatively, the user directs all of these emails into a junk email folder.

### BRIEF DESCRIPTION OF THE DRAWINGS

FIG. 1 depicts an example content consumption monitor (CCM).

FIG. 2 depicts an example of the CCM in more detail.

FIG. 3 depicts an example operation of a CCM tag.

FIG. 4 depicts example events processed by the CCM.

FIG. 5 depicts an example user intent vector.

FIG. 6 depicts an example process for segmenting users.

FIG. 7 depicts an example process for generating organization (org) intent vectors.

FIG. 8 depicts an example consumption score generator.

FIG. 9 depicts the example consumption score generator in more detail.

FIG. 10 depicts an example process for identifying a surge in consumption scores.

FIG. 11 depicts an example process for calculating initial consumption scores.

FIG. 12 depicts an example process for adjusting the initial consumption scores based on historic baseline events.

FIG. 13 depicts an example process for mapping surge topics with contacts.

FIG. 14 depicts an example content consumption monitor calculating content intent.

FIG. 15 depicts an example process for adjusting a consumption score based on content intent.

FIG. 16 depicts an example resource classifier according to various embodiments.

FIG. 17 depicts an example process for resource classification.

FIG. 18 depicts an example CCM that uses a resource classifier.

FIG. 19 depicts an example structural semantic network graph for resources or information objects according to various embodiments.

FIG. 20 depicts example features generated for the information objects of FIG. 19 according to various embodiments.

FIG. 21 depicts example vector embeddings generated for the features of FIG. 20 according to various embodiments.

FIG. 22 depicts an example machine learning (ML) model trained using the vector embeddings of FIG. 21 according to various embodiments.

FIG. 23 depicts an example ML model configured to classify resources based on associated vector embeddings according to various embodiments.

FIG. 24 depicts an example computing system suitable for practicing various aspects of the various embodiments discussed herein.

### DETAILED DESCRIPTION

Embodiments disclosed herein are related to machine learning (ML) techniques for classifying resources such as information objects (InObs), electronic documents, applications, files, webpages, websites, web apps, and/or the like. In disclosed embodiments, a resource classifier distinguishes user-content-interactions to classify individual resources, identify new/unknown resources having similarity to other known classes and/or a desired class, and generally better understand resources and/or content. The disclosed embodiments provide an improvement over existing solutions at least based on the sheer scale of today's networks, such as the Internet which includes billions of web resources with billions of connections. The existing solutions cannot scale to the sheer size of such networks, and thus, cannot classify web resources without expending extremely large amounts of computing and network resources, and without consuming an extremely large amount of time. Thus, the embodiments herein provide novel vector embedding techniques for representing different resource features and predicting resource classes.

In some embodiments, a content consumption monitor (CCM) may use these classifications and/or predictions to generate consumption scores and/or surge scores/signals. Such embodiments allow the CCM to generate more accurate intent data than existing/conventional solutions by better predicting intent and/or interest levels for specific orgs. The CCM uses processing resources more efficiently by generating more accurate consumption scores and/or surge scores/signals. The CCM may also provide more secure network analytics by generating consumption scores and/or surge scores/signals for orgs without using personally identifiable information (PII), sensitive data, and/or confidential data, thereby improving information security for end-users.

The resource classifications and/or intent predictions can be used to more efficiently process events, more accurately calculate consumption scores, and more accurately detect associated surges such as org surges (also referred to as “company surges” or the like). The more accurate intent data and consumptions scores allow third party service providers to conserve computational and network resources by providing a means for better targeting users so that unwanted and seemingly random content is not distributed to users that do not want such content. This is a technological improvement in that it conserves network and computational resources of organizations (orgs) that distribute this content by reducing the amount of content generated and sent to end-user devices. Network resources may be reduced and/or conserved at end-user devices by reducing or eliminating the need for using resources to receive unwanted content, and computational resources may be reduced and/or conserved at end-user devices by reducing or eliminating the need to implement spam filters and/or reducing the amount of data to be processed when analyzing and/or deleting such content. This amounts to an improvement in the technological fields of machine learning and web tracking technologies, and also amounts to an improvement in the functioning of computing systems and computing networks themselves. Furthermore, since the classifications and predictions identify specific orgs associated with a particular network addresses and InObs of interest to those orgs, the embodiments discussed herein can be used for other use cases such as, for example, network troubleshooting, anti-spam and anti-phishing technologies (e.g., for email systems and the like), cybersecurity threat detection and tracking, system/network monitoring and logging, network resource allocation and/or network appliance topology optimization, and/or the like.

### 1. Machine Learning Aspects

Machine learning (ML) involves programming computing systems to optimize a performance criterion using example (training) data and/or past experience. ML involves using algorithms to perform specific task(s) without using explicit instructions to perform the specific task(s), but instead relying on learnt patterns and/or inferences. ML uses statistics to build mathematical model(s) (also referred to as “ML models” or simply “models”) in order to make predictions or decisions based on sample data (e.g., training data). The model is defined to have a set of parameters, and learning is the execution of a computer program to optimize the parameters of the model using the training data or past experience. The trained model may be a predictive model that makes predictions based on an input dataset, a descriptive model that gains knowledge from an input dataset, or both predictive and descriptive. Once the model is learned (trained), it can be used to make inferences (e.g., predictions).

ML algorithms perform a training process on a training dataset to estimate an underlying ML model. An ML algorithm is a computer program that learns from experience with respect to some task(s) and some performance measure(s)/metric(s), and an ML model is an object or data structure created after an ML algorithm is trained with training data. In other words, the term “ML model” or “model” may describe the output of an ML algorithm that is trained with training data. After training, an ML model may be used to make predictions on new datasets. Additionally, separately trained AI/ML models can be chained together in a AI/ML pipeline during inference or prediction generation. Although the term “ML algorithm” refers to different concepts than the term “ML model,” these terms may be used interchangeably for the purposes of the present disclosure.

ML techniques generally fall into the following main types of learning problem categories: supervised learning, unsupervised learning, and reinforcement learning. Supervised learning is an ML task that aims to learn a mapping function from the input to the output, given a labeled data set. Supervised learning algorithms build models from a set of data that contains both the inputs and the desired outputs. For example, supervised learning may involve learning a function (model) that maps an input to an output based on example input-output pairs or some other form of labeled training data including a set of training examples. Each input-output pair includes an input object (e.g., a vector) and a desired output object or value (referred to as a “supervisory signal”). Supervised learning can be grouped into classification algorithms, regression algorithms, and instance-based algorithms.

Classification, in the context of ML, refers to an ML technique for determining the classes to which various data points belong. Here, the term “class” or “classes” may refer to categories, and are sometimes called “targets” or “labels.” Classification is used when the outputs are restricted to a limited set of quantifiable properties. Classification algorithms may describe an individual (data) instance whose category is to be predicted using a feature vector. As an example, when the instance includes a collection (corpus) of text, each feature in a feature vector may be the frequency that specific words appear in the corpus of text. In ML classification, labels are assigned to instances, and models are trained to correctly predict the pre-assigned labels of from the training examples. ML algorithms for classification may be referred to as a “classifier.” Examples of classifiers include linear classifiers, k-nearest neighbor (kNN), decision trees, random forests, support vector machines (SVMs), Bayesian classifiers, convolutional neural networks (CNNs), among many others (note that some of these algorithms can be used for other ML tasks as well).

A regression algorithm and/or a regression analysis, in the context of ML, refers to a set of statistical processes for estimating the relationships between a dependent variable (often referred to as the “outcome variable”) and one or more independent variables (often referred to as “predictors”, “covariates”, or “features”). Examples of regression algorithms/models include logistic regression, linear regression, gradient descent (GD), stochastic GD (SGD), and the like.

Instance-based learning (sometimes referred to as “memory-based learning”), in the context of ML, refers to a family of learning algorithms that, instead of performing explicit generalization, compares new problem instances with instances seen in training, which have been stored in memory. Examples of instance-based algorithms include k-nearest neighbor, and the like), decision tree Algorithms (e.g., Classification And Regression Tree (CART), Iterative Dichotomiser 3 (ID3), C4.5, chi-square automatic interaction detection (CHAID), etc.), Fuzzy Decision Tree (FDT), and the like), Support Vector Machines (SVM), Bayesian Algorithms (e.g., Bayesian network (BN), a dynamic BN (DBN), Naive Bayes, and the like), and ensemble algorithms (e.g., Extreme Gradient Boosting, voting ensemble, bootstrap aggregating (“bagging”), Random Forest, and the like.

In the context of ML, an “ML feature” (or simply “feature”) is an individual measureable property or characteristic of a phenomenon being observed. Features are usually represented using numbers/numerals (e.g., integers), strings, variables, ordinals, real-values, categories, and/or the like. Additionally or alternatively, ML features are individual variables, which may be independent variables, based on observable phenomenon that can be quantified and recorded. ML models use one or more features to make predictions or inferences. In some implementations, new features can be derived from old features. A set of features may be referred to as a “feature vector.” A vector is a tuple of one or more values called scalars, and a feature vector may include a tuple of one or more features. The vector space associated with these vectors is often called a “feature space.” In order to reduce the dimensionality of the feature space, a number of dimensionality reduction techniques can be employed.

Unsupervised learning is an ML task that aims to learn a function to describe a hidden structure from unlabeled data. Unsupervised learning algorithms build models from a set of data that contains only inputs and no desired output labels. Unsupervised learning algorithms are used to find structure in the data, like grouping or clustering of data points. Some examples of unsupervised learning are K-means clustering, principal component analysis (PCA), and topic modeling, among many others. In particular, topic modeling is an unsupervised machine learning technique scans a set of InObs (e.g., documents, webpages, files, data structures, etc.), detects word and phrase patterns within the InObs, and automatically clusters word groups and similar expressions that best characterize the set of InObs. Semi-supervised learning algorithms develop ML models from incomplete training data, where a portion of the sample input does not include labels. One example of unsupervised learning is topic modeling. Topic modeling involves counting words and grouping similar word patterns to infer topics within unstructured data. By detecting patterns such as word frequency and distance between words, a topic model clusters feedback that is similar, and words and expressions that appear most often. With this information, the topics of individual set of texts can be quickly deduced.

Reinforcement learning (RL) is a goal-oriented learning based on interaction with environment. In RL, an agent aims to optimize a long-term objective by interacting with the environment based on a trial and error process. Examples of RL algorithms include Markov decision process, Markov chain, Q-learning, multi-armed bandit learning, and deep RL.

An artificial neural network or neural network (NN) encompasses a variety of ML techniques where a collection of connected artificial neurons or nodes that (loosely) model neurons in a biological brain that can transmit signals to other arterial neurons or nodes, where connections (or edges) between the artificial neurons or nodes are (loosely) modeled on synapses of a biological brain. The artificial neurons and edges typically have a weight that adjusts as learning proceeds. The weight increases or decreases the strength of the signal at a connection. Neurons may have a threshold such that a signal is sent only if the aggregate signal crosses that threshold. The artificial neurons can be aggregated or grouped into one or more layers where different layers may perform different transformations on their inputs. Signals travel from the first layer (the input layer), to the last layer (the output layer), possibly after traversing the layers multiple times. NNs are usually used for supervised learning, but can be used for unsupervised learning as well. Examples of NNs include deep NN (DNN), feed forward NN (FFN), a deep FNN (DFF), convolutional NN (CNN), deep CNN (DCN), deconvolutional NN (DNN), a deep belief NN, a perception NN, recurrent NN (RNN) (e.g., including Long Short Term Memory (LSTM) algorithm, gated recurrent unit (GRU), etc.), deep stacking network (DSN).

ML may require, among other things, obtaining and cleaning a dataset, performing feature selection, selecting an ML algorithm, dividing the dataset into training data and testing data, training a model (e.g., using the selected ML algorithm), testing the model, optimizing or tuning the model, and determining metrics for the model. Some of these tasks may be optional or omitted depending on the use case and/or the implementation used. ML algorithms accept parameters and/or hyperparameters (collectively referred to herein as “training parameters,” “model parameters,” or simply “parameters” herein) that can be used to control certain properties of the training process and the resulting model.

Parameters are characteristics or properties of the training process that are learnt during training. Model parameters may differ for individual experiments and may depend on the type of data and ML tasks being performed. Hyperparameters are characteristics, properties, or parameters for a training process that cannot be learnt during the training process and are set before training takes place. The particular values selected for the parameters and/or hyperparameters affect the training speed, training resource consumption, and the quality of the learning process. As examples, model parameters for topic classification/modeling, natural language processing (NLP), and/or natural language understanding (NLU) may include word frequency, sentence length, noun or verb distribution per sentence, the number of specific character n-grams per word, lexical diversity, constraints, weights, and the like. Examples of hyperparameters may include model size (e.g., in terms of memory space or bytes), whether (and how much) to shuffle the training data, the number of evaluation instances or epochs (e.g., a number of iterations or passes over the training data), learning rate (e.g., the speed at which the algorithm reaches (converges to) the optimal weights), learning rate decay (or weight decay), the number and size of the hidden layers, weight initialization scheme, dropout and gradient clipping thresholds, and the like. In embodiments, the parameters and/or hyperparameters may additionally or alternatively include vector size and/or word vector size.

Any of the aforementioned ML techniques may be utilized, in whole or in part, and variants and/or combinations thereof, for any of the example embodiments discussed herein.

### 2. Content Consumption Monitor Embodiments

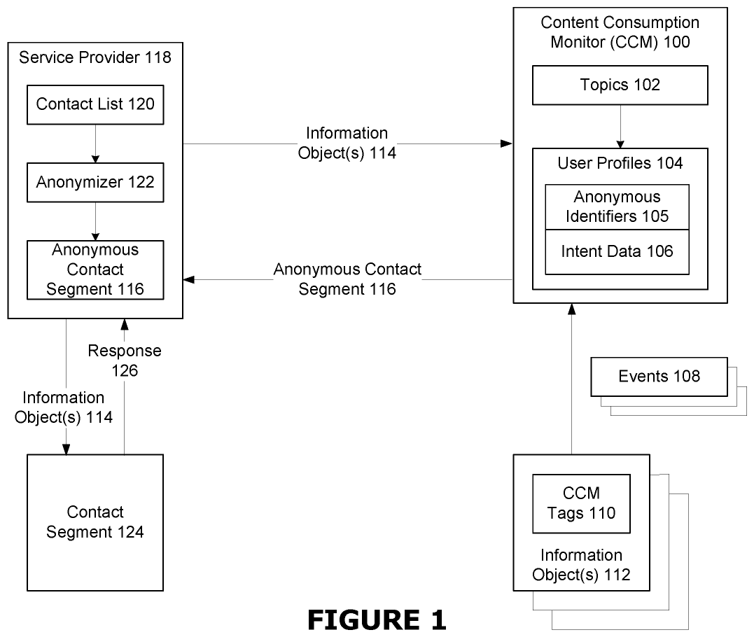

FIG. 1 depicts a content consumption monitor (CCM) 100. CCM 100 includes one or more physical and/or virtualized systems that communicates with a service provider 118 and monitors user accesses to one or more information objects 112 (InObs) such as, for example, third party content and/or the like. The physical and/or virtualized systems include one or more logically or physically connected servers and/or data storage devices distributed locally or across one or more geographic locations. In some implementations, the CCM 100 may be provided by (or operated by) a cloud computing service and/or a cluster of machines in a datacenter. In some implementations, the CCM 100 may be a distributed application provided by (or operated by) various servers of a content delivery network (CDN) or edge computing network. Other implementations are possible in other embodiments.

Service provider 118 (also referred to as a “publisher,” “B2B publisher,” or the like) comprises one or more physical and/or virtualized computing systems owned and/or operated by a company, enterprise, and/or individual that wants to send InOb(s) 114 to an interested group of users, which may include targeted content or the like. This group of users is alternatively referred to as “contact segment 124.” The physical and/or virtualized systems include one or more logically or physically connected servers and/or data storage devices distributed locally or across one or more geographic locations. Generally, the service provider 118 uses IP/network resources to provide InObs such as electronic documents, webpages, forms, applications (e.g., web apps), data, services, web services, media, and/or content to different user/client devices. As examples, the service provider 118 may provide search engine services; social media/networking services; content (media) streaming services; e-commerce services; blockchain services; communication services; immersive gaming experiences; and/or other like services. The user/client devices that utilize services provided by service provider 118 may be referred to as “subscribers.” Although FIG. 1 shows only a single service provider 118, the service provider 118 may represent multiple service providers 118, each of which may have their own subscribing users.

In one example, service provider 118 may be a company that sells electric cars. Service provider 118 may have a contact list 120 of email addresses for customers that have attended prior seminars or have registered on the service provider's 118 website. Contact list 120 may also be generated by CCM tags 110 that are described in more detail below. Service provider 118 may also generate contact list 120 from lead lists provided by third parties lead services, retail outlets, and/or other promotions or points of sale, or the like or any combination thereof. Service provider 118 may want to send email announcements for an upcoming electric car seminar Service provider 118 would like to increase the number of attendees at the seminar. In another example, service provider 118 may be a platform or service provider that offers a variety of user targeting services to their subscribers such as sales enablement, digital advertising, content/engagement marketing, and marketing automation, among others.

The InObs 112 comprise any data structure including or indicating information on any subject accessed by any user. The InObs 112 may include any type of InOb (or collection of InObs). InObs 112 may include electronic documents, database objects, electronic files, resources, and/or any data structure that includes one or more data elements, each of which may include one or more data values and/or content items.

In some implementations, the InObs 112 may include webpages provided on (or served) by one or more web servers and/or application servers operated by different service provides, businesses, and/or individuals. For example, InObs 112 may come from different websites operated by online retailers and wholesalers, online newspapers, universities, blogs, municipalities, social media sites, or any other entity that supplies content. Additionally or alternatively, InObs 112 may also include information not accessed directly from websites. For example, users may access registration information at seminars, retail stores, and other events. InObs 112 may also include content provided by service provider 118. Additionally, InObs 112 may be associated with one or more topics 102. The topic 102 of an InOb 112 may refer to the subject, meaning, and/or theme of that InOb 112.

The CCM 100 may identify or determine one or more topics 102 of an InOb 112 using a topic analysis model/technique. Topic analysis (also referred to as “topic detection,” “topic modeling,” or “topic extraction”) refers to ML techniques that organize and understand large collections of text data by assigning tags or categories according to each individual InOb's 112 topic or theme. A topic model is a type of statistical model used for discovering topics 102 that occur in a collection of InObs 112 or other collections of text. A topic model may be used to discover hidden semantic structures in the InObs 112 or other collections of text. In one example, a topic classification technique is used, where a topic classification model is trained on a set of training data (e.g., InObs 112 labeled with tags/topics 102) and then tested on a set of test data to determine how well the topic classification model classifies data into different topics 102. Once trained, the topic classification model is used to determine/predict topics 102 in various InObs 112. In another example, a topic modeling technique is used, where a topic modeling model automatically analyzes InObs 112 to determine cluster words for a set of documents. Topic modeling is an unsupervised ML technique that does not require training using training data. Any suitable NLP/NLU techniques may be used for the topic analysis in various embodiments.

Computers and/or servers associated with service provider 118, content segment 124, and the CCM 100 may communicate over the Internet or any other wired or wireless network including local area networks (LANs), wide area networks (WANs), wireless networks, cellular networks, WiFi networks, Personal Area Networks (e.g., Bluetooth® and/or the like), Digital Subscriber Line (DSL) and/or cable networks, and/or the like, and/or any combination thereof.

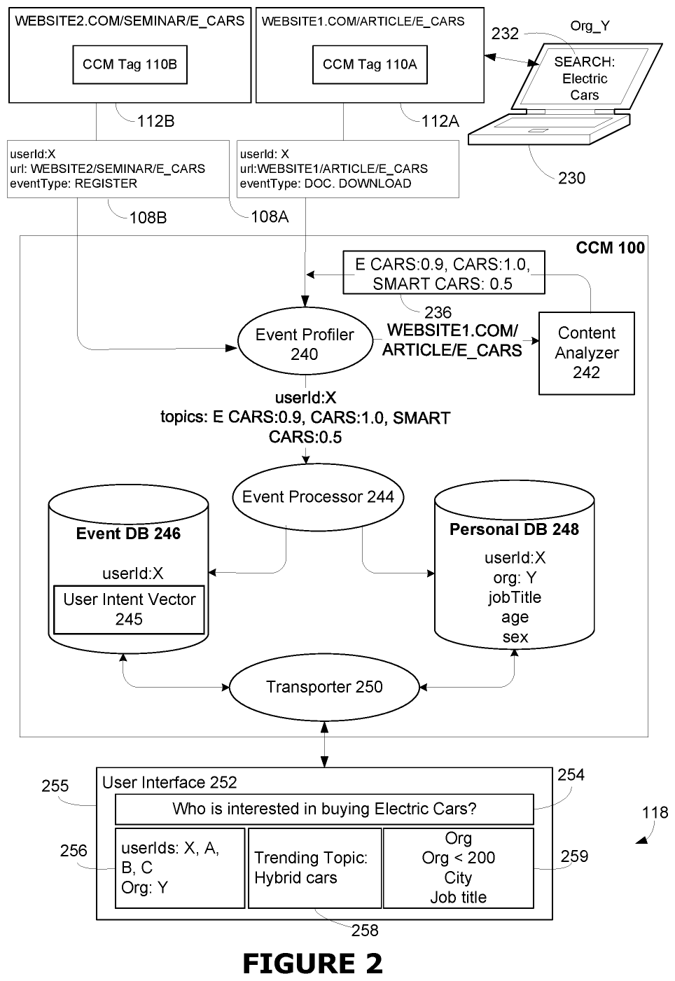

Some of InObs 112 contain CCM tags 110 that capture and send network session events 108 (or simply “events 108”) to CCM 100. For example, CCM tags 110 may comprise JavaScript added to webpages of a website (or individual components of a web app or the like). The website downloads the webpages, along with CCM tags 110, to user computers (e.g., computer 230 of FIG. 2). CCM tags 110 monitor network sessions (or web sessions) and sends some or all captured session events 108 to CCM 100.

In one example, the CCM tags 110 may intercept or otherwise obtain HTTP messages being sent by and/or sent to a computer 230, and these HTTP messages may be provided to the CCM 100 as the events 108. In this example, the CCM tags 110 or the CCM 100 may extract or otherwise obtain a network address of the computer 230 from an X-Forwarded-For (XFF) field of the HTTP header, a time and date that the HTTP message was sent from a Date field of the HTTP header, and/or a user agent string contained in a User Agent field of an HTTP header of the HTTP message. The user agent string may indicate the operating system (OS) type/version of the sending device (e.g., a computer 230); system information of the sending device (e.g., a computer 230); browser version/type of the sending device (e.g., a computer 230); rendering engine version/type of the sending device (e.g., a computer 230); a device type of the of the sending device (e.g., a computer 230), as well as other information. In another example, the CCM tags 110 may derive various information from the computer 230 that is not typically included in an HTTP header, such as time zone information, GPS coordinates, screen or display resolution of the computer 230, data from one or more applications operated by the computer 230, and/or other like information. In various implementations, the CCM tags 110 may generate and send events 108 or messages based on the monitored network session. For example, the CCM tags 110 may obtain data when various events/triggers are detected, and may send back information (e.g., in additional HTTP messages). Other methods may be used to obtain or derive user information.

In some implementations, the InObs 112 that include CCM tags 110 may be provided or hosted by a collection of service providers 118 such as, for example, notable business-to-business (B2B) publishers, marketers, agencies, technology providers, research firms, events firms, and/or any other desired entity/org type. This collection of service providers 118 may be referred to as a “data cooperative” or “data co-op.” Additionally or alternatively, events 108 may be collected by one or more other data tracking entities separate from the CCM 100, and provided as one or more datasets to the CCM 100 (e.g., a “bulk” dataset or the like).

Events 108 may identify InObs 112 and identify the user accessing InObs 112. For example, event 108 may include a URL link to InObs 112 and may include a hashed user email address or cookie identifier (ID) associated with the user that accessed InObs 112. Events 108 may also identify an access activity associated with InObs 112. For example, an event 108 may indicate the user viewed a webpage, downloaded an electronic document, or registered for a seminar Additionally or alternatively, events 108 may identify various user interactions with InObs 112 such as, for example, topic consumption, scroll velocity, dwell time, and/or other user interactions such as those discussed herein. In one example, the tags 110 may collect anonymized information about a visiting user's network address (e.g., IP address), an anonymized cookie ID, a timestamp of when the user visited or accessed an InOb 112, and/or geo-location information associated with the user's computing device. In some embodiments, device fingerprinting can be used to track users, while in other embodiments, device fingerprinting may be excluded to preserver user anonymity.

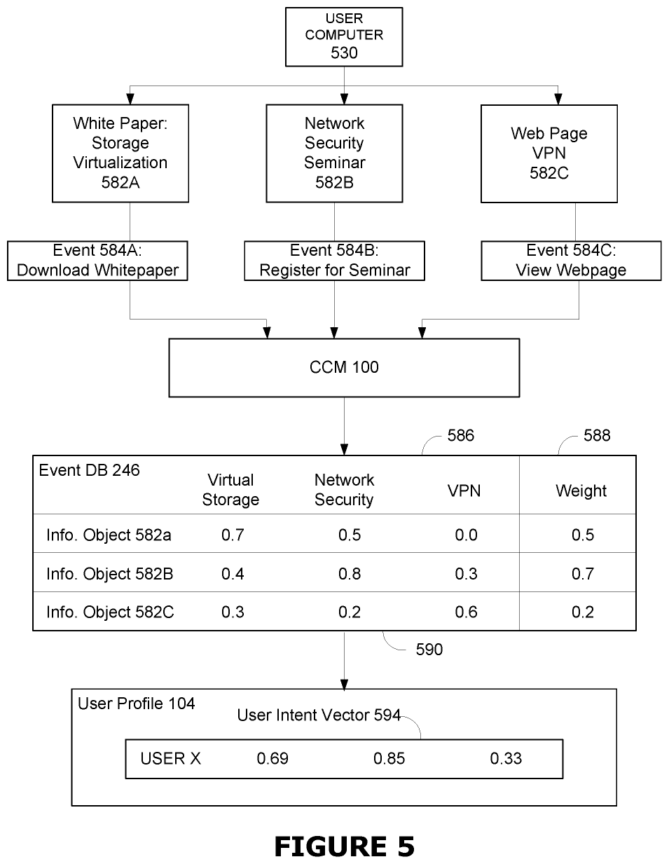

CCM 100 builds user profiles 104 from events 108. User profiles 104 may include anonymous identifiers 105 that associate InObs 112 with particular users. User profiles 104 may also include intent data 106. Intent data 106 includes or indicates insights into users' interests and may include predictions about their potential to take certain actions based on their content consumption. The intent data 106 identifies or indicates topics 102 in InObs 112 accessed by the users. For example, intent data 106 may comprise a user intent vector (e.g., user intent vector 245 of FIG. 2, intent vector 594 of FIG. 5, etc.) that identifies or indicates the topics 102 and identifies levels of user interest in the topics 102.

This approach to intent data 106 collection makes possible a consistent and stable historical baseline for measuring content consumption. This baseline effectively spans the web, delivering at an exponential scale greater than any one site. In embodiments, the CCM 100 monitors content consumption behavior from a collection of service providers 118 (e.g., the aforementioned data co-op) and applies data science and/or ML techniques to identify changes in activity compared to the historical baselines. As examples, research frequency, depth of engagement, and content relevancy all contribute to measuring an org's interest in topic(s) 102. In some embodiments, the CCM 100 may employ an NLP/NLU engine that reads, deciphers, and understands content across a taxonomy of intent topics 102 that grows on a periodic basis (e.g., monthly, weekly, etc.). The NLP/NLU engine may operate or execute the topic analysis models discussed previously.

As mentioned previously, service provider 118 may want to send an email announcing an electric car seminar to a particular contact segment 124 of users interested in electric cars. Service provider 118 may send InOb(s) 114, such as the aforementioned email to CCM 100, and the CCM 100 identifies topics 102 in InOb(s) 114. The CCM 100 compares content topics 102 with the intent data 106, and identifies user profiles 104 that indicate an interest in InOb(s) 114. Then, the CCM 100 sends an anonymous contact segment 116 to service provider 118, which includes anonymized or pseudonymized identifiers 105 associated with the identified user profiles 104. In some embodiments, the CCM 100 includes an anonymizer or pseudonymizer, which is the same or similar to anonymizer 122, to anonymize or pseudonymize user identifiers.

Contact list 120 may include personally identifying information (PII) and/or personal data such as email addresses, names, phone numbers, or some other user identifier(s), or any combination thereof. Additionally or alternatively, the contact list 120 may include sensitive data and/or confidential information. The personal, sensitive, and/or confidential data in contact list 120 are anonymized or pseudonymized or otherwise de-identified by an anonymizer 122.

The anonymizer 122 may anonymize or pseudonymize any personal, sensitive, and/or confidential data using any number of data anonymization or pseudonymization techniques including, for example, data encryption, substitution, shuffling, number and date variance, and nulling out specific fields or data sets. Data encryption is an anonymization or pseudonymization technique that replaces personal/sensitive/confidential data with encrypted data. A suitable hash algorithm may be used as an anonymization or pseudonymization technique in some embodiments. Anonymization is a type of information sanitization technique that removes personal, sensitive, and/or confidential data from data or datasets so that the person or information described or indicated by the data/datasets remain anonymous. Pseudonymization is a data management and de-identification procedure by which personal, sensitive, and/or confidential data within InObs (e.g., fields and/or records, data elements, documents, etc.) is/are replaced by one or more artificial identifiers, or pseudonyms. In most pseudonymization mechanisms, a single pseudonym is provided for each replaced data item or a collection of replaced data items, which makes the data less identifiable while remaining suitable for data analysis and data processing. Although “anonymization” and “pseudonymization” refer to different concepts, these terms may be used interchangeably throughout the present disclosure.

The service provider 118 compares the anonymized/pseudonymized identifiers (e.g., hashed identifiers) from contact list 120 with the anonymous identifiers 105 in anonymous contact segment 116. Any matching identifiers are identified as contact segment 124. Service provider 118 identifies the unencrypted email addresses in contact list 120 associated with contact segment 124. Service provider 118 sends InOb(s) 114 to the addresses (e.g., email addresses) identified for contact segment 124. For example, service provider 118 may send an email announcing the electric car seminar to contact segment 124.

Sending InOb(s) 114 to contact segment 124 may generate a substantial lift in the number of positive responses 126. For example, assume service provider 118 wants to send emails announcing early bird specials for the upcoming seminar. The seminar may include ten different tracks, such as electric cars, environmental issues, renewable energy, etc. In the past, service provider 118 may have sent ten different emails for each separate track to everyone in contact list 120.

Service provider 118 may now only send the email regarding the electric car track to contacts identified in contact segment 124. The number of positive responses 126 registering for the electric car track of the seminar may substantially increase since content 114 is now directed to users interested in electric cars.

In another example, CCM 100 may provide local ad campaign or email segmentation. For example, CCM 100 may provide a “yes” or “no” as to whether a particular advertisement should be shown to a particular user. In this example, CCM 100 may use the hashed data without re-identification of users and the “yes/no” action recommendation may key off of a de-identified hash value.

CCM 100 may revitalize cold contacts in service provider contact list 120. CCM 100 can identify the users in contact list 120 that are currently accessing other InObs 112 and identify the topics associated with InObs 112. By monitoring accesses to InObs 112, CCM 100 may identify current user interests even though those interests may not align with the content currently provided by service provider 118. Service provider 118 might reengage the cold contacts by providing content 114 more aligned with the most relevant topics identified in InObs 112.

FIG. 2 is a diagram explaining the content consumption manager in more detail. A user may enter a search query 232 into a computer 230, for example, via a search engine. The computer 230 may include any communication and/or processing device including but not limited to desktop computers, workstations, laptop computers, smartphones, tablet computers, wearable devices, servers, smart appliances, network appliances, and/or the like, or any combination thereof. The user may work for an organization Y (org_Y). For example, the user may have an associated email address: user@org_y.com.

In response to search query 232, the search engine may display links or other references to InObs 112A and 112B on website1 and website2, respectively (note that websitel and website2 may also be respective InObs 112 or collections of InObs 112). The user may click on the link to websitel, and websitel may download a webpage to a client app operated by computer 230 that includes a link to InOb 112A, which may be a white paper in this example. Website1 may include one or more webpages with CCM tags 110A that capture different events 108 during a network session (or web session) between websitel and computer 230 (or between websitel and the client app operated by computer 230). Websitel or another website may have downloaded a cookie onto a web browser operating on computer 230. The cookie may comprise an identifier X, such as a unique alphanumeric set of characters associated with the web browser on computer 230.

During the session with websitel, the user of computer 230 may click on a link to white paper 112A. In response to the mouse click, CCM tag 110A may download an event 108A to CCM 100. Event 108A may identify the cookie identifier X loaded on the web browser of computer 230. In addition, or alternatively, CCM tag 110A may capture a user name and/or email address entered into one or more webpage fields during the session. CCM tag 110 hashes the email address and includes the hashed email address in event 108A. Any identifier associated with the user is referred to generally as user X or user ID.

CCM tag 110A may also include a link in event 108A to the white paper downloaded from websitel to computer 230. For example, CCM tag 110A may capture the URL for white paper 112A. CCM tag 110A may also include an event type identifier in event 108A that identifies an action or activity associated with InOb 112A. For example, CCM tag 110A may insert an event type identifier into event 108A that indicates the user downloaded an electric document.

CCM tag 110A may also identify the launching platform for accessing InOb 112B. For example, CCM tag 110B may identify a link www.searchengine.com to the search engine used for accessing websitel.

An event profiler 240 in CCM 100 forwards the URL identified in event 108A to a content analyzer 242. Content analyzer 242 generates a set of topics 236 associated with or suggested by white paper 112A. For example, topics 236 may include electric cars, cars, smart cars, electric batteries, etc. Each topic 236 may have an associated relevancy score indicating the relevancy of the topic in white paper 112A. Content analyzers that identify topics in documents are known to those skilled in the art and are therefore not described in further detail.

Event profiler 240 forwards the user ID, topics 236, event type, and any other data from event 108A to event processor 244. Event processor 244 may store personal information captured in event 108A in a personal database 248. For example, during the session with websitel, the user may have entered an employer company name into a webpage form field. CCM tag 110A may copy the employer company name into event 108A. Alternatively, CCM 100 may identify the company name from a domain name of the user email address.

Event processor 244 may store other demographic information from event 108A in personal database 248, such as user job title, age, sex, geographic location (postal address), etc. In one example, some of the information in personal database 248 is hashed, such as the user ID and or any other personally identifiable information. Other information in personal database 248 may be anonymous to any specific user, such as org name and job title.

Event processor 244 builds a user intent vector 245 from topic vectors 236. Event processor 244 continuously updates user intent vector 245 based on other received events 108. For example, the search engine may display a second link to website2 in response to search query 132. User X may click on the second link and website2 may download a webpage to computer 230 announcing the seminar on electric cars.

The webpage downloaded by website2 may also include a CCM tag 110B. User X may register for the seminar during the session with website2. CCM tag 110B may generate a second event 108B that includes the user ID: X, a URL link to the webpage announcing the seminar, and an event type indicating the user registered for the electric car seminar advertised on the webpage.

CCM tag 110B sends event 108B to CCM 100. Content analyzer 242 generates a second set of topics 236. Event 108B may contain additional personal information associated with user X. Event processor 244 may add the additional personal information to personal database 248.

Event processor 244 updates user intent vector 245 based on the second set of topics 236 identified for event 108B. Event processor 244 may add new topics to user intent vector 245 or may change the relevancy scores for existing topics. For example, topics identified in both event 108A and 108B may be assigned higher relevancy scores. Event processor 244 may also adjust relevancy scores based on the associated event type identified in events 108.

Service provider 118 may submit a search query 254 to CCM 100 via a user interface 252 on a computer 255. For example, search query 254 may ask “who is interested in buying electric cars?” A transporter 250 in CCM 100 searches user intent vectors 245 for electric car topics with high relevancy scores. Transporter 250 may identify user intent vector 245 for user X. Transporter 250 identifies user X and other users A, B, and C interested in electric cars in search results 156.

As mentioned above, the user IDs may be hashed and CCM 100 may not know the actual identities of users X, A, B, and C. CCM 100 may provide a segment of hashed user IDs X, A, B, and C to service provider 118 in response to query 254.

Service provider 118 may have a contact list 120 of users (see e.g., FIG. 1). Service provider 118 may hash email addresses in contact list 120 and compare the hashed identifiers with the encrypted or hashed user IDs X, A, B, and C. Service provider 118 identifies the unencrypted email address for matching user identifiers. Service provider 118 then sends information related to electric cars to the email addresses of the identified user segment. For example, service provider 118 may send emails containing white papers, advertisements, articles, announcements, seminar notifications, or the like, or any combination thereof.

CCM 100 may provide other information in response to search query 254. For example, event processor 244 may aggregate user intent vectors 245 for users employed by the same company Y into an org intent vector. The org intent vector for org Y may indicate a strong interest in electric cars. Accordingly, CCM 100 may identify org Y in search results 156. By aggregating user intent vectors 245, CCM 100 can identify the intent of a company or other category without disclosing any specific user personal information (e.g., without regarding a user's online browsing activity).

CCM 100 continuously receives events 108 for different third party content. Event processor 244 may aggregate events 108 for a particular time period, such as for a current day, for the past week, or for the past 30 days. Event processor 244 then may identify trending topics 158 within that particular time period. For example, event processor 244 may identify the topics with the highest average relevancy values over the last 30 days.

Different filters 259 may be applied to the intent data stored in event database 246. For example, filters 259 may direct event processor 244 to identify users in a particular company Y that are interested in electric cars. In another example, filters 259 may direct event processor 244 to identify companies with less than 200 employees that are interested in electric cars.

Filters 259 may also direct event processor 244 to identify users with a particular job title that are interested in electric cars or identify users in a particular city that are interested in electric cars. CCM 100 may use any demographic information in personal database 248 for filtering query 254.

CCM 100 monitors content accessed from multiple different third party websites. This allows CCM 100 to better identify the current intent for a wider variety of users, companies, or any other demographics. CCM 100 may use hashed and/or other anonymous identifiers to maintain user privacy. CCM 100 further maintains user anonymity by identifying the intent of generic user segments, such as companies, marketing groups, geographic locations, or any other user demographics.

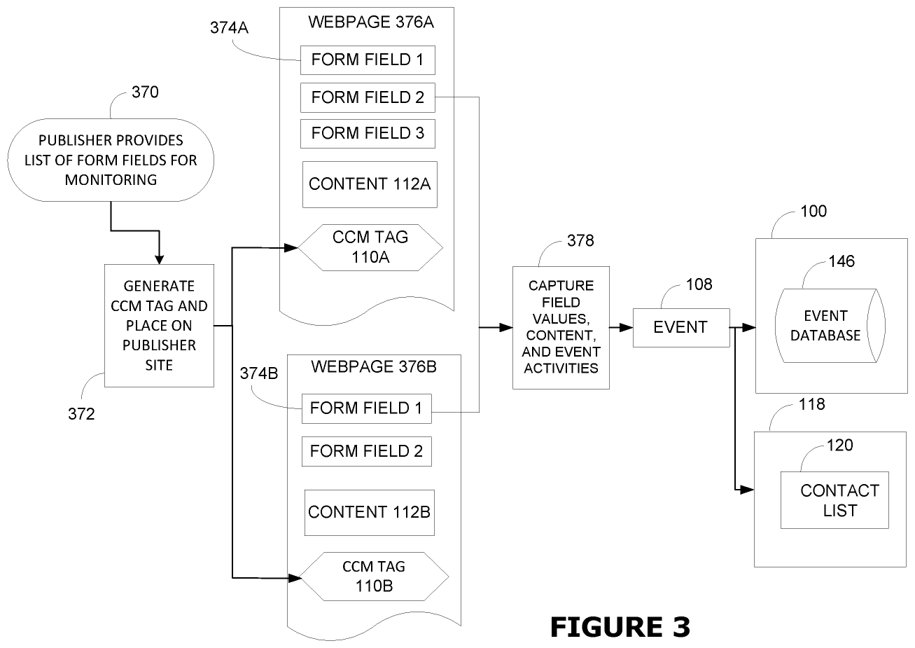

FIG. 3 depicts example operations performed by CCM tags 110 according to various embodiments. In operation 370, a service provider 118 provides a list of form fields 374 for monitoring on webpages 376. In operation 372, CCM tags 110 are generated and loaded in webpages 376 on the service provider's 118 website. For example, CCM tag 110A is loaded onto a first webpage 376A of the service provider's 118 website and a CCM tag 110B is loaded onto a second webpage 376B of the service provider's 118 website. In one example, CCM tags 110 comprise JavaScript loaded into the webpage document object model (DOM).

The service provider 118 may download webpages 376, along with CCM tags 110, to user computers (e.g., computer 230 of FIG. 2) during sessions. Additionally or alternatively, the CCM tags 110 may be executed when the user computers access and/or load the webpages 376 (e.g., within a browser, mobile app, or other client application). CCM tag 110A captures the data entered into some of form fields 374A and CCM tag 110B captures data entered into some of form fields 374B.

A user enters information into form fields 374A and 374B during the session. For example, the user may enter an email address into one of form fields 374A during a user registration process or a shopping cart checkout process. CCM tags 110 may capture the email address in operation 378, validate and hash the email address, and then send the hashed email address to CCM 100 in event 108.

CCM tags 110 may first confirm the email address includes a valid domain syntax and then use a hash algorithm to encode the valid email address string. CCM tags 110 may also capture other anonymous user identifiers, such as a cookie identifier. If no identifiers exist, CCM tag 110 may create a unique identifier. Other data may be captured as well, such as client app data, data mined from other applications, and/or other data from the user computers.

CCM tags 110 may capture any information entered into fields 374. For example, CCM tags 110 may also capture user demographic data, such as organization (org) name, age, sex, postal address, etc. In one example, CCM tags 110 capture some the information for service provider contact list 120.

CCM tags 110 may also identify InOb 112 and associated event activities in operation 378. For example, CCM tag 110A may detect a user downloading the white paper 112A or registering for a seminar (e.g., through an online form or the like hosted by websitel or some other website or web app). CCM tag 110A captures the URL for white paper 112A and generates an event type identifier that identifies the event as a document download.

Depending on the application, CCM tag 110 in operation 378 sends the captured web session information in event 108 to service provider 118 and/or to CCM 100. For example, event 108 is sent to service provider 118 when CCM tag 110 is used for generating service provider contact list 120. In another example, the event 108 is sent to CCM 100 when CCM tag 110 is used for generating intent data.

CCM tags 110 may capture session information in response to the user leaving webpage 376, existing one of form fields 374, selecting a submit icon, moussing out of one of form fields 374, mouse clicks, an off focus, and/or any other user action. Note again that CCM 100 might never receive personally identifiable information (PII) since any PII data in event 108 is hashed by CCM tag 110.

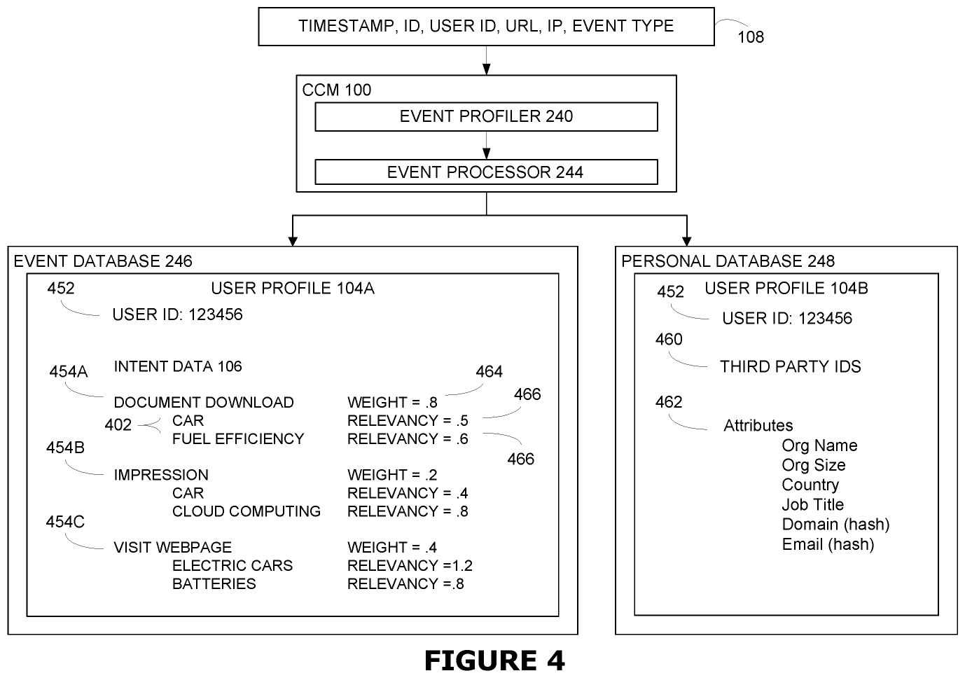

FIG. 4 is a diagram showing how the CCM generates intent data 106 according to various embodiments. As mentioned previously, a CCM tag 110 may send a captured raw event 108 to CCM 100. For example, the CCM tag 110 may send event 108 to CCM 100 in response to a user downloading a white paper. In this example, the event 108 may include a timestamp indicating when the white paper was downloaded, an identifier (ID) for event 108, a user ID associated with the user that downloaded the white paper, a URL for the downloaded white paper, and a network address for the launching platform for the content. Event 108 may also include an event type indicating, for example, that the user downloaded an electronic document.

Event profiler 240 and event processor 244 may generate intent data 106 from one or more events 108. Intent data 106 may be stored in a structured query language (SQL) database or non-SQL database. In one example, intent data 106 is stored in user profile 104A and includes a user ID 452 and associated event data 454.

Event data 454A is associated with a user downloading a white paper. Event profiler 240 identifies a car topic 402 and a fuel efficiency topic 402 in the white paper. Event profiler 240 may assign a 0.5 relevancy value to the car topic and assign a 0.6 relevancy value to the fuel efficiency topic 402.

Event processor 244 may assign a weight value 464 to event data 454A. Event processor 244 may assign larger a weight value 264 to more assertive events, such as downloading the white paper. Event processor 244 may assign a smaller weight value 464 to less assertive events, such as viewing a webpage. Event processor 244 may assign other weight values 464 for viewing or downloading different types of media, such as downloading a text, video, audio, electronic books, on-line magazines and newspapers, etc.

CCM 100 may receive a second event 108 for a second piece of content accessed by the same user. CCM 100 generates and stores event data 454B for the second event 108 in user profile 104A. Event profiler 240 may identify a first car topic with a relevancy value of 0.4 and identify a second cloud computing topic with a relevancy value of 0.8 for the content associated with event data 454B. Event processor 244 may assign a weight value of 0.2 to event data 454B.

CCM 100 may receive a third event 108 for a third piece of content accessed by the same user. CCM 100 generates and stores event data 454C for the third event 108 in user profile 104A. Event profiler 240 identifies a first topic associated with electric cars with a relevancy value of 1.2 and identifies a second topic associated with batteries with a relevancy value of 0.8. Event processor 244 may assign a weight value of 0.4 to event data 454C.

Event data 454 and associated weighting values 264 may provide a better indicator of user interests/intent. For example, a user may complete forms on a service provider website indicating an interest in cloud computing. However, CCM 100 may receive events 108 for third party content accessed by the same user. Events 108 may indicate the user downloaded a whitepaper discussing electric cars and registered for a seminar related to electric cars.

CCM 100 generates intent data 106 based on received events 108. Relevancy values 466 in combination with weighting values 464 may indicate the user is highly interested in electric cars. Even though the user indicated an interest in cloud computing on the service provider website, CCM 100 determined from the third party content that the user was actually more interested in electric cars.

CCM 100 may store other personal user information from events 108 in user profile 104B. For example, event processor 244 may store third party identifiers 460 and attributes 462 associated with user ID 452. Third party identifiers 460 may include user names or any other identifiers used by third parties for identifying user 452. Attributes 462 may include an org name (e.g., employer company name), org size, country, job title, hashed domain name, and/or hashed email addresses associated with user ID 452. Attributes 462 may be combined from different events 108 received from different websites accessed by the user. CCM 100 may also obtain different demographic data in user profile 104 from third party data sources (whether sourced online or offline).

An aggregator may use user profile 104 to update and/or aggregate intent data for different segments, such as service provider contact lists, companies, job titles, etc. The aggregator may also create snapshots of intent data 106 for selected time periods.

Event processor 244 may generate intent data 106 for both known and unknown users. For example, the user may access a webpage and enter an email address into a form field in the webpage. A CCM tag 110 captures and hashes the email address and associates the hashed email address with user ID 452.

The user may not enter an email address into a form field. Alternatively, the CCM tag 110 may capture an anonymous cookie ID in event 108. Event processor 244 then associates the cookie ID with user identifier 452. The user may clear the cookie or access data on a different computer. Event processor 244 may generate a different user identifier 452 and new intent data 106 for the same user.

The cookie ID may be used to create a de-identified cookie data set. The de-identified cookie data set then may be integrated with ad platforms or used for identifying destinations for target advertising.

CCM 100 may separately analyze intent data 106 for the different anonymous user IDs. If the user ever fills out a form providing an email address, event processor then may re-associate the different intent data 106 with the same user identifier 452.

FIG. 5 depicts an example of how the CCM 100 generates a user intent vector 594 from the event data described previously in FIG. 4 according to various embodiments. The user intent vector 594 may be the same or similar as user intent vector 245 of FIG. 2. A user may use computer 530 (which may be the same or similar to the computer 230 of FIG. 2) to access different InObs 582 (including InObs 582A, 582B, and 582C). For example, the user may download a white paper 282A associated with storage virtualization, register for a network security seminar on a webpage 582B, and view a webpage article 582C related to virtual private networks (VPNs). As examples, InObs 582A, 582B, and 582C may come from the same website or come from different websites.

The CCM tags 110 capture three events 584A, 584B, and 584C associated with InObs 582A, 582B, and 582C, respectively. CCM 100 identifies topics 586 in content 582A, 582B, and/or 582C. Topics 586 include virtual storage, network security, and VPNs. CCM 100 assigns relevancy values 590 to topics 586 based on known algorithms For example, relevancy values 590 may be assigned based on the number of times different associated keywords are identified in content 582.

CCM 100 assigns weight values 588 to content 582 based on the associated event activity. For example, CCM 100 assigns a relatively high weight value of 0.7 to a more assertive off-line activity, such as registering for the network security seminar CCM 100 assigns a relatively low weight value of 0.2 to a more passive on-line activity, such as viewing the VPN webpage.

CCM 100 generates a user intent vector 594 in user profile 104 based on the relevancy values 590. For example, CCM 100 may multiply relevancy values 590 by the associated weight values 588. CCM 100 then may sum together the weighted relevancy values for the same topics to generate user intent vector 594.

CCM 100 uses intent vector 594 to represent a user, represent content accessed by the user, represent user access activities associated with the content, and effectively represent the intent/interests of the user. In another embodiment, CCM 100 may assign each topic in user intent vector 594 a binary score of 1 or 0. CCM 100 may use other techniques for deriving user intent vector 594. For example, CCM 100 may weigh the relevancy values based on timestamps.

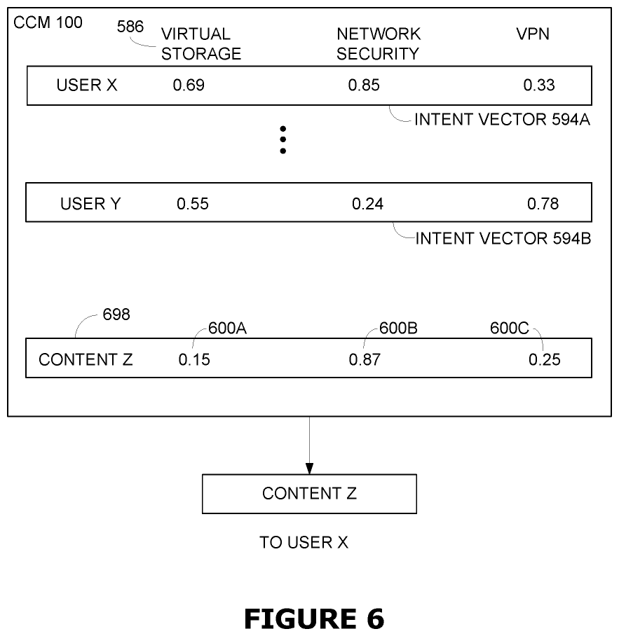

FIG. 6 depicts an example of how the CCM 100 segments users according to various embodiments. CCM 100 may generate user intent vectors 594A and 594B for two different users, including user X and user Y in this example. A service provider 118 may want to email content 698 to a segment of interested users. The service provider submits content 698 to CCM 100. CCM 100 identifies topics 586 and associated relevancy values 600 for content 698.

CCM 100 may use any variety of different algorithms to identify a segment of user intent vectors 594 associated with content 698. For example, relevancy value 600B indicates content 698 is primarily related to network security. CCM 100 may identify any user intent vectors 594 that include a network security topic with a relevancy value above a given threshold value.

In this example, assume the relevancy value threshold for the network security topic is 0.5. CCM 100 identifies user intent vector 594A as part of the segment of users satisfying the threshold value. Accordingly, CCM 100 sends the service provider of content 698 a contact segment that includes the user ID associated with user intent vector 594A. As mentioned above, the user ID may be a hashed email address, cookie ID, or some other encrypted or unencrypted identifier associated with the user.

In another example, CCM 100 calculates vector cross products between user intent vectors 594 and content 698. Any user intent vectors 594 that generate a cross product value above a given threshold value are identified by CCM 100 and sent to the service provider 118.

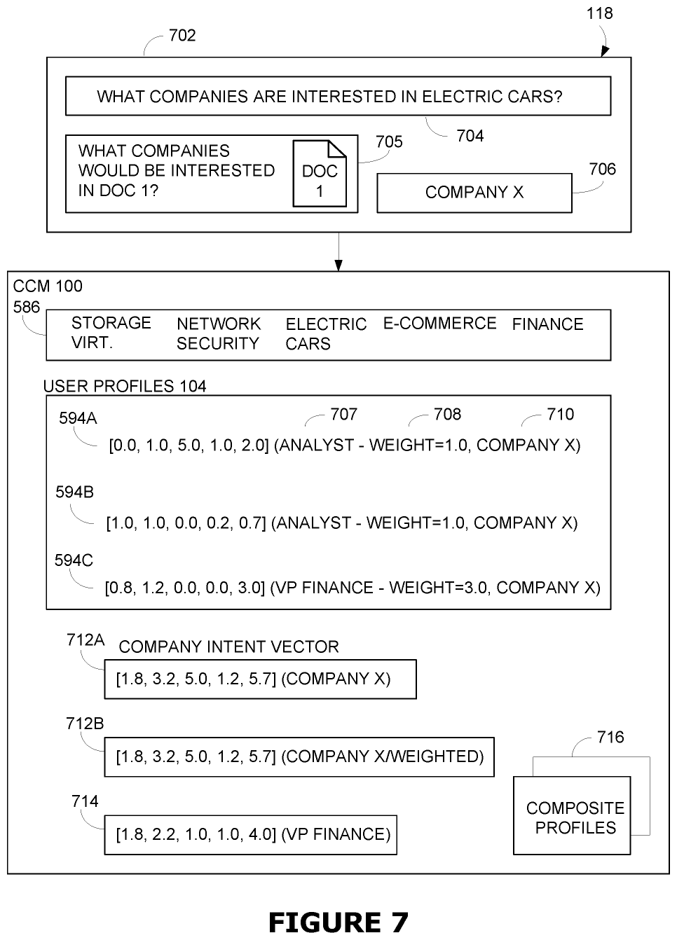

FIG. 7 depicts examples of how the CCM 100 aggregates intent data 106 according to various embodiments. In this example, a service provider 118 operating a computer 702 (which may be the same or similar as computer 230 and computer 530 of FIGS. 2 and 5) submits a search query 704 to CCM 100 asking what companies are interested in electric cars. In this example, CCM 100 associates five different topics 586 with user profiles 104. Topics 586 include storage virtualization, network security, electric cars, e-commerce, and finance.

CCM 100 generates user intent vectors 594 as described previously in FIG. 6. User intent vectors 594 have associated personal information, such as a job title 707 and an org (e.g., employer company) name 710. As explained above, users may provide personal information, such as employer name and job title in form fields when accessing a service provider 118 or third party website.

The CCM tags 110 described previously capture and send the job title and employer name information to CCM 100. CCM 100 stores the job title and employer information in the associated user profile 104. CCM 100 searches user profiles 104 and identifies three user intent vectors 594A, 594B, and 594C associated with the same employer name 710. CCM 100 determines that user intent vectors 594A and 594B are associated with a same job title of analyst and user intent vector 594C is associated with a job title of VP of finance

In response to, or prior to, search query 704, CCM 100 generates a company intent vector 712A for company X. CCM 100 may generate company intent vector 712A by summing up the topic relevancy values for all of the user intent vectors 594 associated with company X.

In response to search query 704, CCM 100 identifies any company intent vectors 712 that include an electric car topic 586 with a relevancy value greater than a given threshold. For example, CCM 100 may identify any companies with relevancy values greater than 4.0. In this example, CCM 100 identifies Org X in search results 706.

In one example, intent is identified for a company at a particular zip code, such as zip code 11201. CCM 100 may take customer supplied offline data, such as from a Customer Relationship Management (CRM) database, and identify the users that match the company and zip code 11201 to create a segment.

In another example, service provider 118 may enter a query 705 asking which companies are interested in a document (DOC 1) related to electric cars. Computer 702 submits query 705 and DOC 1 to CCM 100. CCM 100 generates a topic vector for DOC 1 and compares the DOC 1 topic vector with all known company intent vectors 712A.

CCM 100 may identify an electric car topic in the DOC 1 with high relevancy value and identify company intent vectors 712 with an electric car relevancy value above a given threshold. In another example, CCM 100 may perform a vector cross product between the DOC 1 topics and different company intent vectors 712. CCM 100 may identify the names of any companies with vector cross product values above a given threshold value and display the identified company names in search results 706.

CCM 100 may assign weight values 708 for different job titles. For example, an analyst may be assigned a weight value of 1.0 and a vice president (VP) may be assigned a weight value of 7.0. Weight values 708 may reflect purchasing authority associated with job titles 707. For example, a VP of finance may have higher authority for purchasing electric cars than an analyst. Weight values 708 may vary based on the relevance of the job title to the particular topic. For example, CCM 100 may assign an analyst a higher weight value 708 for research topics.

CCM 100 may generate a weighted company intent vector 712B based on weighting values 708. For example, CCM 100 may multiply the relevancy values for user intent vectors 594A and 594B by weighting value 1.0 and multiply the relevancy values for user intent vector 594C by weighting value 3.0. The weighted topic relevancy values for user intent vectors 594A, 594B, and 594C are then summed together to generate weighted company intent vector 712B.

CCM 100 may aggregate together intent vectors for other categories, such as job title. For example, CCM 100 may aggregate together all the user intent vectors 594 with VP of finance job titles into a VP of finance intent vector 714. Intent vector 714 identifies the topics of interest to VPs of finance.

CCM 100 may also perform searches based on job title or any other category. For example, service provider 118 may enter a query LIST VPs OF FINANCE INTERESTED IN ELECTRIC CARS? The CCM 100 identifies all of the user intent vectors 594 with associated VP finance job titles 707. CCM 100 then segments the group of user intent vectors 594 with electric car topic relevancy values above a given threshold value.

CCM 100 may generate composite profiles 716. Composite profiles 716 may contain specific information provided by a particular service provider 118 or entity. For example, a first service provider 118 may identify a user as VP of finance and a second service provider 118 may identify the same user as VP of engineering. Composite profiles 716 may include other service provider 118 provided information, such as company size, company location, company domain.

CCM 100 may use a first composite profile 716 when providing user segmentation for the first service provider 118. The first composite profile 716 may identify the user job title as VP of finance. CCM 100 may use a second composite profile 716 when providing user segmentation for the second service provider 118. The second composite profile 716 may identify the job title for the same user as VP of engineering. Composite profiles 716 are used in conjunction with user profiles 104 derived from other third party content.

In yet another example, CCM 100 may segment users based on event type. For example, CCM 100 may identify all the users that downloaded a particular article, or identify all of the users from a particular company that registered for a particular seminar.

### 3. Consumption Scoring Embodiments

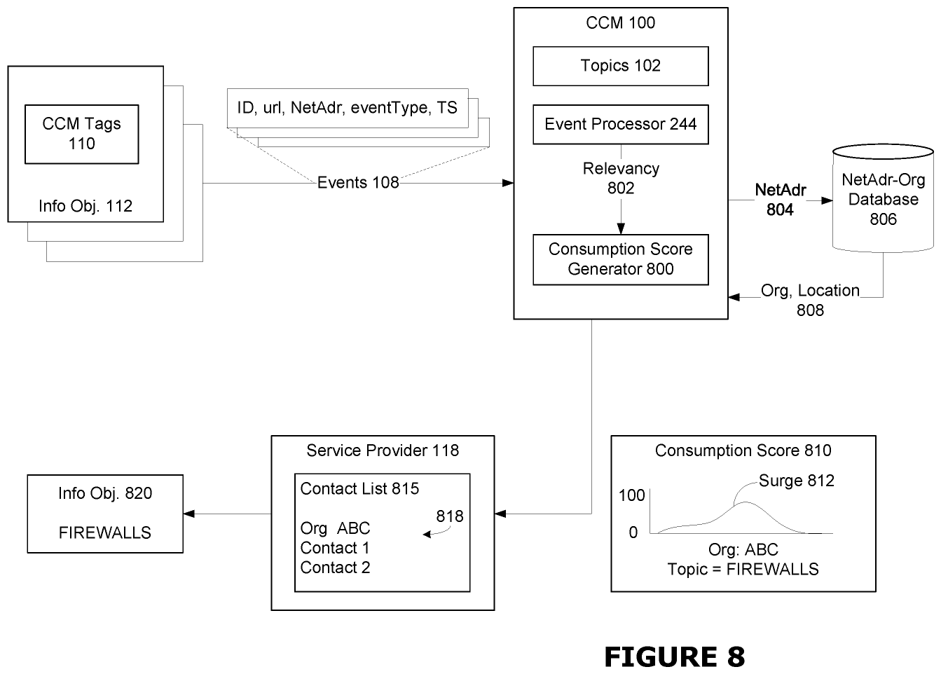

FIG. 8 depicts an example consumption score generator 800 used in CCM 100 according to various embodiments. As explained above, CCM 100 may receive multiple events 108 associated with different InObs 112. For example, users may use client apps (e.g., web browsers, or any other application) to access or view InObs 112 from different resources (e.g., on different websites). The InObs 112 may include any webpage, electronic document, article, advertisement, or any other information viewable or audible by a user such as those discussed herein. In this example, InObs 112 may include a webpage article or a document related to network firewalls.

CCM tag 110 may capture events 108 identifying InObs 112 accessed by a user during a network or application session. For example, events 108 may include various event data such as an identifier (ID) (e.g., a user ID (userld), an application session ID, a network session ID, a device ID, a product ID, electronic product code (EPC), serial number, RFID tag ID, and/or the like), URL, network address (NetAdr), event type (eventType), and a timestamp (TS). The ID field may carry any suitable identifier associated with a user and/or user device, associated with a network session, an application, an app session, an app instance, an app session, an app-generated identifier, and/or a CCM tag 110 may generated identifier. For example, when a user ID is used, the user ID may be a unique identifier for a specific user on a specific client app and/or a specific user device. Additionally or alternatively, the userld may be or include one or more of a user ID (UID) (e.g., positive integer assigned to a user by a Unix-like OS), effective user ID (euid), file system user ID (fsuid), saved user id (suid), real user id (ruid), a cookie ID, a realm name, domain ID, logon user name, network credentials, social media account name, session ID, and/or any other like identifier associated with a particular user or device. The URL may be links, resource identifiers (e.g., Uniform Resource Identifiers (URIs)), or web addresses of InObs 112 accessed by the user during the session.

The NetAdr field includes any identifier associated with a network node. As examples, the NetAdr field may include any suitable network address (or combinations of network addresses) such as an internet protocol (IP) address in an IP network (e.g., IP version 4 (Ipv4), IP version 6 (IPv6), etc.), telephone numbers in a public switched telephone number, a cellular network address (e.g., international mobile subscriber identity (IMSI), mobile subscriber ISDN number (MSISDN), Subscription Permanent Identifier (SUPI), Temporary Mobile Subscriber Identity (TMSI), Globally Unique Temporary Identifier (GUTI), Generic Public Subscription Identifier (GPSI), etc.), an internet packet exchange (IPX) address, an X.25 address, an X.21 address, a port number (e.g., when using Transmission Control Protocol (TCP) or User Datagram Protocol (UDP)), a media access control (MAC) address, an Electronic Product Code (EPC) as defined by the EPCglobal Tag Data Standard, Bluetooth hardware device address (BD_ADDR), a Universal Resource Locator (URL), an email address, and/or the like. The NetAdr may be for a network device used by the user to access a network (e.g., the Internet, an enterprise network, etc.) and InObs 112.

As explained previously, the event type may identify an action or activity associated with InObs 112. In this example, the event type may indicate the user downloaded an electric document or displayed a webpage. The timestamp (TS) may identify a date and/or time the user accessed InObs 112, and may be included in the TS field in any suitable timestamp format such as those defined by ISO 8601 or the like.

Consumption score generator (CSG) 800 may access a NetAdr-Org database 806 to identify a company/entity and location 808 associated with NetAdr 804 in event 108. In one example, the NetAdr-Org database 806 may be a IP/company 806 when the NetAdr is a network address and the Orgs are entities such companies, enterprises, and/or the like. For example, existing services may provide databases 806 that identify the company and company address associated with network addresses. The NetAdr (e.g., IP address) and/or associated org may be referred to generally as a domain. CSG 800 may generate metrics from events 108 for the different companies 808 identified in database 806.

In another example, CCM tags 110 may include domain names in events 108. For example, a user may enter an email address into a webpage field during a web session. CCM 100 may hash the email address or strip out the email domain address. CCM 100 may use the domain name to identify a particular company and location 808 from database 806.

As also described previously, event processor 244 may generate relevancy scores 802 that indicate the relevancy of InObs 112 with different topics 102. For example, InObs 112 may include multiple words associate with topics 102. Event processor 244 may calculate relevancy scores 802 for InObs 112 based on the number and position words associated with a selected topic.

CSG 800 may calculate metrics from events 108 for particular companies 808. For example, CSG 800 may identify a group of events 108 for a current week that include the same NetAdr 804 associated with a same company and company location 808. CSG 800 may calculate a consumption score 810 for company 808 based on an average relevancy score 802 for the group of events 108. CSG 800 may also adjust the consumption score 810 based on the number of events 108 and the number of unique users generating the events 108.

CSG 800 generates consumption scores 810 for org 808 for a series of time periods. CSG 800 may identify a surge 812 in consumption scores 810 based on changes in consumption scores 810 over a series of time periods. For example, CSG 800 may identify surge 812 based on changes in content relevancy, number of unique users, number of unique user accesses for a particular InOb, a number of events over one or more time periods (e.g., several weeks), a number of particular types of user interactions with a particular InOb, and/or any other suitable parameters/criteria. It has been discovered that surge 812 corresponds with a unique period when orgs have heightened interest in a particular topic and are more likely to engage in direct solicitations related to that topic. The surge 812 (also be referred to as a “surge score 812” or the like) informs a service provider 118 when target orgs (e.g., org 808) are indicating active demand for the products or services that are offered by the service provider 118.

CCM 100 may send consumption scores 810 and/or any surge indicators 812 to service provider 118. Service provider 118 may store a contact list 815 that includes contacts 818 for org ABC. For example, contact list 815 may include email addresses or phone number for employees of org ABC. Service provider 118 may obtain contact list 815 from any source such as from a customer relationship management (CRM) system, commercial contact lists, personal contacts, third parties lead services, retail outlets, promotions or points of sale, or the like or any combination thereof.

In one example, CCM 100 may send weekly consumption scores 810 to service provider 118. In another example, service provider 118 may have CCM 100 only send surge notices 812 for companies on list 815 surging for particular topics 102.

Service provider 118 may send InOb 820 related to surge topics to contacts 818. For example, the InOb 820 sent by service provider 118 to contacts 818 may include email advertisements, literature, or banner ads related to firewall products/services. Alternatively, service provider 118 may call or send direct mailings regarding firewalls to contacts 818. Since CCM 100 identified surge 812 for a firewall topic at org ABC, contacts 818 at org ABC are more likely to be interested in reading and/or responding to content 820 related to firewalls. Thus, content 820 is more likely to have a higher impact and conversion rate when sent to contacts 818 of org ABC during surge 812.

In another example, service provider 118 may sell a particular product, such as firewalls. Service provider 118 may have a list of contacts 818 at org ABC known to be involved with purchasing firewall equipment. For example, contacts 418 may include the chief technology officer (CTO) and information technology (IT) manager at org ABC. CCM 100 may send service provider 118 a notification whenever a surge 812 is detected for firewalls at org ABC. Service provider 118 then may automatically send content 820 to specific contacts 818 at org ABC with job titles most likely to be interested in firewalls.

CCM 100 may also use consumption scores 810 for advertising verification. For example, CCM 100 may compare consumption scores 810 with advertising content 820 sent to companies or individuals. Advertising content 820 with a particular topic sent to companies or individuals with a high consumption score or surge for that same topic may receive higher advertising rates.

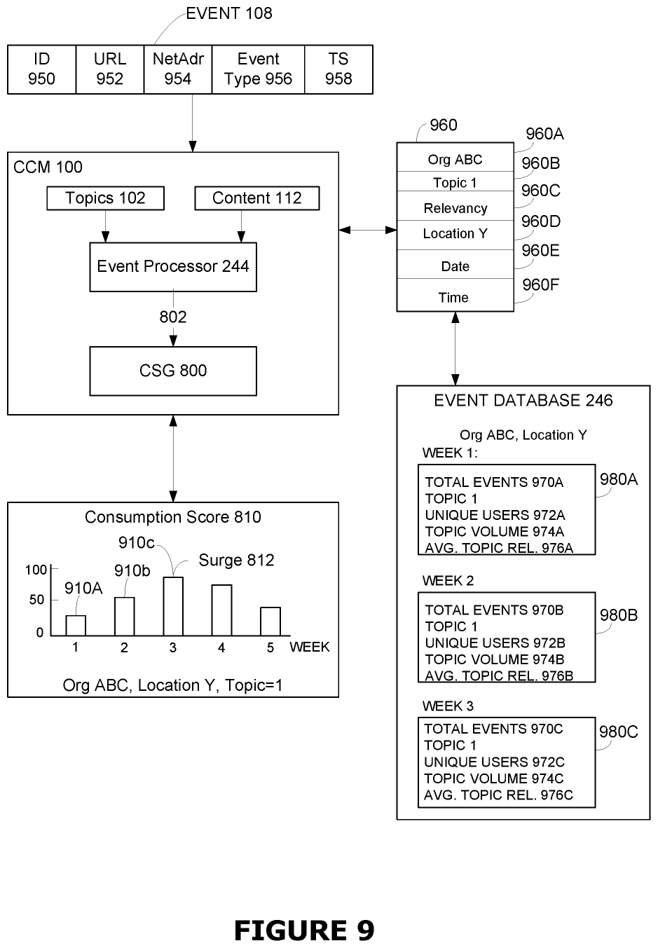

FIG. 9 shows a more detailed example of how the CCM 100 generates consumption scores 810 according to various embodiments. CCM 100 may receive millions of events 108 from millions of different users associated with thousands of different domains every day. CCM 100 may accumulate the events 108 for different time periods, such as daily, weekly, monthly, or the like. Week time periods are just one example and CCM 100 may accumulate events 108 for any selectable time period. CCM 100 may also store a set of topics 102 for any selectable subject matter. CCM 100 may also dynamically generate some of topics 102 based on the content identified in events 108 as described previously.

Events 108 as mentioned previously, and as shown by FIG. 9, may include an identifier (ID) 950 (e.g., a user ID, session ID, device ID, product ID/code, serial number, and/or the like), URL 952, network address 954, event type 956, and timestamp 958 (which may be collectively referred to as “event data” or the like). Event processor 244 identifies InObs 112 located at URL 942 and selects one of topics 102 for comparing with InObs 112. Event processor 244 may generate an associated relevancy score 802 indicating a relevancy of InObs 112 to selected topic 102. Relevancy score 802 may alternatively be referred to as a “topic score” or the like.

CSG 800 generates consumption data 960 from events 108. For example, CSG 800 may identify or determine an org 960A (e.g., “Org ABC” in FIG. 9) associated with network address 954. CSG 800 also calculates a relevancy score 960C between InObs 112 and the selected topic 960B. CSG 800 also identifies or determines a location 960D for with company 960A and identify a date 960E and time 960F when event 108 was detected.

CSG 800 generates consumption metrics 980 from consumption data 960. For example, CSG 800 may calculate a total number of events 970A associated with org 960A (e.g., Org ABC) and location 960D (e.g., location Y) for all topics during a first time period, such as for a first week. CSG 800 also calculates the number of unique users 972A generating the events 108 associated with org ABC and topic 960B for the first week. For example, CSG 800 may calculate for the first week a total number of events generated by org ABC for topic 960B (e.g., topic volume 974A). CSG 800 may also calculate an average topic relevancy 976A for the content accessed by org ABC and associated with topic 960B. CSG 800 may generate consumption metrics 980A-980C for sequential time periods, such as for three consecutive weeks.

CSG 800 may generate consumption scores 910 based on consumption metrics 980A-980C. For example, CSG 800 may generate a first consumption score 910A for week 1 and generate a second consumption score 910B for week 2 based in part on changes between consumption metrics 980A for week 1 and consumption metrics 980B for week 2. CSG 800 may generate a third consumption score 910C for week 3 based in part on changes between consumption metrics 980A, 980B, and 980C for weeks 1, 2, and 3, respectively. In one example, any consumption score 910 above as threshold value is identified as a surge 812.

Additionally or alternatively, the consumption metrics 980 may include metrics such as topic consumption by interactions, topic consumption by unique users, Topic relevancy weight, and engagement. Topic consumption by interactions is the number of interactions from an org in a given time period compared to a larger time period of historical data, for example, the number of interactions in a previous three week period compared to a previous 12 week period of historical data. Topic consumption by unique users refers to the number of unique individuals from an org researching relevant topics in a given time period compared to a larger time period of historical data, for example, the number of individuals from an org researching relevant topic in a previous three week period compared to a previous 12 week period of historical data. Topic relevancy weight refers to a measure of a content piece's ‘denseness’ in a topic of interest such as whether the topic is the focus of the content piece or sparsely mentioned in the content piece. Engagement refers to the depth of an org's engagement with the content, which may be based on an aggregate of engagement of individual users associated with the org. The engagement may be measured based on the user interactions with the InOb such as by measuring dwell time, scroll velocity, scroll depth, and/or any other suitable user interactions such as those discussed herein.

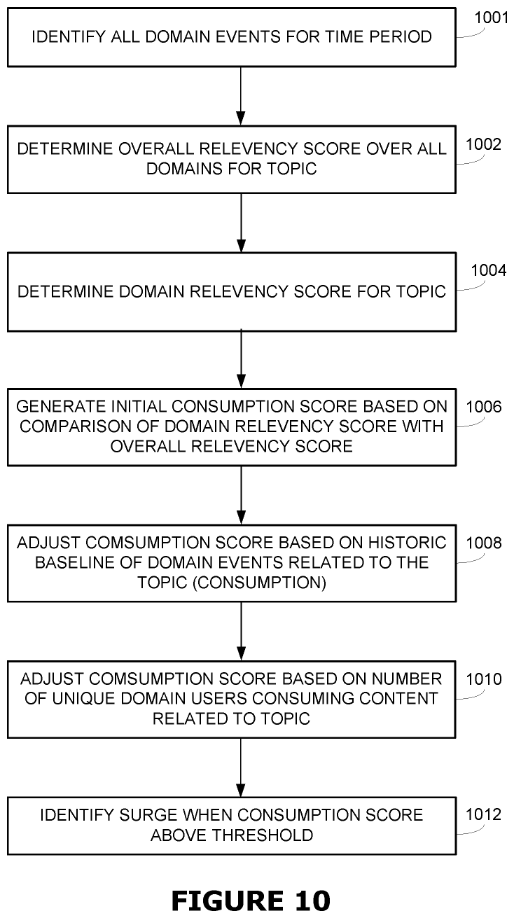

FIG. 10 depicts a process for identifying a surge in consumption scores according to various embodiments. In operation 1001, the CCM 100 identifies all domain events for a given time period. For example, for a current week the CCM 100 may accumulate all of the events for every network address (e.g., IP address, domain, or the like) associated with every topic 102.

The CCM 100 may use thresholds to select which domains to generate consumption scores. For example, for the current week the CCM 100 may count the total number of events for a particular domain (domain level event count (DEC)) and count the total number of events for the domain at a particular location (metro level event count (DMEC)).

The CCM 100 calculates the consumption score for domains with a number of events more than a threshold (DEC>threshold). The threshold can vary based on the number of domains and the number of events. The CCM 100 may use the second DMEC threshold to determine when to generate separate consumption scores for different domain locations. For example, the CCM 100 may separate subgroups of org ABC events for the cities of Atlanta, New York, and Los Angeles that have each a number of events DMEC above the second threshold.

In operation 1002, the CCM 100 determines an overall relevancy score for all selected domains for each of the topics. For example, the CCM 100 for the current week may calculate an overall average relevancy score for all domain events associated with the firewall topic.

In operation 1004, the CCM 100 determines a relevancy score for a specific domain. For example, the CCM 100 may identify a group of events 108 having a same network address associated with org ABC. The CCM 100 may calculate an average domain relevancy score for the org ABC events associated with the firewall topic.

In operation 1006, the CCM 100 generates an initial consumption score based on a comparison of the domain relevancy score with the overall relevancy score. For example, the CCM 100 may assign an initial low consumption score when the domain relevancy score is a certain amount less than the overall relevancy score. The CCM 100 may assign an initial medium consumption score larger than the low consumption score when the domain relevancy score is around the same value as the overall relevancy score. The CCM 100 may assign an initial high consumption score larger than the medium consumption score when the domain relevancy score is a certain amount greater than the overall relevancy score. This is just one example, and the CCM 100 may use any other type of comparison to determine the initial consumption scores for a domain/topic.

In operation 1008, the CCM 100 adjusts the consumption score based on a historic baseline of domain events related to the topic. This is alternatively referred to as consumption. For example, the CCM 100 may calculate the number of domain events for org ABC associated with the firewall topic for several previous weeks.

The CCM 100 may reduce the current week consumption score based on changes in the number of domain events over the previous weeks. For example, the CCM 100 may reduce the initial consumption score when the number of domain events fall in the current week and may not reduce the initial consumption score when the number of domain events rises in the current week.

In operation 1010, the CCM 100 further adjusts the consumption score based on the number of unique users consuming content associated with the topic. For example, the CCM 100 for the current week may count the number of unique user IDs (unique users) for org ABC events associated with firewalls. The CCM 100 may not reduce the initial consumption score when the number of unique users for firewall events increases from the prior week and may reduce the initial consumption score when the number of unique users drops from the previous week.

In operation 1012, the CCM 100 identifies or determines surges based on the adjusted weekly consumption score. For example, the CCM 100 may identify a surge when the adjusted consumption score is above a threshold.

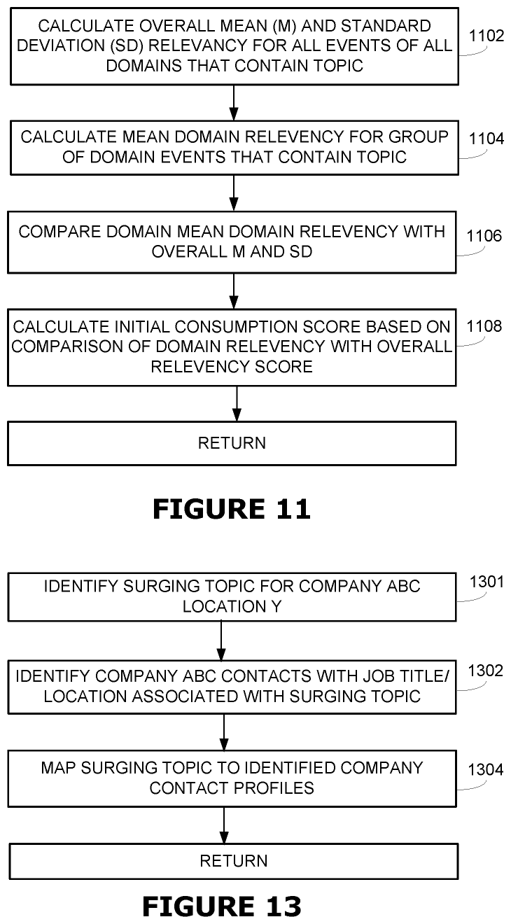

FIG. 11 depicts in more detail the process for generating an initial consumption score according to various embodiments. It should be understood this is just one example scheme and a variety of other schemes may also be used in other embodiments.

In operation 1102, the CCM 100 calculates an arithmetic mean (M) and standard deviation (SD) for each topic over all domains. The CCM 100 may calculate M and SD either for all events for all domains that contain the topic, or alternatively for some representative (big enough) subset of the events that contain the topic. The CCM 100 may calculate the overall mean and standard deviation according to the following equations:

$$\begin{matrix}M = \frac{1}{n} * {\sum }_{1}^{n} {x}_{i} & [ Equation 1 ] \\ SD = \sqrt{\frac{1}{n - 1}} {\sum }_{1}^{n} {( {x}_{i} - M )}^{2} & [ Equation 2 ]\end{matrix}$$

Equation 1 may be used to determine a mean and equation may be used to determine a standard deviation (SD). In equations 1 and 2, xᵢ is a topic relevancy, and n is a total number of events.

In operation 1104, the CCM 100 calculates a mean (average) domain relevancy for each group of domain and/or domain/metro events for each topic. For example, for the past week the CCM 100 may calculate the average relevancy for org ABC events for firewalls.

In operation 1106, the CCM 100 compares the domain mean relevancy (DMR) with the overall mean (M) relevancy and over standard deviation (SD) relevancy for all domains. For example, the CCM 100 may assign at least one of three different levels to the DMR as shown by table 1.

TABLE 1

| | | |
|---|---|---|
| Low | DMR < M − 0.5 * SD | ~33% of all values |
| Medium | M − 0.5 * SD < DMR < M + 0.5 * SD | ~33% of all values |
| High | DMR > M + 0.5 * SD | ~33% of all values |

In operation 1108, the CCM 100 calculates an initial consumption score for the domain/topic based on the above relevancy levels. For example, for the current week the CCM 100 may assign one of the initial consumption scores shown by table 2 to the org ABC firewall topic. Again, this just one example of how the CCM 100 may assign an initial consumption score to a domain/topic.

TABLE 2

| Relevancy | Initial Consumption Score |
|---|---|
| High | 100 |
| Medium | 70 |
| Low | 40 |

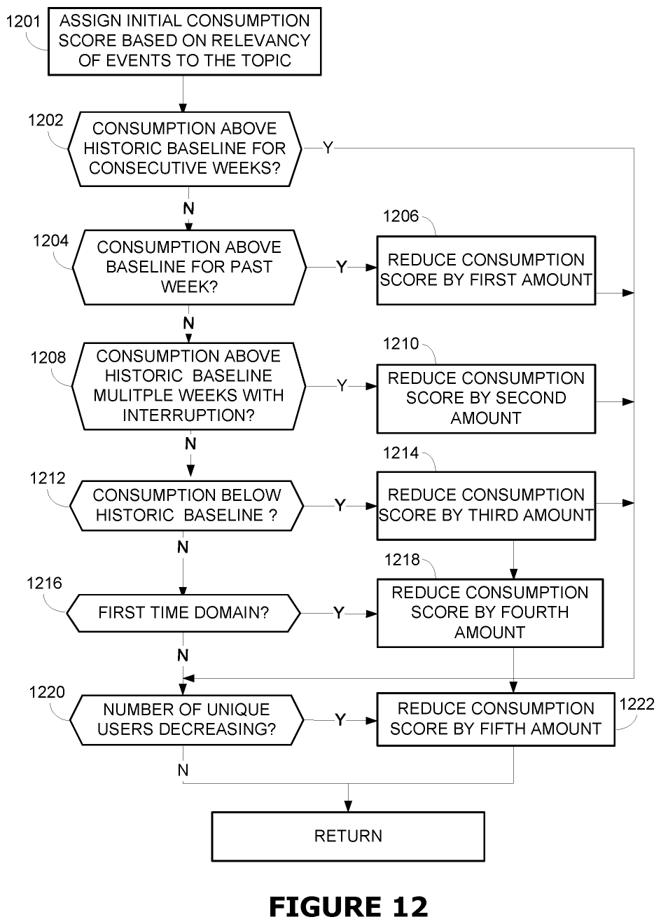

FIG. 12 depicts one example of how the CCM 100 may adjust the initial consumption score according to various embodiments. These are also just examples and the CCM 100 may use other schemes for calculating a final consumption score in other embodiments. In operation 1201, the CCM 100 assigns an initial consumption score to the domain/location/topic as described previously in FIG. 11.

The CCM 100 may calculate a number of events for domain/location/topic for a current week. The number of events is alternatively referred to as consumption. The CCM 100 may also calculate the number of domain/location/topic events for previous weeks and adjust the initial consumption score based on the comparison of current week consumption with consumption for previous weeks.

In operation 1202, the CCM 100 determines if consumption for the current week is above historic baseline consumption for previous consecutive weeks. For example, the CCM 100 may determine is the number of domain/location/topic events for the current week is higher than an average number of domain/location/topic events for at least the previous two weeks. If so, the CCM 100 may not reduce the initial consumption value derived in FIG. 11.

If the current consumption is not higher than the average consumption in operation 542, the CCM 100 in operation 1204 determines if the current consumption is above a historic baseline for the previous week. For example, the CCM 100 may determine if the number of domain/location/topic events for the current week is higher than the average number of domain/location/topic events for the previous week. If so, the CCM 100 in operation 1206 reduces the initial consumption score by a first amount.

If the current consumption is not above than the previous week consumption in operation 1204, the CCM 100 in operation 1208 determines if the current consumption is above the historic consumption baseline but with interruption. For example, the CCM 100 may determine if the number of domain/location/topic events has fallen and then risen over recent weeks. If so, the CCM 100 in operation 1210 reduces the initial consumption score by a second amount.

If the current consumption is not above than the historic interrupted baseline in operation 1208, the CCM 100 in operation 1212 determines if the consumption is below the historic consumption baseline. For example, the CCM 100 may determine if the current number of domain/location/topic events is lower than the previous week. If so, the CCM 100 in operation 1214 reduces the initial consumption score by a third amount.

If the current consumption is above the historic base line in operation 1212, the CCM 100 in operation 1216 determines if the consumption is for a first-time domain. For example, the CCM 100 may determine the consumption score is being calculated for a new company or for a company that did not previously have enough events to qualify for calculating a consumption score. If so, the CCM 100 in operation 1218 may reduce the initial consumption score by a fourth amount.

In one example, the CCM 100 may reduce the initial consumption score by the following amounts. The CCM 100 may use any values and factors to adjust the consumption score in other embodiments.

Consumption above historic baseline consecutive weeks (operation 542).—0

Consumption above historic baseline past week (operation 544).—20 (first amount).

Consumption above historic baseline for multiple weeks with interruption (operation 548)—30 (second amount).

Consumption below historic baseline (operation 552).—40 (third amount).

First time domain (domain/metro) observed (operation 556).—30 (fourth amount).

As explained above, the CCM 100 may also adjust the initial consumption score based on the number of unique users. The CCM tags 110 in FIG. 8 may include cookies placed in web browsers that have unique identifiers. The cookies may assign the unique identifiers to the events captured on the web browser. Therefore, each unique identifier may generally represent a web browser for a unique user. The CCM 100 may identify the number of unique identifiers for the domain/location/topic as the number of unique users. The number of unique users may provide an indication of the number of different domain users interested in the topic.

In operation 1220, the CCM 100 compares the number of unique users for the domain/location/topic for the current week with the number of unique users for the previous week. The CCM 100 may not reduce the consumption score if the number of unique users increases over the previous week. When the number of unique users decrease, the CCM 100 in operation 1222 may further reduce the consumption score by a fifth amount. For example, the CCM 100 may reduce the consumption score by 10.

The CCM 100 may normalize the consumption score for slower event days, such as weekends. Again, the CCM 100 may use different time periods for generating the consumption scores, such as each month, week, day, hour, etc. The consumption scores above a threshold are identified as a surge or spike and may represent a velocity or acceleration in the interest of a company or individual in a particular topic. The surge may indicate the company or individual is more likely to engage with a service provider 118 who presents content similar to the surge topic. The surge helps service providers 118 identify the orgs in active research mode for the service providers' 118 products/services so the service providers 118 can proactively coordinate sales and marketing activities around orgs with active intent, and/or obtain or deliver better results with highly targeted campaigns that focus on orgs demonstrating intent around a certain topic.

### 4. Consumption DNA

One advantage of domain-based surge detection is that a surge can be identified for an org without using personally identifiable information (PII), sensitive data, or confidential data of the org personnel (e.g., company employees). The CCM 100 derives the surge data based on an org's network address without using PII, sensitive data, or confidential data associated with the users generating the events 108.

In another example, the user may provide PII, sensitive data, and/or confidential data during network/web sessions. For example, the user may agree to enter their email address into a form prior to accessing content. As described previously, the CCM 100 may anonymize (e.g., hash, or the like) the PII, sensitive data, or confidential data and include the anonymized data either with org consumption scores or with individual consumption scores.

FIG. 13 shows an example process for mapping domain consumption data to individuals according to various embodiments. In operation 1301, the CCM 100 identifies or determines a surging topic for an org (e.g., org ABC at location Y) as described previously. For example, the CCM 100 may identify a surge 812 for org ABC in New York for firewalls.

In operation 1302, the CCM 100 identifies or determines users associated with org ABC. As mentioned above, some org ABC personnel may have entered personal, sensitive, or confidential data, such as their office location and/or job titles into fields of webpages during events 108. In another example, a service provider 118 or other party may obtain contact information for employees of org ABC from CRM customer profiles or third party lists.

Either way, the CCM 100 or service provider 118 may obtain a list of employees/users associated with org ABC at location Y. The list may also include job titles and locations for some of the employees/users. The CCM 100 or service provider 118 may compare the surge topic with the employee job titles. For example, the CCM 100 or service provider may determine that the surging firewall topic is mostly relevant to users with a job title such as engineer, chief technical officer (CTO), or information technology (IT).

In operation 1304, the CCM 100 or service provider 118 maps the surging topic (e.g., firewall in this example) to profiles of the identified personnel of org ABC. In another example, the CCM 100 or service provider 118 may not be as discretionary and map the firewall surge to any user associated with org ABC. The CCM 100 or service provider then may direct content associated with the surging topic to the identified users. For example, the service provider may direct banner ads or emails for firewall seminars, products, and/or services to the identified users.

Consumption data identified for individual users is alternatively referred to as “Dino DNA” and the general domain consumption data is alternatively referred to as “frog DNA.” Associating domain consumption and surge data with individual users associated with the domain may increase conversion rates by providing more direct contact to users more likely interested in the topic.

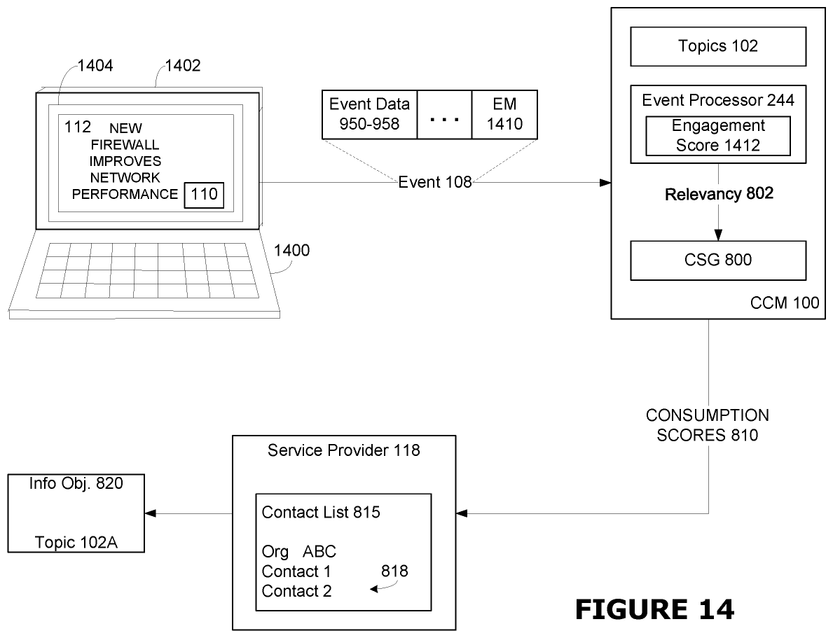

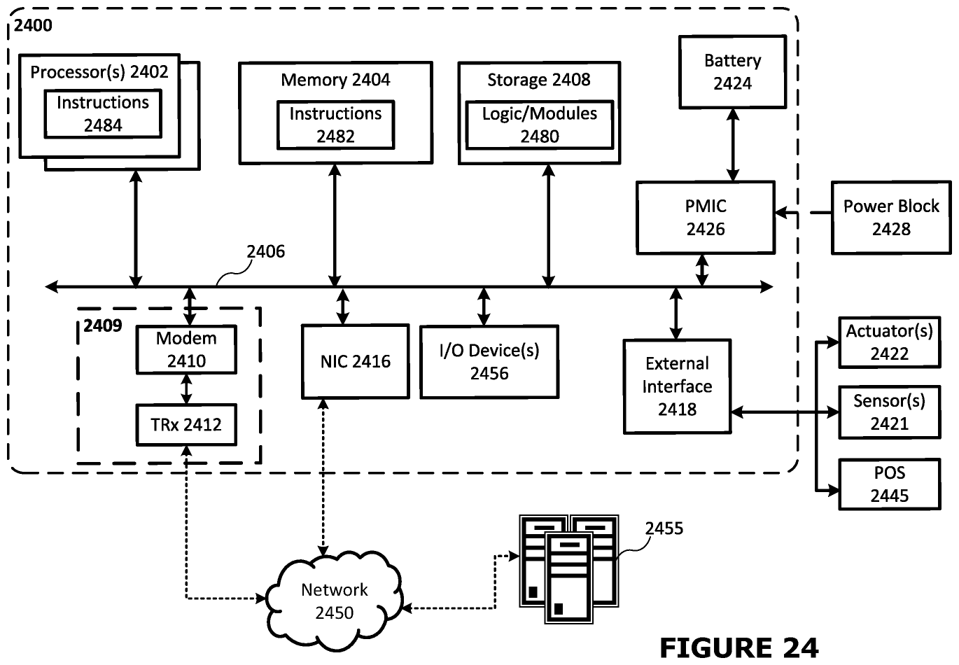

The example embodiments described herein provide improvements to the functioning of computing devices and computing networks by providing specific mechanisms of collecting network session events 118 from user devices (e.g., computers 232 and 1404 of FIGS. 2 and 14, and platform 2400 of FIG. 24), accessing InObs 112, 114, determining the amount of traffic individual websites receive from user devices at or related to a specific domain name or network addresses at specific periods of time, and identifying spikes (surges 812). The collected data can be used to analyze the cause of the surge (e.g., relevant topics in specific InObs 112, 114), which provides a specific improvement over prior systems, resulting in improved network/traffic monitoring capabilities and resource consumption efficiencies. The embodiments discussed herein allows for the discovery of information from extremely large amounts of data that was not previously possible in conventional computing architectures.

Identifying spikes (e.g., surges) in traffic in this way allows content providers to better serve their content to specific users. Serving content to numerous users (e.g., responding to network request for content and the like) without targeting can be computationally intensive and can consume large amounts of computing and network resources, at least from the perspective of content providers, service providers, and network operators. The improved network/traffic monitoring and resource efficiencies provided by the present claims is a technological improvement in that content providers, service providers, and network operators can reduce network and computational resource overhead associated with serving content to users by reducing the overall amount of content served to users by focusing on the relevant content. Additionally, the content providers, service providers, and network operators could use the improved network/traffic monitoring to better adapt the allocation of resources to serve users a peak times in order to smooth out their resource consumption over time.

### 5. Intent Measurement

FIG. 14 depicts how CCM 100 may calculate consumption scores based on user engagement. A computer 1400 may operate a client app 1404 (e.g., a browser, desktop/mobile app, etc.) to access InObs 112, for example, by sending appropriate HTTP messages or the like, and in response, server-side application(s) may dynamically generate and provide code, scripts, markup documents, and/or other InOb(s) 112 to the client app 1404 to render and display InObs 112 within the client app 1404. As alluded to previously, InObs 112 may be a webpage or web app comprising a graphical user interface (GUI) including graphical control elements (GCEs) for accessing and/or interacting with a service provider (e.g., a service provider 118). The server-side applications may be developed with any suitable server-side programming languages or technologies, such as PHP; Java™ based technologies such as Java Servlets, JavaServer Pages (JSP), JavaServer Faces (JSF), etc.; ASP.NET; Ruby or Ruby on Rails; a platform-specific and/or proprietary development tool and/or programming languages; and/or any other like technology that renders HyperText Markup Language (HTML). The computer 1400 may be a laptop, smartphone, tablet, and/or any other device such as any of those discussed herein. In this example, a user may open the client app 1404 on a screen 1402 of computer 1400.

CCM tag 110 may operate within client app 1404 and monitor user web sessions. As explained previously, CCM tag 110 may generate events 108 for the web/network session that includes various event data 950-958 such as an ID 950 (e.g., a user ID, session ID, app ID, etc.), a URL 952 for accessed InObs 112, a network address 954 of a user/user device that accessed the InObs 112, an event type 956 that identifies an action or activity associated with the accessed InObs 112, and timestamp 958 of the events 108. For example, CCM tag 110 may add an event type identifier into event 108 indicating the user downloaded an InOb 112. In some embodiments, the events 108 may include also include an engagement metrics (EM) field 1410 to include engagement metrics (the data field/data element that carries engagement metrics, and the engagement metrics themselves may be referred to herein as “engagement metrics 1410” or “EM 1410”)

In one example, CCM tag 110 may generate a set of impressions, which is alternatively referred to as engagement metrics 1410, indicating actions taken by the user while consuming InObs 112 (e.g., user interactions). For example, engagement metrics 1410 may indicate how long the user dwelled on InObs 112, how the user scrolled through InObs 112, and/or the like. Engagement metrics 1410 may indicate a level of engagement or interest a user has in InObs 112. For example, the user may spend more time on the webpage and scroll through webpage at a slower speed when the user is more interested in the InObs 112.

In embodiments, the CCM 100 calculates an engagement score 1412 for InObs 112 based on engagement metrics 1410. CCM 100 may use engagement score 1412 to adjust a relevancy score 802 for InObs 112. For example, CCM 100 may calculate a larger engagement score 1412 when the user spends a larger amount of time carefully paging through InObs 112. CCM 100 then may increase relevancy score 802 of InObs 112 based on the larger engagement score 1412. CSG 800 may adjust consumption scores 910 based on the increased relevancy 802 to more accurately identify domain surge topics. For example, a larger engagement score 1412 may produce a larger relevancy 802 that produces a larger consumption score 910.

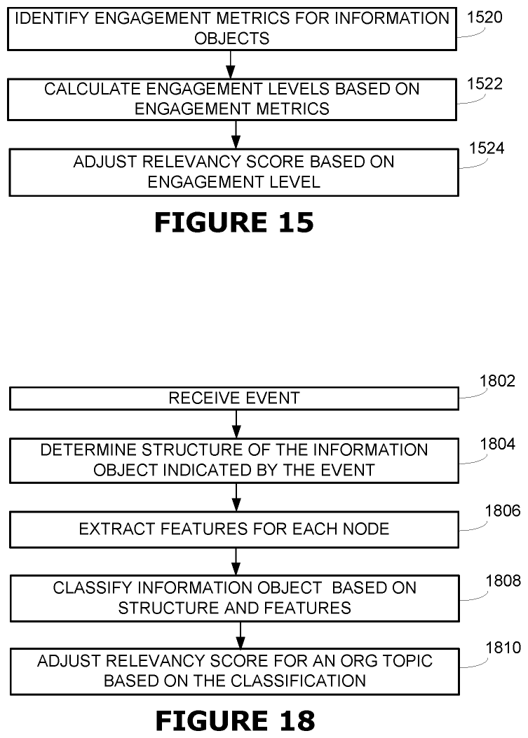

FIG. 15 depicts an example process for calculating the engagement score for content according to various embodiments. In operation 1520, the CCM 100 identifies or determines engagement metrics 1410 for InObs 112. In embodiments, the CCM 100 may receive events 100 that include content engagement metrics 1410 for one or more InObs 112. The engagement metrics 1410 for InObs 112 may be content impressions or the like. As examples, the engagement metrics 1410 may indicate any user interaction with InObs 112 including tab selections that switch to different pages, page movements, mouse page scrolls, mouse clicks, mouse movements, scroll bar page scrolls, keyboard page movements, touch screen page scrolls, eye tracking data (e.g., gaze locations, gaze times, gaze regions of interest, eye movement frequency, speed, orientations, etc.), touch data (e.g., touch gestures, etc.), and/or any other content movement or content display indicator(s).

In operation 1522, the CCM 100 identifies or determines engagement levels based on the engagement metrics 1410. In one example at operation 1522, the CCM 100 identifies/determines a content dwell time. The dwell time may indicate how long the user actively views a page of content. In one example, tag 110 may stop a dwell time counter when the user changes page tabs or becomes inactive on a page. Tag 110 may start the dwell time counter again when the user starts scrolling with a mouse or starts tabbing. Additionally or alternatively at operation 1522, the CCM 100 identifies/determines, from the events 108, a scroll depth for the content. For example, the CCM 100 may determine how much of a page the user scrolled through or reviewed. In one example, the CCM tag 110 or CCM 100 may convert a pixel count on the screen into a percentage of the page. Additionally or alternatively at operation 1522, the CCM 100 identifies/determines an up/down scroll speed. For example, dragging a scroll bar may correspond with a fast scroll speed and indicate the user has less interest in the content. Using a mouse wheel to scroll through content may correspond with a slower scroll speed and indicate the user is more interested in the content. Additionally or alternatively at operation 1522, the CCM 100 identifies/determines various other aspects/levels of the engagement based on some or all of the engagement metrics 1410 such as any of those discussed herein. In some embodiments, the CCM 100 may assign higher values to engagement metrics 1410 (e.g., impressions) that indicate a higher user interest and assign lower values to engagement metrics that indicate lower user interest. For example, the CCM 100 may assign a larger value in operation 1522 when the user spends more time actively dwelling on a page and may assign a smaller value when the user spends less time actively dwelling on a page.

In operation 1524, the CCM 100 calculates the content engagement score 1412 based on the values derived in operations 1520-1522. For example, the CCM 100 may add together and normalize the different values derived in operations 1520-1522. Other operations may be performed on these values in other embodiments.

In operation 1526, the CCM 100 adjusts relevancy values (e.g., relevancy scores 802) described previously in FIGS. 1-14 based on the content engagement score 1412. For example, the CCM 100 may increase the relevancy values (e.g., relevancy scores 802) when the InOb(s) 112 has/have a high engagement score and decrease the relevancy (e.g., relevancy scores 802) for a lower engagement scores.

CCM 100 or CCM tag 110 in FIG. 14 may adjust the values assigned in operations 1520-1524 based on the type of device 1400 used for viewing the content. For example, the dwell times, scroll depths, and scroll speeds, may vary between smartphone, tablets, laptops and desktop computers. CCM 100 or tag 110 may normalize or scale the engagement metric values so different devices provide similar relative user engagement results.

By providing more accurate intent data and consumptions scores in the ways discussed herein allows service providers 118 to conserve computational and network resources by providing a means for better targeting users so that unwanted and seemingly random content is not distributed to users that do not want such content. This is a technological improvement in that it conserves network and computational resources of service providers 118 and/or other organizations (orgs) that distribute this content by reducing the amount of content generated and sent to end-user devices. End-user devices may reduce network and computational resource consumption by reducing or eliminating the need for using such resources to obtain (download) and view unwanted content. Additionally, end-user devices may reduce network and computational resource consumption by reducing or eliminating the need to implement spam filters and reducing the amount of data to be processed when analyzing and/or deleting such content.

Furthermore, unlike conventional targeting technologies, the embodiments herein provide user targeting based on surges in interest with particular content, which allows service providers 118 to tailor the timing of when to send content to individual users to maximize engagement, which may include tailoring the content based on the determined locations. This allows content providers to spread out the content distribution over time. Spreading out content distribution reduces congestion and overload conditions at various nodes within a network, and therefore, the embodiments herein also reduce the computational burdens and network resource consumption on the content providers 118, content distribution platforms, and Internet Service Providers (ISPs) at least when compared to existing/conventional mass/bulk distribution technologies.

### 6. Resource Classification Embodiments

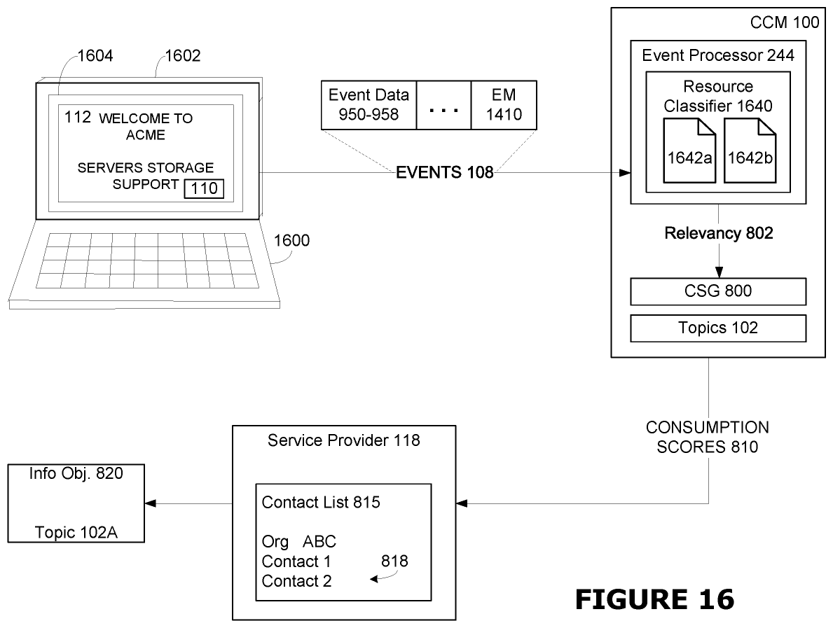

It may be difficult to identify an org's intent (e.g., company purchasing intent) based on relatively brief user resource accesses (e.g., visits to a webpage, file downloads, etc.), relatively little user interactions with a webpage or web app, and/or when a webpage or web app contains relatively little content. However, a pattern of users visiting multiple resources (e.g., vendor sites) associated with the same or similar topics during the same or similar time periods may be used to identify a more urgent topic and/or predict org intent. In embodiments, a classifier (e.g., resource classifier 1640 of FIG. 16) may adjust relevancy scores 802 based on different resource (e.g., website) classifications and produce surge signals 812 that better indicate org interest in purchasing or otherwise consuming a particular product, service, or resource.

FIG. 16 shows an example of how CCM 100 calculates consumption scores based on resource (e.g., website) classifications according to various embodiments. In this example, a computer 1600 may operate a client app 1604 (e.g., a browser, desktop/mobile app, etc.) to access InObs 112, for example, by sending appropriate HTTP messages or the like, and in response, server-side application(s) may dynamically generate and provide code, scripts, markup documents, and/or other InOb(s) 112 to the client app 1604 to render and display InObs 112 within the client app 1604 on screen 1602. Computer 1600, screen 1602, and client app 1604 may be the same or similar to computer 1400, screen 1402, and client app 1404 discussed previously.

As explained previously, CCM tag 110 may generate events 108 for the network/web session that includes various event data 950-958 such as an ID 950 (e.g., a user ID, session ID, app ID, etc.), a URL 952 for InObs 112, a network address 954, an event type 956, timestamp 958, and engagement metrics (EM) 1410 indicating various user interactions with InOb(s) 112. The EM 1410 may indicate a level of engagement or interest the user has in InOb(s) 112. For example, a user may spend more time on a webpage and scroll through the webpage at a slower speed when the user is more interested in the InOb(s) 112.

The events 108 are provided to the event processor 244 in the same/similar manner as discussed previously. In this example, the event processor 244 includes and/or operates a resource classifier 1640 to classify InObs 1642 according to their type or class, and/or according to some other parameters/criteria. The CCM 100 (e.g., event processor 244 and/or CSG 800) may adjust relevancy scores 802 and/or the consumption scores 810 m according to the classification of InObs 1642.

For example, a first InOb 1642A may be a website associated with a service provider 118, such as a news reporting/aggregation org, a social media/networking platform, or the like; and a second InOb 1642B may be a website associated with a vendor, such as a manufacturer or retailer that sells products or services. CCM 100 may adjust relevancy score 802 and resulting consumption scores 810 based on InOb(s) 112 being located on publisher InOb 1642A or located on vendor InOb 1642B. For example, it has been discovered that a user may be closer to making a purchase decision when viewing content on a vendor website 1642B compared to viewing similar content on a publisher website 1642A. Accordingly, CCM 100 may increase relevancy score 802 associated with InOb(s) 112 located on a vendor website 1642B or otherwise weight relevancy score 802 for InOb(s) 112 located on a vendor website 1642B more than InOb(s) 112 located on a service provider 118 website 1642A.

CCM 100 may use the increased relevancy score 802 to calculate consumption scores 810 as described previously. The classification based consumption scores 810 may be used to determine surges 812 as described with respect to FIG. 9 that more accurately indicate when orgs are ready to purchase or otherwise consume products, services, and/or resources associated with topics 102.

For purposes of the present disclosure, a service provider website 1642A may refer to any website that focuses more on providing informational content compared to content primarily directed to selling products or services. For example, the service provider 118 may be a news service or blog that displays news articles and commentary, a service org or marketer that publishes content, a social media platform that publishes third-party and/or social media users' content, and/or the like. For purposes of the present disclosure, a vendor website 1642B may contain content primarily directed toward selling products or services and may include resources/websites operated by manufacturers, retailers, distributers, wholesalers, and/or any other intermediary.

The example explanations below refer to service provider websites and vendor websites. However, it should be understood that the schemes described below may be used to classify any type of website that may have an associated structure, content, or type of user engagement. It should also be understood that the classification schemes described below may be used for classifying any group of content including different content located on the same website or content located for example on servers or cloud systems.

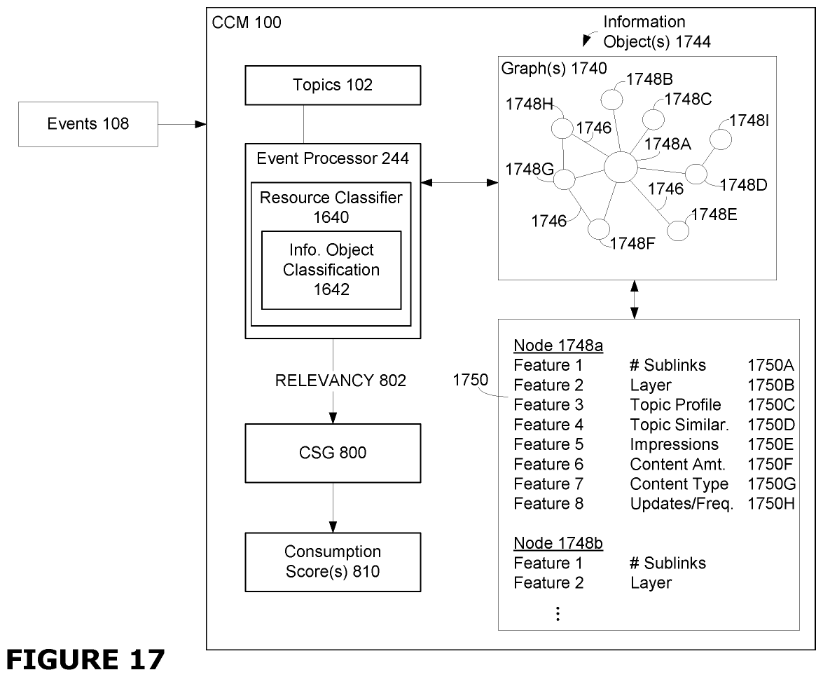

FIG. 17 shows an example of resource classifier 1640 operation according to various embodiments. In this embodiment, the resource classifier 1640 generates one or more graphs 1740 for one or more InObs 1744 (e.g., web resources such as websites, individual web pages, and/or the like) accessed by users or things. In one example, the resource classifier 1640 generates one graph 1740 for a corresponding InOb 1744. The resource classifier 1640 may use any suitable graph drawing algorithm to generate the graph(s) 1740 such as, for example, a force-based graph algorithm, a spectral layout algorithm, and/or the like, such as those discussed in Tarawneh et al., “A General Introduction To Graph Visualization Techniques”, Visualization of Large and Unstructured Data Sets: Applications in Geospatial Planning, Modeling and Engineering-Proceedings of IRTG 1131 Workshop 2011, Schloss Dagstuhl-Leibniz-Zentrum fuer Informatik, pp. 151-164 (2012) and/or Frishman, “Graph Drawing Algorithms in Information Visualization.” Diss. Comp. Sci. Dep., Technion - Israel Institute of Technology (Jan. 2009), available at: http://www.cs.technion.ac.il/users/wwwb/cgi-bin/tr-info.cgi/2009/PHD/PHD-2009-02, each of which are hereby incorporated by reference in their entireties.

The graph 1740 in the context of the present disclosure refers to a data structure or data type that comprises a number of (or set of) nodes 1748 (also referred to as “vertices 1748”, “points 1748”, or “objects 1748”), which are connected by a number of (or set of) edges 1746, arcs, or lines. A graph 1740 may be undirected or directed. In this embodiment, the graph 1740 may be an undirected graph, wherein the edges 1746 have no orientation and/or pairs of nodes 1748 are unordered. In other embodiments, the graph 1740 may be a directed graph in which edges 1746 have an orientation, or where the pairs of vertices 1748 are ordered. An edge 1746 has two or more vertices 1748 to which it is attached, called endpoints or nodes 1748. Edges 1746 may be directed or undirected; undirected edges 1746 may be referred to as “lines” and directed edges 1746 may be referred to as “arcs” or “arrows.”

In the example of FIG. 17, the graph 1740 includes multiple nodes 1748, where each node 1748 is associated with a content item or other elements on, or accessible through, an InOb 1744. In one example, the InOb 1744 is a website and each node 1748 is a webpage belonging to the website. In another example, the InOb 1744 is a webpage and each node 1748 is a data element that contains a data item, a content item, and/or one or more attributes (if any) (e.g., as indicated by an opening tag, closing tag, and any content therebetween). Additionally or alternatively, one or more of the nodes 1748 may be a component of web app 1744. In another example, the graph 1740 may be a tree data structure such as a Document Object Model (DOM) data structure of an InOb 1744, or one or more elements that make up the InOb 1744. The DOM is a data representation of the objects that comprise the structure and content of an InOb 1744 (e.g., a webpage or web app, XML document, etc.). The DOM is an object-oriented representation of the InOb 1744, which can be modified with a scripting language such as JavaScript or the like. The scripting language may utilize a DOM API (e.g., the HTML DOM API or the like) to access and/or manipulate the DOM. In another example, the InOb 1744 is a scripting language document (e.g., JavaScript) and each node 1748 is a data element and/or object including any attributes, properties, data/content, etc. In another example, the InOb 1744 is an archive file or a file path/directory, and each node 1748 is a file contained inside the archive file or file path/directory including the content of each file (if any). Any of the aforementioned examples could be combined with any other example, and/or any other InOb 1744 may be used/analyzed in other embodiments.

As an example, each node 1748 in the graph 1740 may represent individual web resources (e.g., referred to as “webpages 1748” or “web resource 1748”) on a website 1744, and the edges 1746 between the individual nodes 1748 may represent links or other like relationships between the different nodes 1748 (also referred to as “sublinks 1746” or “links 1746”). In this example, a first home page 1748A on website 1744 may include sublinks to webpages 1748B-1748H. Webpage 1748G may include second level sublinks 1746 to webpages 1748H and 1748F. Webpage 1748D may include a second level sublink 1746 to webpage 17481.

Resource classifier 1640 may classify InOb 1744 based on the structure of graph 1746. Continuing with the previous example, home page 1748A in graph 1740 may include sublinks 1746 to many sub-webpages 1748B-1748H. Graph 1740 may also include only a few webpage sublevels below home page 1748A. For example, nodes 1748B-1748H are located on a first sub-level below home page 1748A. Only one additional webpage sublevel exists that includes webpage 17481.

In some embodiments, a website 1744 with a home page 1748A with a relatively large number of sublinks 1746 to a large number of first level subpages 1748B-1748H more likely represent a vendor website 1744. For example, a vendor website may include multiple products or services all accessed through the home page. Further, a vendor website 1744 may have a relatively small number of lower level sublinks 1746 and associated webpage sublevels (shallow depth). In this example, resource classifier 1640 may predict website 1744 as associated with a vendor.

In another example, home page 1748A may include relatively few sublinks 1746 to other webpages 1748. Further, there may be many more sublayers of webpages 1748 linked to other webpages. In other words, graph 1740 may have a deeper tree structure. In this example, resource classifier 1640 may predict website 1744 as associated with a service provider 118.

Based on the structure of graph 1740 in FIG. 17, resource classifier 1640 may predict website 1744 is a vendor website. A company accessing a vendor website may indicate more urgency in a company intent to purchase a product associated with the website. Accordingly, site classifier 1640 may increase the relevancy scores 802 produced from InOb(s) 112 accessed from vendor website 1744.

This is just one example of how resource classifier 1640 may classify websites 1744 based on an associated webpage structure. In other embodiments, the resource classifier 1640 may classify websites 1744 based on one or more machine learning (ML) features 1750 (or simply “features of 1750”) extracted from InObs 1744 (e.g., extracted from HTML in webpages of a website at URLs 952 identified in events 108).

In embodiments, the resource classifier 1640 first determines if a graph 1740 already exists for the InOb 1744 associated with URL 952 in event 108. If a graph 1740 already exists, resource classifier 1640 may check a timestamp 958 in event 108 with a timestamp assigned to graph 1740 to determine if the graph 1740 should be updated (e.g., the timestamp assigned to graph 1740 is earlier in time than the timestamp 958, or vice versa). If a graph 1740 has not been created for InOb 1744 or the graph 1740 needs or should be updated, resource classifier 1640 obtains the InOb and analyzes the elements of the obtained InOb (e.g., by downloading the HTML for the webpages on website 1744).

In embodiments, the resource classifier 1640 extracts or otherwise generates one or more ML features 1750 for each node 1748 and generates an associated graph 1740 based on those features 1750. For example, as a first feature 1750, the resource classifier 1640 determines the number of sublinks 1750A for each node 1748 contained in the graph 1740 based on the data elements and/or other aspects of the InOb 1744 (e.g., tags or other data elements in HTML documents). As a second feature 1750, the resource classifier 1640 identifies/determines the (sub)layer locations 1750B (e.g., sublinks 1750B) of respective nodes 1748 within graph 1740. For example, resource classifier 1640 may identify the fewest number of sublinks 1746 separating a node 1748 from the homepage node 1748A.

After identifying sublinks 1750B for each node 1748, the resource classifier 1640 may derive graph 1740 identifying the relationships between each node 1748. While shown graphically in FIG. 17, graph 1740 may also or alternatively be generated in a table format that identifies the relationships between different nodes 1748 and provides additional graph metrics, such as the number of node layers, the number of nodes on each node layer, the number of links for each node layer, and/or other like information/aspects.

As mentioned previously, the number of sublinks 1750A and/or the association of links 1746 with other nodes 1748 may indicate the structure and associated type or class of InOb 1744. In one embodiment, a deeper tree structure with more lower level nodes 1748 linked to other lower level nodes 1748 may indicate a service provider website 1744. Additionally or alternatively, a shallower tree structure with fewer node levels or fewer links at higher node levels may indicate a vendor website 1744.

As a third feature 1750, the resource classifier 1640 may generate a topic profile 1750C for each node 1748. For example, event processor 244 may use content analyzer 242 in FIG. 2 to identify a set of topics 102 contained in an InOb (e.g., webpage). The topic profile 1750C may provide an aggregated view of content of a particular node 1748.

As a fourth feature 1750, the resource classifier 1640 may also generate topic similarity values 1750D indicating the similarity of topics 102 of a particular node 1748 with topics 102 of other linked nodes 1748 on a higher graph level, the same graph level, lower graph levels, or the similarity with topics 102 for unlinked nodes 1748 on the same or other graph levels.

The relationships between topics on different nodes 1748 may also indicate the type of webpage 1748. For example, nodes 1748 on a service provider website 1744 may be more disparate and have a wider variety of topics 1750C than nodes 1748 on a vendor website 1744. In another example, similar topics for nodes 1748 on a same graph level or nodes on a same branch of graph 1740 may more likely represent a vendor website.

The resource classifier 1640 may identify topic similarities 1750D by identifying the topics on a first webpage, such as home webpage 1748A. The resource classifier 1640 then compares the home page topics with the content on a second webpage. Content analyzer 142 in FIG. 2 then generates a set of relevancy scores indicating the relevancy or similarity of the second webpage to the home page. Of course, resource classifier 1640 may use other natural language processing (NLP) and/or Natural Language Understanding (NLU) schemes to identify topic similarities between different nodes 1748. The resource classifier 1640 may generate topic similarities 1750D between any linked nodes 1748, nodes 1748 associated with a same or different graph levels, or any other node relationship.

As a fifth feature 1750, the resource classifier 1640 may generate impressions 1750E for each InOb 1748. As described previously in FIGS. 14 and 15, CCM 100 may generate consumption scores 810 and identify company surges 812 based on user EM 1410. The impressions 1750E may indicate a level of engagement or interest the user has the webpage 1748. For example, impressions 1750E may indicate how long the user dwelled on a particular webpage 1748, how the user scrolled through content in the webpage 1748, touch data when touch interfaces are used, gaze times and/or gaze locations when eye tracking technologies are used, and/or the like. The user may spend more time on a webpage and scroll at a slower speed when more interested in the webpage InOb(s) 112. Longer gaze times at certain regions of interest may also indicate user interest in a certain InOb or content.

The resource classifier 1640 may use impressions 1750E to classify web resources 1744. For example, users on a news website 1744 may on average spend more time reading articles on individual webpages 1748 and may scroll multiple times through relatively long articles. Users on a vendor website 1744 may on average spend less time viewing different products and scroll less on relatively short webpages 1748. A user may also access a news website more frequently, such as every day or several times a day. The user may access vendor websites 1744 much less frequently, such as only when interested in purchasing a particular product or service. In addition, users may spend more time on more webpages of a news-related website when there is a particular news story of interest that may be distributed over several service provider news stories. This additional engagement on the news website could be mistakenly identified as a company surge, when actually the additional engagement is due to a non-purchasing related news topic. On the other hand, users from a same company viewing multiple vendor websites within a relatively short time period, and/or the users viewing the vendor websites with additional engagement, may represent an increased company urgency to purchase a particular product. Accordingly, the resource classifier 1640 may take these different behavior patterns into account when classifying different InObs 1744. It should be noted that other types/classes of InObs 1744 may be identified/determined and the resource classifier 1640 may accommodate or account for different user behaviors for those types/classes of InObs 1744 when performing various classification operations.

The resource classifier 1640, or another module/element in event processor 244, may generate engagement scores 812 (“surge scores 812”) for each node 1748 of the InOb 1744 as described previously with respect to FIGS. 14 and 15. The resource classifier 1640 may then classify the InOb 1744 as a particular type/class (e.g., service provider) based at least partially on nodes 1748 having higher engagement scores where users on average spend more time on the webpages 1748, and visit the webpages 1748 more frequently. resource classifier 1640 may classify web resources 1744 as a particular type/class (e.g., a vendor website) based at least partially on webpages 1748 having lower engagement scores where users spend less time on the webpage and visit the webpage less frequently, or have more isolated engagement score increases. In addition, resource classifier 1640 may classify a web resource 1744 as a vendor website when the users view content associated with pricing.

The resource classifier 1640 may generate an average engagement score 812 for the nodes 1748 of the same InOb 1744 and use this average engagement score 812 as the engagement score 812 for that InOb 1744. Additionally or alternatively, the resource classifier 1640 may increase the relevancy score 802 when the amount and pattern of engagement scores 812 indicate a vendor website 1744 and may reduce relevancy score 802 when the amount and pattern of engagement score 812 indicates a service provider website 1744.

Different types of InObs may contain different amounts of content. For example, individual webpages 1748 on a service provider website 1744 may generally contain more text (deeper content) than individual webpages 1748 on a vendor website (shallower content). In embodiments, the resource classifier 1640 may calculate as a sixth feature 1750, the amounts of content 1750F for individual nodes 1748 in InObs 1744. For example, resource classifier 1640 may count the number of words, paragraphs, documents, pictures, videos, images, etc. contained in individual webpages 1748. In some embodiments, different weights or scaling factors may be applied to different types of content when determining the sixth feature 1750.

In some embodiments, the resource classifier 1640 may calculate an average amount of content 1750F in nodes 1748 on the same website 1744. For example, an average content amount (e.g., within some threshold range or the like) may more likely represent a service provider website 1744 and a less-than-average amount of content 1750F (e.g., below some threshold amount) may more likely represent a vendor website 1744. In these cases, the resource classifier 1640 may increase relevancy score 802 when the average amount of content 1750F indicates a vendor website 1744 and may reduce relevancy score 802 when the average amount of content 1750F indicates a service provider website 1744.

Different types of InObs may contain different types of content. For example, service provider websites 1744 may contain more advertisements than vendor website 1744. In another example, vendor sites may have a “contact us” webpage, product webpages, purchase webpages, etc. A “contact us” link in a service provider website may be hidden in several levels of webpages compared with a vendor website where the “contact us” link may be located on the home page. A vendor website may also have a more prominent hiring/careers webpage. In these embodiments, the resource classifier 1640 may identify/determine, as a seventh feature 1750, different types and locations of content 1750G in the InOb's source code (e.g., webpage HTML). In one example, the resource classifier 1640 may identify inline frames (iframe) in the webpage HTML. The HTML inline frame element (<iframe>) represents a nested browsing context, embedding another HTML page into a current HTML page. An iframe may be an HTML document embedded inside another HTML document and is often used to insert content from another source, such as an advertisement.

Additionally or alternatively, other types of content 1750G may be associated with particular types of InObs 1744. For example, vendor websites may include more webpages associated with employment opportunities or include webpages identifying the management team of the company. In another example, both service provider webpages and vendor webpages may include links to employment opportunities. However, vendor websites may more frequently locate a prominent link from homepage to employment opportunities service provider websites may more frequently embed links to the employment opportunities among many other links to service provider news content. The total number of links from a vendor homepage may be less and a “Careers” page link will be, for example, 1 out of 10 total links. A service provider homepage may have many more links and include the careers opportunity link nested within them.

The resource classifier 1640 may also classify web resources 1744 based on these other content type features 1750G and/or content locations features 1750G. The content type features 1750G may be or indicate the type of content embedded in web resources 1744 and/or otherwise rendered within web resources 1744 such as, for example, text, images, graphics, audio, video, animations, and/or the like. The content type features 1750G may also include or account for styles employed by the web resources 1744 (e.g., various color schemes, fonts, etc. as indicated by a Cascading Style Sheet (CSS) or other style sheet language documents) and/or various user interface elements employed by the web resources 1744. The content locations features 1750G may include, indicate, or refer to the position and/or orientation of content items within a web resource 1744 with respect to some reference or with respect to some other content item (e.g., based on the CSS position property or the like). In some embodiments, resource classifier 1640 may also identify “infinite scroll” techniques or “virtual page views” as features 1750G that allow web resource visitors to continually scroll through (up/down) a page, and, at end of content, produce a new article to continue reading within the same page without clicking a link. Examples of such websites include Facebook.com, Forbes.com, Businesslnsider.com, and the like.

The resource classifier 1640 may also classify web resources 1744 based on content update frequency features 1750H. For example, a service provider web resource 1744 may update and/or replace content, such as news articles, more frequently than a vendor website replaces webpage content for products or services. In embodiments, the resource classifier 1640 identifies topics on the web resources 1744, 1748 over some period of time (e.g., every day, week, or month), and generates an update value/feature 1750H indicating the frequently of topics changes on the web resources 1744, 1748 over the period of time. In some implementations, a higher update values 1750H may indicate service provider resources 1744, 1748 and a lower update values 1750H may indicate vendor resources 1744, 1748.

The resource classifier 1640 may use any combination of features 1750 to classify InObs 1744. Additionally, the resource classifier 1640 may weight some features 1750 higher than other features 1750. For example, the resource classifier 1640 may assign a higher vendor score to a website 1744 identified with a shallow graph structure 1740 compared with identifying website 1744 with relatively shallow content 1750F.

In embodiments, the resource classifier 1640 generates a classification value for InOb 1744 based on the combination of features 1750 and associated weights (if any). The resource classifier 1640 then adjusts relevancy score 802 based on the classification value. In one example, the resource classifier 1640 may increase relevancy score 802 or consumption score 810 more for a larger vendor classification value and may decrease relevancy score 802 or consumption score 810 more for a larger service provider classification value.

FIG. 18 shows an example process 1800 for identifying surge scores 812 based on resource classifications according to various embodiments. Process 1800 begins at operation 1802 where the resource classifier 1640 receives an event 108 (e.g., from tags 110) that includes various event data such as an ID, URL, event type, engagement metrics, and/or any other information identifying content, activity, user interaction, etc., associated with an InOb 112. In some embodiments, resource classifier 1640 first may determine if a graph 1740 already exists for the InOb 112 associated with the URL included in the event 108. If an up-to-date graph 1740 exists, the resource classifier 1640 may have already classified the InOb 112. If so, resource classifier 1640 may adjust any derived relevancy scores 802 based on the resource classification. Otherwise, the resource classifier 1640 may proceed to operation 1804 to determine the structure of the InOb 112.

At operation 1804, the resource classifier 1640 determines the structure of the InOb 112 by, for example, analyzing the InOb 112 to identify the various nodes 1748 making up the InOb 112. Additionally or alternatively, operation 1804 may include generating a graph 1740 for the InOb 112. In one example, the resource classifier 1640 crawls through the InOb 112 and identifies and/or determines each node making up the InOb 112 and identifying/determining the links/relationships between each of the nodes 1748. In one example, when the InOb 112 is a website, the resource classifier 1640 starts the crawling beginning at a home page of the website associated with the received event. Additionally or alternatively in this example, the resource classifier 1640 identifies links on the home page to other webpages. The resource classifier 1640 then identifies links in the HTML of the lower level pages to other pages to generate a website graph or tree structure 1740 as shown in FIG. 17. In another example, the generated tree structure 1740 may similar to a DOM or the like.

At operation 1806, the resource classifier 1640 extracts various features from/for each node 1748 as described previously. For example, when the InOb 112 is a website, the resource classifier 1640 may identify the number of sublinks, layers of webpages, topics, engagement metrics (e.g., impressions, etc.), amounts and types of content, number of updates, etc. associated with each webpage.

At operation 1808, the resource classifier 1640 classifies the InOb 112 based on the identified/determined structure (e.g., see e.g., operation 1804) and the extracted/generated features 1750 (e.g., see e.g., operation 1806). In one example, the resource classifier 1640 may use any combination of the features 1750 discussed previously to generate a classification value for the InOb 112. As explained previously, the resource classifier 1640 may also weigh different node features 1750 differently. For example, the resource classifier 1640 may assign a larger weight to a website graph structure indicating a service provider website and assign a lower weight to a particular type of content associated with service provider websites. Based on all of the weighted features 1750, the resource classifier 1640 may generate the classification value predicting the type of InOb 112.

At operation 1810, the resource classifier 1640 adjusts the relevancy score 802 for org topics based on the classification value. For example, resource classifier 1640 may increase the relevancy score 802 more for a larger vendor classification value and may reduce the relevancy score more for a larger service provider classification value. Other implementations are possible in other embodiments.

### 7. Structure Based Topic Prediction Embodiments

The CCM 100 may use the InOb structure and features 1750 described previously to improve topic predictions for InObs 1744, 112 or for individual nodes 1748. For example, when an InOb 1744, 112 is a website, the CCM 100 may identify a most influential page 1748 of the website 1744, which may be a page 1748 with the most links, the most content, the most user visits, or having some other aspects/features greater or different than other pages 1748 of the website 1744. Webpages 1748 that are a closer distance to the most influential webpage 1748 (e.g., with fewer number of links or hops from the most influential webpage 1748) may be identified as more influential than webpages 1748 that are at a further distance from the most influential webpage 1748. For example, a webpage 1748 separated from most of the other webpages 1748 and with few sublinks may be identified as less influential in website 1744 than webpages 1748 with more connections to other webpages 1748. In this example, the CCM 100 may increase the topic prediction values for more influential webpages 1748 or webpages 1748 directly connected to the most influential webpages 1748 and/or reduce the topic prediction values for less influential webpages 1748.

In some embodiments, the resource classifier 1640 may modify relevancy scores 802 based on the org associated with the website 1744. For example, resource classifier 1640 may increase the relevancy score 802 for an identified vendor website 1744 and/or the resource classifier 1640 may increase relevancy score 802 even more for websites 1744 operated by the org requesting the consumption score 810.

In various embodiments, the CCM 100 and/or the resource classifier 1640 may use the structure of graph 1740 to train topic models. For example, during ML model training, the topic model may generate topic relevancy ratings (e.g., relevancy scores 802) for different InObs 1744, 112 (e.g., individual webpages 1748 of a website 1744). In some cases, the ML model may not accurately identify the topics on a first webpage 1748 but may accurately identify the topics on other closely linked webpages 1748. During training and testing, model performance may be rated not only on the accuracy of identifying topics 102 on one particular webpage 1748 but also rated based on the accuracy of identifying related topics 102 on other closely linked pages 1748.

### 8. Resource Fingerprinting Embodiments

In various embodiments, the resource classifier 1640 may generate vectors that represent the different features of resources (e.g., webpages, websites, and/or other InObs), and uses a suitable machine learning (ML) model to classify the different resources based on the feature vectors (the feature vectors may be referred to herein as “resource embeddings”, “webpage embeddings”, or the like). The feature vectors provide more accurate resource classifications than existing classification techniques while using fewer computing resources for classification tasks than existing classification techniques.

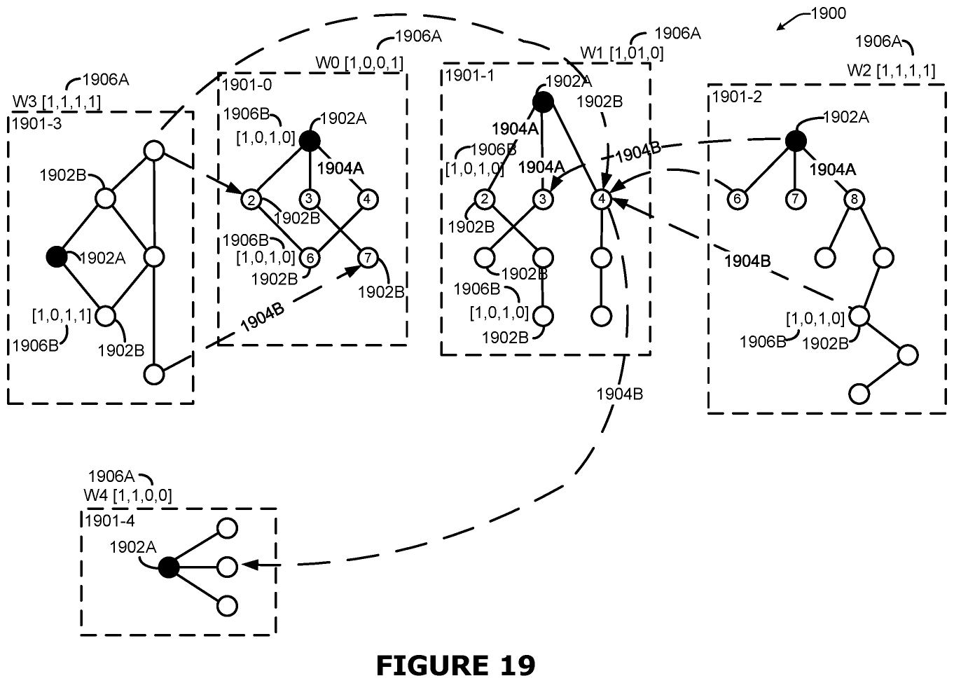

FIG. 19 shows an example structure for a network 1900 that includes multiple resources 1901, including resource 1901-0, resource 1901-1, resource 1901-2, resource 1901-3, and resource 1901-4 (alternatively referred to as W0, W1, W2, W3, and W4, respectively). In one example, individual resources 1901 are associated with different types of orgs, host/serve different content, and/or have other aspects and/or properties. Individual resources 1901 may be classified (or assigned to one or more classes) based on one or more aspects and/or properties of the individual resources 1901.

One or more resources 1901 may include a collection of resources 1902 alternatively referred to as nodes. Each resource 1901 may include a root node 1902A and a set of other lower tiered nodes 1902B. Each resource 1902 has a specific identifier or address alternatively referred to as a link 1904. One or more resources 1901 may reference or link to other resources 1902 belonging to a same resource 1901 and/or other resources 1902 belonging to another resource 1901. In one example, each resource 1901 may be a website and each resource 1902 may be a webpage that is part of a website. In this example, webpages 1902 may include URLs 1904A that link to other webpages 1902 within the same website 1901 and/or may include URLs 1904B that link to webpages 1902 on other resources 1901.

In the example of FIG. 19, W0 and W1 are vendor websites, W2 is a marketer website, W3 is a news website, and W4 is any other class of website. As explained previously, vendor websites W0 and W1 may contain content primarily directed toward selling or promoting products or services and may include websites operated by manufacturers, retailers, or any other intermediary. Marketer websites W2 may be operated by organizations that provide content directed to marketing or promoting different products, such as an online trade magazine. News websites W3 may be operated by news services or blogs that contain news articles and commentary on a wide variety of different subjects. Website W4 may be any other class of website. For example, website W4 may be a website operated by an individual or operated by an entity not primarily focused on selling products or services.

### 9. Structural Semantics

Still referring to FIG. 19, across resources 1901, the relationships (e.g., links 1904A) between webpages 1902 on the same resources 1901 and relationships (e.g., links 1904B) between webpages 1902 on other resources 1901 are referred to generally as structural semantics. In one example, the resource classifier 1640 uses links 1904 to capture the structural semantics across all resources 1901.

As explained previously, vendor websites W0 and W1 may have different structural semantics than marketer website W2 or news website W3. For example, vendor website W0 may have a different tree structure of links 1904A from root node 1902A to lower nodes 1902B compared with marketer website W2 or news website W3. Vendor websites W0 and W1 also may have more links from root node 1902A to lower level resources 1902B. Vendor website W0 also may have relatively fewer links 1904B to other resources 1901, compared with marketer website W2 or news website W3. In this example, there are no external links 1904B connecting the two vendor websites W0 and W1 together. However, marketer website W2 and news website W3 may discuss products or services sold on vendor websites W0 and W1, and therefore, may include more external links 1904B to these resources 1901. Thus, marketer website W2 and news website W3 may have the unique quality of including more links 1904B to webpages 1902 on vendor websites W0 and W1.

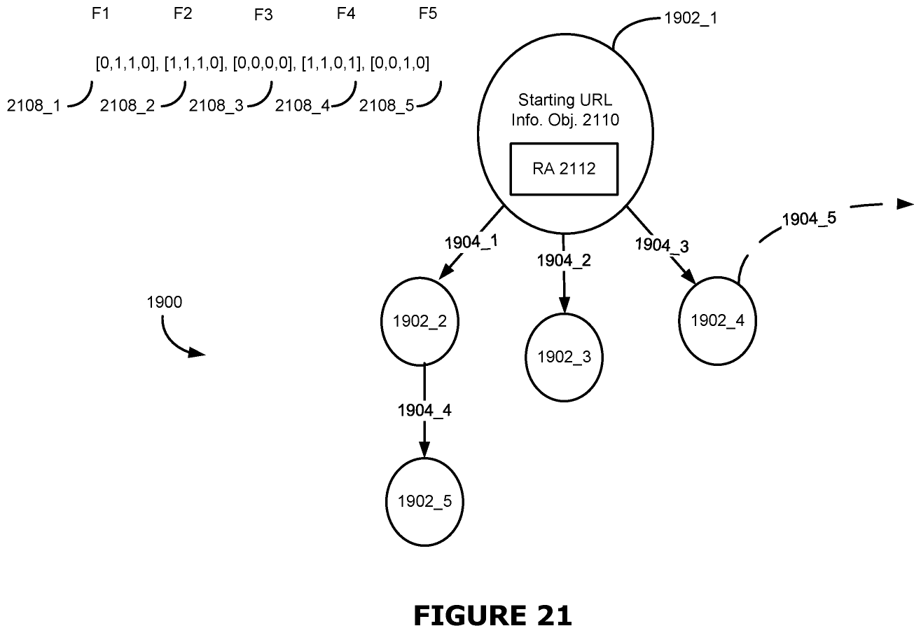

In some implementations, the resource classifier 1640 uses these relationships to capture the structural semantics across all InObs 112 of a set of InObs 112. In one example, an analyzer (e.g., resource analyzer 2112 of FIG. 21) systematically browses individual InObs 112 to identify what is conceptually equivalent to a language for a particular network 1900. The analyzer may start from a particular node 1902 in an InOb (website) 1901 and identify paths to other nodes. For example, the analyzer may identify the following path [2, 1, 3, 5, 8] formed by links 1904 in resources 1902 referencing other resources 1902.

In FIG. 19, node 2 of website W1 is linked through a hyperlink 1904A to node 1 in website W1, node 1 in website W1 is linked through another hyperlink 1904A to node 3 in website W1, node 3 in website W1 is linked through another hyperlink 1904B to node 5 in website W2, and node 5 in website W2 is linked through another hyperlink 1904A to node 8 in website W2, etc.

The generated path [2, 1, 3, 5, 8] is conceptually equivalent or similar to a sentence of words, effectively representing an instance of a natural language structure for network 1900 or set of InObs 112. Suitable word embedding techniques in NLP, such as Word2Vec (see e.g., Mikolov et al., “Efficient Estimation of Word Representations in Vector Space.” arXiv preprint arXiv:1301.3781 (16 Jan. 2013), which hereby incorporated by reference in its entirety) are used to convert individual words found across numerous examples of sentences within a corpus of documents into low-dimensional vectors, capturing the semantic structure of their proximity to other words, as exists in human language. Similarly, website/network (graph) embedding techniques such as Large-scale Information Network Embedding (LINE), Graph Neural Network (GNN) such as DeepWalk (see e.g., Perozzi et al., “DeepWalk: Online Learning of Social Representations”, arXiv:1403.6652v2 (27 Jun. 2014), available at: https://arxiv.org/pdf/1403.6652.pdf; 10 pages, which hereby incorporated by reference in its entirety), GraphSAGE (see e.g., Hamilton et al., “Inductive Representation Learning on Large Graphs”, arXiv:1706.02216v4 (10 Sep. 2018), which hereby incorporated by reference in its entirety), or the like can be used to convert sequences of InObs 112 found across a collection of InObs 112 (e.g., a collection of referenced websites) into low-dimensional vectors, capturing the semantic structure of their relationship to other pages.

The resource classifier 1640 uses suitable NLP/NLU technique(s) to convert the different paths, such as path [2, 1, 3, 5, 8] for node 2, into structural semantic vector(s) 1906B (also referred to as “embeddings”). The resource classifier may generate structural semantic vectors for each InOb 112 and feeds these vectors into a suitable ML model to classify the InObs 112. In one example, the resource classifier 1640 may generate structural semantic vectors 1906B for each resource 1902 in the same resource 1901. The resource classifier 1640 then combines the structural semantic vectors 1906B for the same resource 1901 together via a summation to generate a resource structural semantic vector 1906A. In this example, the resource classifier 1640 feeds resource vectors 1906A into a logistic regression model (and/or some other suitable ML model) that then classifies the resource 1901 as a particular type of resource (e.g., as a vendor, marketer, or news provider in this example).

### 10. Resource Semantic Features and Interaction Features

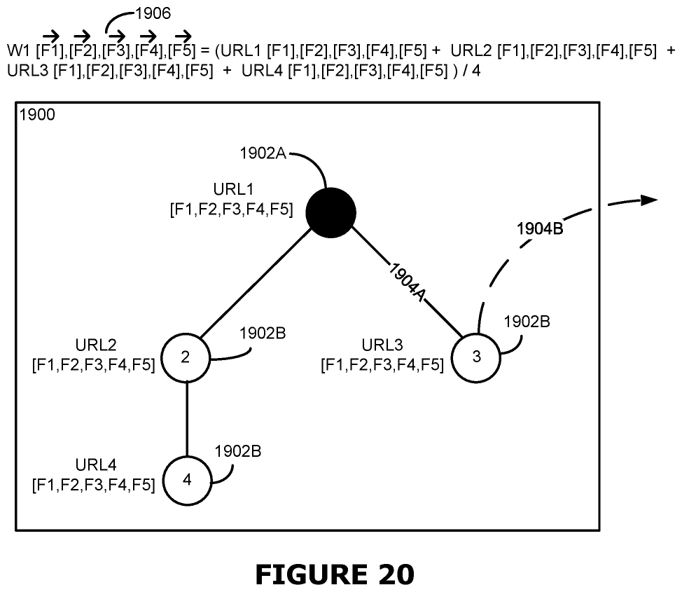

FIG. 20 shows in more detail one particular resource 1901. As mentioned above, the resource classifier 1640 may classify resource 1901 based on structural semantic features. The resource classifier 1640 may generate and use additional features of webpages 1902 to classify resource 1901. Features generated by the resource classifier 1640 may include but is not limited to the features described in Table F1.

TABLE F1

| Feature | Feature Name | Description |
|---|---|---|
| Feature | Structural | structural semantics F1 may be generated |
| F1 | Semantics | based on the structural relationships |
| | | between information objects such as |
| | | webpages 1902 provided by |
| | | references/links such as hyperlinks 1904 |
| Feature | Content | Content semantics F2 may capture the |
| F2 | Semantics | language and metadata semantics of |
| | | content contained within information |
| | | objects such as webpages 1902. |
| Feature | Topics | Topic features include identified topics |
| F3 | Semantics | contained in information objects such |
| | | as webpages 1902. Semantic features may |
| | | include semantic relationships between |
| | | two or more words or topics. |
| Feature | Content Interaction | Content interaction behavior is |
| F4 | Behavior | alternatively referred to as |
| | | content consumption or content use |
| Feature | Entity Type | The entity type feature identifies types |
| F5 | | or locations of industries, companies, |
| | | organizations, bot-based applications |
| | | or users accessing the webpage |
| Feature | Lexical | Lexical semantics refers to the |
| F6 | Semantics | grammatical structure of information |
| | | objects 112, and the relationships between |
| | | individual words in a particular context. |

Content semantics (feature F2) capture the language and metadata semantics of content contained within webpages 1902. For example, a trained NLP/NLU ML model may predict topics associated with the InObs, such as sports, religion, politics, fashion, or travel. Of course, any other topic taxonomy may be considered to predict topics from webpage content. In addition, the resource classifier 1640 can also identify content metadata, such as the breath of content, number of pages of content, number of words in webpage content, number of topics in webpage content, number of changes in webpage content, etc. Content semantics F2 also may include any other HTML elements that may be associated with different types of resources, such as Iframes, document object models (DOMs), etc.

Similar to structural semantic features (e.g., feature F1), vendor, marketing, and news resources 1901 may have different content semantics (feature F2). For example, a news website W3 may include content with more topics compared with a vendor website WO that may be limited to a small set of topics related to their products or services. Content on news website W3 also may change more frequently compared to vendor website WO. For example, content on news website W3 may change daily and content on vendor website WO related to products or services may change weekly or monthly.

Topic semantics (feature F3) may involve identifying topics and generating associated topic vectors as described above in FIG. 2. For example, CCM 100 may identify different business-related topics (e.g., B2b topics) in each webpage 1902, such as, for example, network security, servers, virtual private networks, and/or any other topic(s).

Content interaction behavior (feature F4) identifies patterns of user interaction/consumption on webpages 1902. For example, news site W3 in FIG. 19 may receive more continuous user interaction/consumption throughout the day and over the entire week and weekend. Marketer website W2 (e.g., trade publications) and vendor sites WO and W1 may have more volatile user consumption mostly restricted to work hours during the work week. Types of user consumption reflected in feature F4 may include, but is not limited to time of day, day of week, total amount of content consumed/viewed by the user, device type, percentages of different device types used for accessing InObs 112, duration of time users spend on an InOb 112 and total engagement user has on the InOb 112, the number of distinct user profiles accessing the InOb 112vs. total number of events for the InOb 112, dwell time, scroll depth, scroll velocity, variance in content consumption over time, tab selections that switch to different InObs 112, page movements, mouse page scrolls, mouse clicks, mouse movements, scroll bar page scrolls, keyboard page movements, touch screen page scrolls, eye tracking data (e.g., gaze locations, gaze times, gaze regions of interest, eye movement frequency, speed, orientations, etc.), touch data (e.g., touch gestures, etc.), and/or the like. Identifying different event types associated with these different user content interaction behaviors (consumption) and associated engagement scores is described in more detail herein. For example, the resource classifier 1640 may generate the content interaction feature F4 based on the event types and engagement metrics identified in events 108 associated with each webpage 1902.

In one example for Feature F5, the entity type feature identifies types or locations of industries, companies, organizations, bot-based applications or users accessing a particular InOb 112. For example, the CCM 100 may identify each user event 108 as associated with a particular enterprise, institution, mobile network operator, bots/crawls and/or other applications, and the like. Details on how to identify types of orgs and/or locations from which InObs 112 are accessed is described in U.S. application Ser. No. 17/153,673, filed Jan. 20, 2021, which is hereby incorporated by reference in its entirety.

Lexical semantics (feature F6) may be derived from an initial NLP/NLU analysis of the InObs 112 to identify lexical aspects of the InObs 112. As examples, these lexical aspects may include hyponyms (specific lexical items of a generic lexical item (hypernym), meronom (a logical arrangement of text and words that denotes a constituent part of or member of something), polysemy (a relationship between the meanings of words or phrases, although slightly different, share a common core), synonyms (words that have the same sense or nearly the same meaning as another), antonyms (words that have close to opposite meanings), homonyms (two words that are sound the same and are spelled alike but have a different meaning), and/or the like

Structural semantics (feature F1), content semantics (feature F2), topic semantics (feature F3), and/or lexical semantics (feature F6) may be collectively referred to as “information object semantic features”, “website semantic features”, or “resource semantic features.” Content interaction behavior (feature F4), entity type (feature F5), and any other user interactions with webpages may be collectively referred to as “behavioral features.”

In one example, the resource classifier 1640 generates one or more feature vectors F1-F5 for each resource 1902. The resource classifier 1640 then combines all of the same resource feature vectors to generate an overall resource feature vector 1906. For example, the resource classifier 1640 may add together the structural semantics feature vectors F1 generated for each of the individual resources 1902 in a resource 1901. The resource classifier 1640 then divides the sum by the number of resources 1902 to generate an average structural semantics feature vector F1 for resource 1901.

The resource classifier 1640 performs the same or similar averaging for each of the other features F2-F5 to form a combined feature vector 1906. The resource classifier 1640 feeds combined feature value 1906 into an ML model that classifies resource 1901 as either a vendor, marketer, or news site. Again, this is just one example, and any combination of features F1-F5, or any other features, can be used to classify resource 1901.

FIG. 21 shows an example of how the resource classifier 1640 generates feature vectors 2108 according to various embodiments. In this example, the feature vectors 2108 are vectors generated for features F1-F5. As explained previously, CCM 100 obtains InOb 2110 from a plurality of resources 1901 (e.g., millions or billions of resources 1901 in some implementations). InOb 2110 may include the markup (e.g., HTML, XML, etc.), script, program code, and/or other content from each webpage 1902. Additionally or alternatively, the InOb 2110 may include any text, video, audio, or any other data included with the markup, script, program code, and/or other content.

One or multiple resource analyzers (RAs) 2112 may start at random webpages 1902 within different resources and proceed/walk different paths through other webpages 1902. The RAs 2112 may be applications/engines that run/execute automated tasks (e.g., scripts or the like). The RAs 2112 may sometimes be referred to as “crawlers,” “bots”, and/or the like. The RAs 2112 identify the different paths through the different resources as explained previously with respect to FIG. 19 and/or using a suitable graph search/analysis algorithm. The paths are used for generating the structural semantics of each webpage 1902. InOb 2110 for each webpage 1902 is parsed to identify the different content semantics. Independent of the features generated from web crawling, content consumption events associated with each webpage are also processed to identify the behavioral features of each webpage 1902.

Vectors 2108 are then generated for each of the identified features F1-F5. In this example, vector 2108_1 represents the structural semantics feature F1 for webpage 1902_1, vector 2108_2 represents the content semantics feature F2 for webpage 1902_1, vector 2108_3 represents the topic feature F3 for webpage 1902_1, vector 2108_4 represents the content interaction feature F4 for webpage 1902_1, and vector 2108_4 represents the entity type feature F5 for webpage 1902_1.

TABLE F2

| Vector | Feature | |
|---|---|---|
| Vector 2108_1 | structural semantics feature F1 | [0, 1, 1, 0] |
| Vector 2108_2 | content semantics feature F2 | [1, 1, 1, 0] |
| Vector 2108_3 | topic feature F3 | [0, 0, 0, 0] |
| Vector 2108_4 | content interaction feature F4 | [1, 1, 0, 1] |
| Vector 2108_5 | entity type feature F5 | [0, 0, 1, 0] |

For example, resource analyzer 2112 fetches HTML for a webpage 1902_1. RA 2112 finds a link 1904_1 to a next lower webpage 1902_2. RA 2112 then parses the HTML for webpage 1902_2 for any other links. In this example, RA 2112 identifies a link 1904_4 to a next lower level webpage 1902_5. RA 2112 then parses HTML for webpage 1902_5 for any other links. In this example, there are no additional links in webpage 1902_5.

RA 2112 then parses the HTML in webpage 1902_1 for any additional links. In this example, RA 2112 identifies a next link 1904_2 to another lower level webpage 1902_3. RA 2112 parses the HTML in webpage 1902_3 and determines there are no additional links.

RA 2112 further parses the HTML in webpage 1902_1 and identifies a third link 1904_3 to webpage 1902_4. RA 2112 parses the HTML in webpage 1902_4 and identifies an external link 1904_5 to a webpage located on a different resource. RA 2112 then parses the HTML on the webpage located on the other resource for other links as described above.

RA 2112 continues crawling webpages until detecting a convergence of the same webpages on the same resources. Otherwise, RA 2112 may stop crawling through a web path if no new webpages or resources are detected after some threshold number of hops. RA 2112 then may crawl through the next link in webpage 1902_1. When all links in webpage 1902_1 are crawled, RA 2112 may start crawling the remaining links in the next webpage 1902_2.

As explained above, the different paths identified by web RA 2112 through webpage 1902_1, such as path [2, 1, 3, 5, 8] described above in FIG. 19, are converted by an unsupervised learning model, such as DeepWalk (Perozzi, Bryan et al. “DeepWalk: online learning of social representations.” KDD (2014)), LINE (Tang, Jian et al. “LINE: Large-scale Information Network Embedding.” WWW (2015)), or GraphSAGE (Hamilton, William L. et al. “Inductive Representation Learning on Large Graphs.” NIPS (2017)) into structural

Values in vector 2108_1 may represent different structural characteristics of webpage 1902_1. For example, values in vector 2108_1 may indicate the hierarchical position of webpage 1902_1 within resource 1901, the number of links to other webpages within resource 1901, the number of links to other webpages outside of resource 1901, etc. Structural semantic vector 2108_1 may capture first order proximity identifying direct relationships of webpage 1902_1 with other webpages. Vector 2108_1 also may capture second order proximity identifying indirect relationships of resource 1902_1 with other resources 1901, 1902 through intermediate resources 1901, 1902.

A natural language processor analyzes InOb 2110 to generate a vector 2108_2 for content semantic feature F2. The natural language machine learning algorithm may identify subjects, number or words, number of topics, etc. in the text of resource 1902_1. The natural language processor converts the identified topics, sentence structure, word count, etc. into content semantic vector 2108_2. A content semantic vector 2108_2 is generated for each webpage 1902 in resource 1901.

Content semantic vectors 2108_2 for different resources 1902 can becompared to identify resource similarities and differences which may provide further insight into resource classification. For example, a cosine similarity operation may be performed for different content semantic vectors 2108_2 to determine the similarity of topics for webpages 1902 on the same resources 1901 or to determine the similarities between topics on different resources 1901.

One example machine learning algorithm for converting text from a webpage into content semantic vector 2108_2 is Word2Vec described in Mikolov, Tomas et al. “Efficient Estimation of Word Representations in Vector Space.” CoRR abs/1301.3781 (2013), which is herein incorporated by reference in its entirety. Converting text into a multidimensional vector space is known to those skilled in the art and is therefore not described in further detail.

The resource classifier 1640 may generate a vector 2108_3 for topic feature F3. As described above, content analyzer 242 in FIG. 2 above generates vectors of topic 236 (or “topic vectors 236”) for different InObs (e.g., webpages). The resource classifier 1640 may use a same or similar content analyzer as content analyzer 242 to generate B2B topic vector 2108_3 for webpage 1902_1. Each value in B2B topic vector 2108_3 may indicate the probability or relevancy score of an associated business-related topic within InOb 2110. In one example, content semantics vector 2108_2 may represent a more general language structure in InOb 2110 and B2B topic vector 2108_3 may represent a more specific set of business-related topics in InOb 2110.

In some embodiments, the resource classifier 1640 generates a vector 2108_4 for content interaction feature F4. Vector 2108_4 identifies different user interactions with webpage 1902_1. The resource classifier 1640 may generate vector 2108_4 by analyzing the events 108 associated with webpage 1902_1. For example, each event 108 described above may include an event type 456 and engagement metric 610 identifying scroll, time duration on the webpage, time of day, day of week webpage was accessed, variance in consumption, etc. Each value in vector 2108_4 may represent a percentage or average value for an associated one of the event types 456 for a specified time period.

For example, the resource classifier 1640 may identify all of the events 108 for a specified time period associated with webpage 1902_1. The resource classifier 1640 may generate content interaction vector 2108_4 by identifying all of the same event types in the set of events 108. The resource classifier 1640 then may identify the percentage of events 108 associated with each of the different event types. The resource classifier 1640 uses each identified percentage as a different value in content interaction vector 2108_4.

For example, a first value in content interaction vector 2108_4 may indicate the percentage of events generated for webpage 1902_1 during normal work hours and a second value in content interaction vector 2108_4 may indicate the percentage or ratio of events generated for webpage 1902_1 during non-work hours. Other values in content interaction vector 2108_4 may identify any other user engagement or change of user engagement with webpage 1902_1.

The resource classifier 1640 generates a vector 2108_5 for entity type feature FS. Vector FS identifies different types of users interacting with webpage 1902_1. The resource classifier 1640 may generate vector 2108_5 by analyzing all of the events 108 associated with webpage 1902_1. For example, each event 108 may include an associated IP address. As mentioned above, CCM 100 may identify the IP address as being associated with an enterprise, small-medium business (SMB), educational entity, mobile network operator, hotel, etc.

The resource classifier 1640 identifies the events 104 associated with webpage 1902_1 for a specified time period. The resource classifier 1640 then identifies the percentage of the events associated with each of the different entity types. For example, the resource classifier 1640 may generate an entity type vector 2108_5 =[0.23, 0.20, 0.30, 0.17, 0.10] where [% enterprise, % small medium business, % education, % mobile network operators, % hotels].

As mentioned above in FIG. 20, The resource classifier 1640 calculates the average for feature vectors 2108_1, 2108_2, 2108_3, 2108_4, and 2108_5 generated for all of the webpages 1902 associated with the same resource 1901 to generate an overall resource feature vector 1906 as shown in FIG. 20. Each of the different features F1-F5 provide additional information for more accurate site classifications.

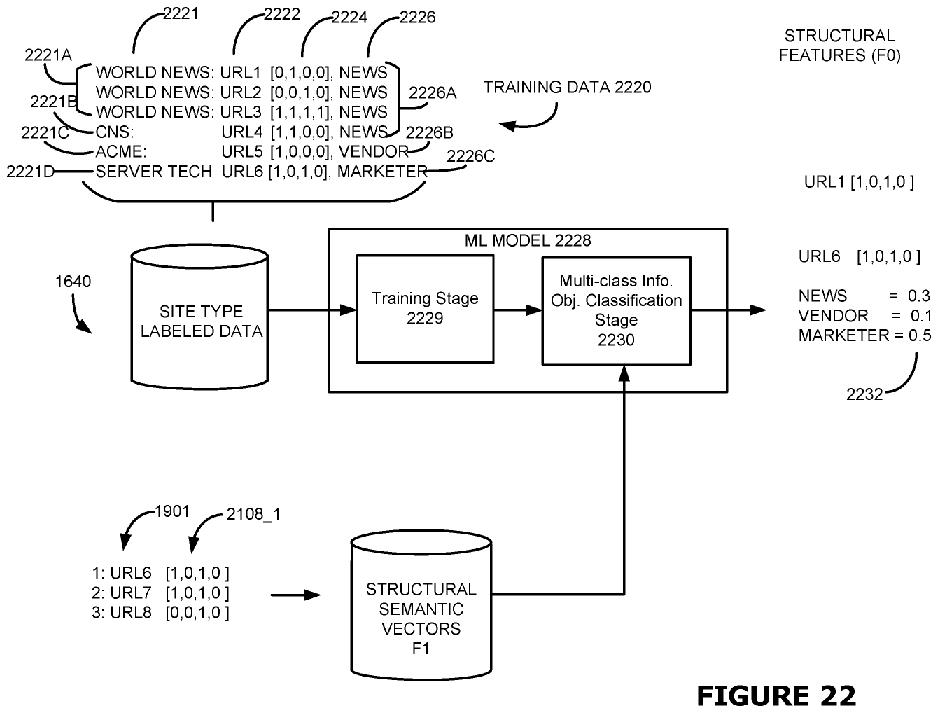

FIG. 22 depicts an example of how the resource classifier 1640 classifies an InOb based on structural semantic features Fl. However, it should be understood that the resource classifier 1640 may classify InObs based on any combination of features F1-F6 described previously and/or any other features.

The resource classifier 1640 may receive a set of training data 2220 that includes the URLs 2222 and associated structural semantic (SS) vectors 2224 for a set of known webpages. The resource classifier 1640 (or RA 2112) may analyze (e.g., crawl through) a set of resources/nodes (URLs 2222) on resources 2221 with known classifications 2226. For example, a known news website 2221A may include three webpages with URL1, 2, and 3. The resource classifier 1640 may crawl each URL 1, 2, and 3 over a previous week to generate associated SS vectors 2224. URLs 1, 2, and 3 are from a known news website and accordingly are manually assign news classification 2226A. The resource classifier 1640 also generates SS vectors 2224 for URL4 associated with another known news website 2221B, URL5 associated with a known vendor website 2221C, and URL6 associated with a known marketer website 2221D. Of course, SS vectors 2224 may be generated for each webpage 2222 on each of websites 2221. The operator assigns each SS vector 2224 its known site classification 2226.

The resource classifier 1640 feeds training data 2220 that includes SS vectors 2224 and the associated known site classifications 2226 into an ML model 2228. For example, ML model 2228 may be a logistic regression (LR) model or Random Forest model. Other types of supervised ML models can also be used in other embodiments. ML model 2228 uses training data 2220 during a training stage 2229 to identify the characteristics of SS vectors 2224 associated with each site classification 2226. After model 2228 has completed training stage 2229, it then operates as a site classifier in website classification stage 2230.

Structural semantic vectors 2108_1 are generated for different resources 1901 with unknown classification as described above. SS vectors 2108_1 are fed into model 2228. Model 2228 generates resource prediction values 2232 for each resource 1901 and/or for individual InObs and/or content items making up a resource 1901. For example, ML model 2228 may predict the website associated with URL6 as having a 0.3 likelihood of being a news website, 0.1 likelihood of a vendor website, and a 0.5 likelihood of a marketer website.

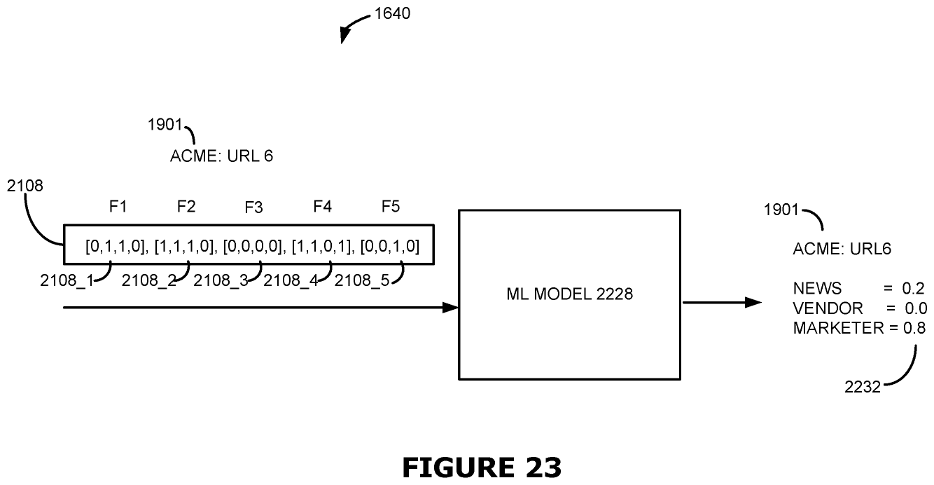

FIG. 23 depicts an example of the resource classifier 1640 using multiple feature vectors 2108 to classify resource(s) 1901. In this example, website 1901 is associated with a resource identifier (e.g., URL6). The resource classifier 1640 generates vector 2108_1 from the structural semantic features Fl of the content/InObs of the resource 1901 (e.g., webpages of a website), and generates vector 2108_2 from the content semantic features F2 of the content/InObs of the resource 1901. The resource classifier 1640 generates vector 2108_3 from the topic features F3 identified in the content/InObs of the resource 1901. The resource classifier 1640 analyzes the events associated with each content/InObs of the resource 1901 and generates vector 2108_4 from the user interaction features F4. The resource classifier 1640 generates vector 2108_5 from the entity type features F5 associated with the content/InObs of the resource 1901.

ML model 2228 is trained as explained previously with any combination of vectors 2108_1, 2108_2, 2108_3, 2108_4, and/or 2108_5 generated from the resource 1901 with known classifications. Vectors 2108 are generated from the resource 1901 with an unknown classification and fed into a ML trained classifier model 2228. Model 2228 generates site predictions 2232 for the resource 1901. In this example, model 2228 may more accurately predict the resource 1901 as being a marketer website due to the additional features F2, F3, F4, and F5 used for classifying the resource 1901.

As mentioned, the classifications 2232 can be used as another event dimension for determining user or org intent and surge scores. For example, a large surge score from a vendor website may have more significance for identifying a company surge than a similar surge score on a news or marketing website. Resource classifications 2232 can also be used for filtering different types of data. For example, CCM 100 can capture and determine surge scores from events 108 generated for one particular website class.

### 11. Example Hardware and Software Configurations and Implementaions

FIG. 24 illustrates an example of an computing system 2400 (also referred to as “computing device 2400,” “platform 2400,” “device 2400,” “appliance 2400,” “server 2400,” or the like) in accordance with various embodiments. The computing system 2400 may be suitable for use as any of the computer devices discussed herein and performing any combination of processes discussed above. As examples, the computing device 2400 may operate in the capacity of a server or a client machine in a server-client network environment, or as a peer machine in a peer-to-peer (or distributed) network environment. Additionally or alternatively, the system 2400 may represent the CCM 100, user computer(s) 230, 530, 1400, and 1600, network devices, resource classifier 1640, application server(s) (e.g., owned/operated by service providers 118), a third party platform or collection of servers that hosts and/or serves InObs 112, and/or any other system or device discussed previously. Additionally or alternatively, various combinations of the components depicted by FIG. 24 may be included depending on the particular system/device that system 2400 represents. For example, when system 2400 represents a user or client device, the system 2400 may include some or all of the components shown by FIG. 24. In another example, when the system 2400 represents the CCM 100 or a server computer system, the system 2400 may not include the communication circuitry 2409 or battery 2424, and instead may include multiple NICs 2416 or the like. As examples, the system 2400 and/or the remote system 2455 may comprise desktop computers, workstations, laptop computers, mobile cellular phones (e.g., “smartphones”), tablet computers, portable media players, wearable computing devices, server computer systems, web appliances, network appliances, an aggregation of computing resources (e.g., in a cloud-based environment), or some other computing devices capable of interfacing directly or indirectly with network 2450 or other network, and/or any other machine or device capable of executing instructions (sequential or otherwise) that specify actions to be taken by that machine.

The components of system 2400 may be implemented as an individual computer system, or as components otherwise incorporated within a chassis of a larger system. The components of system 2400 may be implemented as integrated circuits (ICs) or other discrete electronic devices, with the appropriate logic, software, firmware, or a combination thereof, adapted in the computer system 2400. Additionally or alternatively, some of the components of system 2400 may be combined and implemented as a suitable System-on-Chip (SoC), System-in-Package (SiP), multi-chip package (MCP), or the like.

The system 2400 includes physical hardware devices and software components capable of providing and/or accessing content and/or services to/from the remote system 2455. The system 2400 and/or the remote system 2455 can be implemented as any suitable computing system or other data processing apparatus usable to access and/or provide content/services from/to one another. The remote system 2455 may have a same or similar configuration and/or the same or similar components as system 2400. The system 2400 communicates with remote systems 2455, and vice versa, to obtain/serve content/services using, for example, Hypertext Transfer Protocol (HTTP) over Transmission Control Protocol (TCP)/Internet Protocol (IP), or one or more other common Internet protocols such as File Transfer Protocol (FTP); Session Initiation Protocol (SIP) with Session Description Protocol (SDP), Real-time Transport Protocol (RTP), or Real-time Streaming Protocol (RTSP); Secure Shell (SSH), Extensible Messaging and Presence Protocol (XMPP); WebSocket; and/or some other communication protocol, such as those discussed herein.

As used herein, the term “content” refers to visual or audible information to be conveyed to a particular audience or end-user, and may include or convey information pertaining to specific subjects or topics. Content or content items may be different content types (e.g., text, image, audio, video, etc.), and/or may have different formats (e.g., text files including Microsoft® Word® documents, Portable Document Format (PDF) documents, HTML documents; audio files such as MPEG-4 audio files and WebM audio and/or video files; etc.). As used herein, the term “service” refers to a particular functionality or a set of functions to be performed on behalf of a requesting party, such as the system 2400. As examples, a service may include or involve the retrieval of specified information or the execution of a set of operations. In order to access the content/services, the system 2400 includes components such as processors, memory devices, communication interfaces, and the like. However, the terms “content” and “service” may be used interchangeably throughout the present disclosure even though these terms refer to different concepts.

Referring now to system 2400, the system 2400 includes processor circuitry 2402, which is configurable or operable to execute program code, and/or sequentially and automatically carry out a sequence of arithmetic or logical operations; record, store, and/or transfer digital data. The processor circuitry 2402 includes circuitry such as, but not limited to one or more processor cores and one or more of cache memory, low drop-out voltage regulators (LDOs), interrupt controllers, serial interfaces such as serial peripheral interface (SPI), inter-integrated circuit (I²C) or universal programmable serial interface circuit, real time clock (RTC), timer-counters including interval and watchdog timers, general purpose input-output (I/O), memory card controllers, interconnect (IX) controllers and/or interfaces, universal serial bus (USB) interfaces, mobile industry processor interface (MIPI) interfaces, Joint Test Access Group (JTAG) test access ports, and the like. The processor circuitry 2402 may include on-chip memory circuitry or cache memory circuitry, which may include any suitable volatile and/or non-volatile memory, such as DRAM, SRAM, EPROM, EEPROM, Flash memory, solid-state memory, and/or any other type of memory device technology, such as those discussed herein. Individual processors (or individual processor cores) of the processor circuitry 2402 may be coupled with or may include memory/storage and may be configurable or operable to execute instructions stored in the memory/storage to enable various applications or operating systems to run on the system 2400. In these embodiments, the processors (or cores) of the processor circuitry 2402 are configurable or operable to operate application software (e.g., logic/modules 2480) to provide specific services to a user of the system 2400. In some embodiments, the processor circuitry 2402 may include special-purpose processor/controller to operate according to the various embodiments herein.

In various implementations, the processor(s) of processor circuitry 2402 may include, for example, one or more processor cores (CPUs), graphics processing units (GPUs), Tensor Processing Units (TPUs), reduced instruction set computing (RISC) processors, Acorn RISC Machine (ARM) processors, complex instruction set computing (CISC) processors, digital signal processors (DSP), programmable logic devices (PLDs), field-programmable gate arrays (FPGAs), Application Specific Integrated Circuits (ASICs), SoCs and/or programmable SoCs, microprocessors or controllers, or any suitable combination thereof. As examples, the processor circuitry 2402 may include Intel® Core™ based processor(s), MCU-class processor(s), Xeon® processor(s); Advanced Micro Devices (AMD) Zen® Core Architecture processor(s), such as Ryzen® or Epyc® processor(s), Accelerated Processing Units (APUs), MxGPUs, or the like; A, S, W, and T series processor(s) from Apple® Inc., Snapdragon™ or Centrig™ processor(s) from Qualcomm® Technologies, Inc., Texas Instruments, Inc.® Open Multimedia Applications Platform (OMAP)™ processor(s); Power Architecture processor(s) provided by the OpenPOWER® Foundation and/or IBM®, MIPS Warrior M-class, Warrior I-class, and Warrior P-class processor(s) provided by MIPS Technologies, Inc.; ARM Cortex-A, Cortex-R, and Cortex-M family of processor(s) as licensed from ARM Holdings, Ltd.; the ThunderX2® provided by Cavium™, Inc.; GeForce®, Tegra®, Titan X®, Tesla®, Shield®, and/or other like GPUs provided by Nvidia®; or the like. Other examples of the processor circuitry 2402 may be mentioned elsewhere in the present disclosure.

In some implementations, the processor(s) of processor circuitry 2402 may be, or may include, one or more media processors comprising microprocessor-based SoC(s), FPGA(s), or DSP(s) specifically designed to deal with digital streaming data in real-time, which may include encoder/decoder circuitry to compress/decompress (or encode and decode) Advanced Video Coding (AVC) (also known as H.264 and MPEG-4) digital data, High Efficiency Video Coding (HEVC) (also known as H.265 and MPEG-H part 2) digital data, and/or the like.

In some implementations, the processor circuitry 2402 may include one or more hardware accelerators. The hardware accelerators may be microprocessors, configurable hardware (e.g., FPGAs, programmable ASICs, programmable SoCs, DSPs, etc.), or some other suitable special-purpose processing device tailored to perform one or more specific tasks or workloads, for example, specific tasks or workloads of the subsystems of the CCM 100, IP2D resolution system 850, and/or some other system/device discussed herein, which may be more efficient than using general-purpose processor cores. In some embodiments, the specific tasks or workloads may be offloaded from one or more processors of the processor circuitry 2402. In these implementations, the circuitry of processor circuitry 2402 may comprise logic blocks or logic fabric including and other interconnected resources that may be programmed to perform various functions, such as the procedures, methods, functions, etc. of the various embodiments discussed herein. Additionally, the processor circuitry 2402 may include memory cells (e.g., EPROM, EEPROM, flash memory, static memory (e.g., SRAM, anti-fuses, etc.) used to store logic blocks, logic fabric, data, etc. in LUTs and the like.

In some implementations, the processor circuitry 2402 may include hardware elements specifically tailored for machine learning functionality, such as for operating the subsystems of the CCM 100 discussed previously with regard to FIG. 2. In these implementations, the processor circuitry 2402 may be, or may include, an AI engine chip that can run many different kinds of AI instruction sets once loaded with the appropriate weightings and training code. Additionally or alternatively, the processor circuitry 2402 may be, or may include, AI accelerator(s), which may be one or more of the aforementioned hardware accelerators designed for hardware acceleration of AI applications, such as one or more of the subsystems of CCM 100, IP2D resolution system 850, and/or some other system/device discussed herein. As examples, these processor(s) or accelerators may be a cluster of artificial intelligence (AI) GPUs, tensor processing units (TPUs) developed by Google® Inc., Real AI Processors (RAPs™) provided by AlphalCs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 2402 and/or hardware accelerator circuitry may be implemented as AI accelerating co-processor(s), such as the Hexagon 685 DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit (NPU) within the HiSilicon Kirin 970 provided by Huawei®, and/or the like.

In some implementations, the processor(s) of processor circuitry 2402 may be, or may include, one or more custom-designed silicon cores specifically designed to operate corresponding subsystems of the CCM 100, IP2D resolution system 850, and/or some other system/device discussed herein. These cores may be designed as synthesizable cores comprising hardware description language logic (e.g., register transfer logic, verilog, Very High Speed Integrated Circuit hardware description language (VHDL), etc.); netlist cores comprising gate-level description of electronic components and connections and/or process-specific very-large-scale integration (VLSI) layout; and/or analog or digital logic in transistor-layout format. In these implementations, one or more of the subsystems of the CCM 100, IP2D resolution system 850, and/or some other system/device discussed herein may be operated, at least in part, on custom-designed silicon core(s). These “hardware-ized” subsystems may be integrated into a larger chipset but may be more efficient that using general purpose processor cores.

The system memory circuitry 2404 comprises any number of memory devices arranged to provide primary storage from which the processor circuitry 2402 continuously reads instructions 2482 stored therein for execution. In some embodiments, the memory circuitry 2404 is on-die memory or registers associated with the processor circuitry 2402. As examples, the memory circuitry 2404 may include volatile memory such as random access memory (RAM), dynamic RAM (DRAM), synchronous DRAM (SDRAM), etc. The memory circuitry 2404 may also include nonvolatile memory (NVM) such as high-speed electrically erasable memory (commonly referred to as “flash memory”), phase change RAM (PRAM), resistive memory such as magnetoresistive random access memory (MRAM), etc. The memory circuitry 2404 may also comprise persistent storage devices, which may be temporal and/or persistent storage of any type, including, but not limited to, non-volatile memory, optical, magnetic, and/or solid state mass storage, and so forth.

In some implementations, some aspects (or devices) of memory circuitry 2404 and storage circuitry 2408 may be integrated together with a processing device 2402, for example RAM or FLASH memory disposed within an integrated circuit microprocessor or the like. In other implementations, the memory circuitry 2404 and/or storage circuitry 2408 may comprise an independent device, such as an external disk drive, storage array, or any other storage devices used in database systems. The memory and processing devices may be operatively coupled together, or in communication with each other, for example by an I/O port, network connection, etc. such that the processing device may read a file stored on the memory.

Some memory may be “read only” by design (ROM) by virtue of permission settings, or not. Other examples of memory may include, but may be not limited to, WORM, EPROM, EEPROM, FLASH, etc. which may be implemented in solid state semiconductor devices. Other memories may comprise moving parts, such a conventional rotating disk drive. All such memories may be “machine-readable” in that they may be readable by a processing device.

Storage circuitry 2408 is arranged to provide persistent storage of information such as data, applications, operating systems (OS), and so forth. As examples, the storage circuitry 2408 may be implemented as hard disk drive (HDD), a micro HDD, a solid-state disk drive (SSDD), flash memory cards (e.g., SD cards, microSD cards, xD picture cards, and the like), USB flash drives, on-die memory or registers associated with the processor circuitry 2402, resistance change memories, phase change memories, holographic memories, or chemical memories, and the like.

The storage circuitry 2408 is configurable or operable to store computational logic 2480 (or “modules 2480”) in the form of software, firmware, microcode, or hardware-level instructions to implement the techniques described herein. The computational logic 2480 may be employed to store working copies and/or permanent copies of programming instructions, or data to create the programming instructions, for the operation of various components of system 2400 (e.g., drivers, libraries, application programming interfaces (APIs), etc.), an OS of system 2400, one or more applications, and/or for carrying out the embodiments discussed herein. The computational logic 2480 may be stored or loaded into memory circuitry 2404 as instructions 2482, or data to create the instructions 2482, which are then accessed for execution by the processor circuitry 2402 to carry out the functions described herein. The processor circuitry 2402 accesses the memory circuitry 2404 and/or the storage circuitry 2408 over the interconnect (IX) 2406. The instructions 2482 to direct the processor circuitry 2402 to perform a specific sequence or flow of actions, for example, as described with respect to flowchart(s) and block diagram(s) of operations and functionality depicted previously. The various elements may be implemented by assembler instructions supported by processor circuitry 2402 or high-level languages that may be compiled into instructions 2484, or data to create the instructions 2484, to be executed by the processor circuitry 2402. The permanent copy of the programming instructions may be placed into persistent storage devices of storage circuitry 2408 in the factory or in the field through, for example, a distribution medium (not shown), through a communication interface (e.g., from a distribution server (not shown)), or over-the-air (OTA).

The operating system (OS) of system 2400 may be a general purpose OS or an OS specifically written for and tailored to the computing system 2400. For example, when the system 2400 is a server system or a desktop or laptop system 2400, the OS may be Unix or a Unix-like OS such as Linux e.g., provided by Red Hat Enterprise, Windows 10™ provided by Microsoft Corp.®, macOS provided by Apple Inc.®, or the like. In another example where the system 2400 is a mobile device, the OS may be a mobile OS, such as Android° provided by Google Inc.®, iOS® provided by Apple Inc.®, Windows 10 Mobile° provided by Microsoft Corp.®, KaiOS provided by KaiOS Technologies Inc., or the like.

The OS manages computer hardware and software resources, and provides common services for various applications (e.g., one or more loci/modules 2480). The OS may include one or more drivers or APIs that operate to control particular devices that are embedded in the system 2400, attached to the system 2400, or otherwise communicatively coupled with the system 2400. The drivers may include individual drivers allowing other components of the system 2400 to interact or control various I/O devices that may be present within, or connected to, the system 2400. For example, the drivers may include a display driver to control and allow access to a display device, a touchscreen driver to control and allow access to a touchscreen interface of the system 2400, sensor drivers to obtain sensor readings of sensor circuitry 2421 and control and allow access to sensor circuitry 2421, actuator drivers to obtain actuator positions of the actuators 2422 and/or control and allow access to the actuators 2422, a camera driver to control and allow access to an embedded image capture device, audio drivers to control and allow access to one or more audio devices. The OSs may also include one or more libraries, drivers, APIs, firmware, middleware, software glue, etc., which provide program code and/or software components for one or more applications to obtain and use the data from other applications operated by the system 2400, such as the various subsystems of the CCM 100, IP2D resolution system 850, and/or some other system/device discussed previously.

The components of system 2400 communicate with one another over the interconnect (IX) 2406. The IX 2406 may include any number of IX technologies such as industry standard architecture (ISA), extended ISA (EISA), inter-integrated circuit (I²C), an serial peripheral interface (SPI), point-to-point interfaces, power management bus (PMBus), peripheral component interconnect (PCI), PCI express (PCIe), Intel® Ultra Path Interface (UPI), Intel® Accelerator Link (IAL), Common Application Programming Interface (CAPI), Intel® QuickPath Interconnect (QPI), Intel® Omni-Path Architecture (OPA) IX, RapidIO™ system interconnects, Ethernet, Cache Coherent Interconnect for Accelerators (CCIA), Gen-Z Consortium IXs, Open Coherent Accelerator Processor Interface (OpenCAPI), and/or any number of other IX technologies. The IX 2406 may be a proprietary bus, for example, used in a SoC based system.

The communication circuitry 2409 is a hardware element, or collection of hardware elements, used to communicate over one or more networks (e.g., network 2450) and/or with other devices. The communication circuitry 2409 includes modem 2410 and transceiver circuitry (“TRx”) 812. The modem 2410 includes one or more processing devices (e.g., baseband processors) to carry out various protocol and radio control functions. Modem 2410 may interface with application circuitry of system 2400 (e.g., a combination of processor circuitry 2402 and CRM 860) for generation and processing of baseband signals and for controlling operations of the TRx 2412. The modem 2410 may handle various radio control functions that enable communication with one or more radio networks via the TRx 2412 according to one or more wireless communication protocols. The modem 2410 may include circuitry such as, but not limited to, one or more single-core or multi-core processors (e.g., one or more baseband processors) or control logic to process baseband signals received from a receive signal path of the TRx 2412, and to generate baseband signals to be provided to the TRx 2412 via a transmit signal path. In various embodiments, the modem 2410 may implement a real-time OS (RTOS) to manage resources of the modem 2410, schedule tasks, etc.

The communication circuitry 2409 also includes TRx 2412 to enable communication with wireless networks using modulated electromagnetic radiation through a non-solid medium. TRx 2412 includes a receive signal path, which comprises circuitry to convert analog RF signals (e.g., an existing or received modulated waveform) into digital baseband signals to be provided to the modem 2410. The TRx 2412 also includes a transmit signal path, which comprises circuitry configurable or operable to convert digital baseband signals provided by the modem 2410 to be converted into analog RF signals (e.g., modulated waveform) that will be amplified and transmitted via an antenna array including one or more antenna elements (not shown). The antenna array may be a plurality of microstrip antennas or printed antennas that are fabricated on the surface of one or more printed circuit boards. The antenna array may be formed in as a patch of metal foil (e.g., a patch antenna) in a variety of shapes, and may be coupled with the TRx 2412 using metal transmission lines or the like.

The TRx 2412 may include one or more radios that are compatible with, and/or may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDM2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10) , 3GPP Rel. 11 (3rd Generation Partnership Project Release 11), 3GPP Rel. 12 (3rd Generation Partnership Project Release 12), 3GPP Rel. 8 (3rd Generation Partnership Project Release 8), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-URTA), Long Term Evolution Advanced (4th Generation) (LTE Advanced (4G)), cdmaOne (2G), Code division multiple access 2000 (Third generation) (CDM2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Bluetooth(r), Bluetooth Low Energy (BLE), IEEE 802.15.4 based protocols (e.g., IPv6 over Low power Wireless Personal Area Networks (6LoWPAN), WirelessHART, MiWi, Thread, 1600.11a, etc.) WiFi-direct, ANT/ANT+, ZigBee, Z-Wave, 3GPP device-to-device (D2D) or Proximity Services (ProSe), Universal Plug and Play (UPnP), Low-Power Wide-Area-Network (LPWAN), LoRaWAN™ (Long Range Wide Area Network), Sigfox, Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (V2V) and Vehicle-to-X (V2X) and Vehicle-to-Infrastructure (V21) and Infrastructure-to-Vehicle (I2V) communication technologies, 3GPP cellular V2X, DSRC (Dedicated Short Range Communications) communication systems such as Intelligent-Transport-Systems and others, the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non- safety applications in the frequency range 5,855 GHz to 5,875 GHz), ITS-G5C (i.e., Operation of ITS applications in the frequency range 5,470 GHz to 5,725 GHz)), etc. In addition to the standards listed above, any number of satellite uplink technologies may be used for the TRx 2412 including, for example, radios compliant with standards issued by the ITU (International Telecommunication Union), or the ETSI (European Telecommunications Standards Institute), among others, both existing and not yet formulated.

Network interface circuitry/controller (NIC) 2416 may be included to provide wired communication to the network 2450 or to other devices using a standard network interface protocol. The standard network interface protocol may include Ethernet, Ethernet over GRE Tunnels, Ethernet over Multiprotocol Label Switching (MPLS), Ethernet over USB, or may be based on other types of network protocols, such as Controller Area Network (CAN), Local Interconnect Network (LIN), DeviceNet, ControlNet, Data Highway+, PROFIBUS, or PROFINET, among many others. Network connectivity may be provided to/from the system 2400 via NIC 2416 using a physical connection, which may be electrical (e.g., a “copper interconnect”) or optical. The physical connection also includes suitable input connectors (e.g., ports, receptacles, sockets, etc.) and output connectors (e.g., plugs, pins, etc.). The NIC 2416 may include one or more dedicated processors and/or FPGAs to communicate using one or more of the aforementioned network interface protocols. In some implementations, the NIC 2416 may include multiple controllers to provide connectivity to other networks using the same or different protocols. For example, the system 2400 may include a first NIC 2416 providing communications to the cloud over Ethernet and a second NIC 2416 providing communications to other devices over another type of network. In some implementations, the NIC 2416 may be a high-speed serial interface (HSSI) NIC to connect the system 2400 to a routing or switching device.

Network 2450 comprises computers, network connections among various computers (e.g., between the system 2400 and remote system 2455), and software routines to enable communication between the computers over respective network connections. In this regard, the network 2450 comprises one or more network elements that may include one or more processors, communications systems (e.g., including network interface controllers, one or more transmitters/receivers connected to one or more antennas, etc.), and computer readable media. Examples of such network elements may include wireless access points (WAPs), a home/business server (with or without radio frequency (RF) communications circuitry), a router, a switch, a hub, a radio beacon, base stations, picocell or small cell base stations, and/or any other like network device. Connection to the network 2450 may be via a wired or a wireless connection using the various communication protocols discussed infra. As used herein, a wired or wireless communication protocol may refer to a set of standardized rules or instructions implemented by a communication device/system to communicate with other devices, including instructions for packetizing/depacketizing data, modulating/demodulating signals, implementation of protocols stacks, and the like. More than one network may be involved in a communication session between the illustrated devices. Connection to the network 2450 may require that the computers execute software routines which enable, for example, the seven layers of the OSI model of computer networking or equivalent in a wireless (or cellular) phone network.

The network 2450 may represent the Internet, one or more cellular networks, a local area network (LAN) or a wide area network (WAN) including proprietary and/or enterprise networks, Transfer Control Protocol (TCP)/Internet Protocol (IP)-based network, or combinations thereof. In such embodiments, the network 2450 may be associated with network operator who owns or controls equipment and other elements necessary to provide network-related services, such as one or more base stations or access points, one or more servers for routing digital data or telephone calls (e.g., a core network or backbone network), etc. Other networks can be used instead of or in addition to the Internet, such as an intranet, an extranet, a virtual private network (VPN), an enterprise network, a non-TCP/IP based network, any LAN or WAN or the like.

The external interface 2418 (also referred to as “I/O interface circuitry” or the like) is configurable or operable to connect or coupled the system 2400 with external devices or subsystems. The external interface 2418 may include any suitable interface controllers and connectors to couple the system 2400 with the external components/devices. As an example, the external interface 2418 may be an external expansion bus (e.g., Universal Serial Bus (USB), FireWire, Thunderbolt, etc.) used to connect system 2400 with external (peripheral) components/devices. The external devices include, inter alia, sensor circuitry 2421, actuators 2422, and positioning circuitry 2445, but may also include other devices or subsystems not shown by FIG. 24.

The sensor circuitry 2421 may include devices, modules, or subsystems whose purpose is to detect events or changes in its environment and send the information (sensor data) about the detected events to some other a device, module, subsystem, etc. Examples of such sensors 621 include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors); pressure sensors; barometric pressure sensors; gravimeters; altimeters; image capture devices (e.g., cameras); light detection and ranging (LiDAR) sensors; proximity sensors (e.g., infrared radiation detector and the like), depth sensors, ambient light sensors, ultrasonic transceivers; microphones; etc.

The external interface 2418 connects the system 2400 to actuators 2422, which allow system 2400 to change its state, position, and/or orientation, or move or control a mechanism or system. The actuators 2422 comprise electrical and/or mechanical devices for moving or controlling a mechanism or system, and/or converting energy (e.g., electric current or moving air and/or liquid) into some kind of motion. The actuators 2422 may include one or more electronic (or electrochemical) devices, such as piezoelectric biomorphs, solid state actuators, solid state relays (SSRs), shape-memory alloy-based actuators, electroactive polymer-based actuators, relay driver integrated circuits (ICs), and/or the like. The actuators 2422 may include one or more electromechanical devices such as pneumatic actuators, hydraulic actuators, electromechanical switches including electromechanical relays (EMRs), motors (e.g., DC motors, stepper motors, servomechanisms, etc.), wheels, thrusters, propellers, claws, clamps, hooks, an audible sound generator, and/or other like electromechanical components. The system 2400 may be configurable or operable to operate one or more actuators 2422 based on one or more captured events and/or instructions or control signals received from a service provider and/or various client systems. In embodiments, the system 2400 may transmit instructions to various actuators 2422 (or controllers that control one or more actuators 2422) to reconfigure an electrical network as discussed herein.

The positioning circuitry 2445 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 2445 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 2445 may include a Micro-Technology for Positioning, Navigation, and Timing (Micro-PNT) IC that uses a master timing clock to perform position tracking/estimation without GNSS assistance. The positioning circuitry 2445 may also be part of, or interact with, the communication circuitry 2409 to communicate with the nodes and components of the positioning network. The positioning circuitry 2445 may also provide position data and/or time data to the application circuitry, which may use the data to synchronize operations with various infrastructure (e.g., radio base stations), for turn-by-turn navigation, or the like.

The input/output (I/O) devices 2456 may be present within, or connected to, the system 2400. The I/O devices 2456 include input device circuitry and output device circuitry including one or more user interfaces designed to enable user interaction with the system 2400 and/or peripheral component interfaces designed to enable peripheral component interaction with the system 2400. The input device circuitry includes any physical or virtual means for accepting an input including, inter alia, one or more physical or virtual buttons (e.g., a reset button), a physical keyboard, keypad, mouse, touchpad, touchscreen, microphones, scanner, headset, and/or the like. The output device circuitry is used to show or convey information, such as sensor readings, actuator position(s), or other like information. Data and/or graphics may be displayed on one or more user interface components of the output device circuitry. The output device circuitry may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the system 2400. The output device circuitry may also include speakers or other audio emitting devices, printer(s), and/or the like. In some embodiments, the sensor circuitry 2421 may be used as the input device circuitry (e.g., an image capture device, motion capture device, or the like) and one or more actuators 2422 may be used as the output device circuitry (e.g., an actuator to provide haptic feedback or the like). In another example, near-field communication (NFC) circuitry comprising an NFC controller coupled with an antenna element and a processing device may be included to read electronic tags and/or connect with another NFC-enabled device. Peripheral component interfaces may include, but are not limited to, a non-volatile memory port, a universal serial bus (USB) port, an audio jack, a power supply interface, etc.

A battery 2424 may be coupled to the system 2400 to power the system 2400, which may be used in embodiments where the system 2400 is not in a fixed location, such as when the system 2400 is a mobile or laptop client system. The battery 2424 may be a lithium ion battery, a lead-acid automotive battery, or a metal-air battery, such as a zinc-air battery, an aluminum-air battery, a lithium-air battery, a lithium polymer battery, and/or the like. In embodiments where the system 2400 is mounted in a fixed location, such as when the system is implemented as a server computer system, the system 2400 may have a power supply coupled to an electrical grid. In these embodiments, the system 2400 may include power tee circuitry to provide for electrical power drawn from a network cable to provide both power supply and data connectivity to the system 2400 using a single cable.

Power management integrated circuitry (PMIC) 2426 may be included in the system 2400 to track the state of charge (SoCh) of the battery 2424, and to control charging of the system 2400. The PMIC 2426 may be used to monitor other parameters of the battery 2424 to provide failure predictions, such as the state of health (SoH) and the state of function (SoF) of the battery 2424. The PMIC 2426 may include voltage regulators, surge protectors, power alarm detection circuitry. The power alarm detection circuitry may detect one or more of brown out (under-voltage) and surge (over-voltage) conditions. The PMIC 2426 may communicate the information on the battery 2424 to the processor circuitry 2402 over the IX 2406. The PMIC 2426 may also include an analog-to-digital (ADC) convertor that allows the processor circuitry 2402 to directly monitor the voltage of the battery 2424 or the current flow from the battery 2424. The battery parameters may be used to determine actions that the system 2400 may perform, such as transmission frequency, mesh network operation, sensing frequency, and the like.

A power block 2428, or other power supply coupled to an electrical grid, may be coupled with the PMIC 2426 to charge the battery 2424. In some examples, the power block 2428 may be replaced with a wireless power receiver to obtain the power wirelessly, for example, through a loop antenna in the system 2400. In these implementations, a wireless battery charging circuit may be included in the PMIC 2426. The specific charging circuits chosen depend on the size of the battery 2424 and the current required.

The system 2400 may include any combinations of the components shown by FIG. 24, however, some of the components shown may be omitted, additional components may be present, and different arrangement of the components shown may occur in other implementations. In one example where the system 2400 is or is part of a server computer system, the battery 2424, communication circuitry 2409, the sensors 2421, actuators 2422, and/or POS 2445, and possibly some or all of the I/O devices 2456 may be omitted.

Furthermore, the embodiments of the present disclosure may take the form of a computer program product or data to create a computer program, with the computer program or data embodied in any tangible or non-transitory medium of expression having the computer-usable program code (or data to create the computer program) embodied in the medium.

For example, the memory circuitry 2404 and/or storage circuitry 2408 may be embodied as non-transitory computer-readable storage media (NTCRSM) that may be suitable for use to store programming instructions (prog_ins) or data that creates the prog_ins that cause an apparatus (e.g., any of the devices/components/systems described with regard to FIGS. 1-24), in response to execution of the instructions by the apparatus, to perform various programming operations associated with operating system functions, one or more applications, and/or aspects of the present disclosure. In various embodiments, the prog_ins may correspond to any of the computational logic 2480, instructions 2482 and 2484. Additionally or alternatively, the prog_ins (or data to create the prog_ins) may be disposed on multiple NTCRSM. Additionally or alternatively, prog_ins (or data to create the prog_ins) may be disposed on (or encoded in) computer-readable transitory storage media, such as, signals. The prog_ins embodied by a machine-readable medium may be transmitted or received over a communications network using a transmission medium via a network interface device (e.g., communication circuitry 2409 and/or NIC 2416) utilizing any one of a number of transfer protocols (e.g., HTTP, etc.).

Any combination of one or more computer usable or computer readable media may be utilized as or instead of the NTCRSM including, for example but not limited to, one or more electronic, magnetic, optical, electromagnetic, infrared, or semiconductor systems, apparatuses, devices, or propagation media. For instance, the NTCRSM may be embodied by devices described herein, an electrical connection having one or more wires, a portable computer diskette, a hard disk, RAM, ROM, EPROM, flash memory, optical fiber, compact disc, an optical storage device, a transmission media, a magnetic storage device, or any number of other hardware devices. In the context of the present disclosure, a computer-usable or computer-readable medium may be any medium that can contain, store, communicate, propagate, or transport the program (or data to create the program) for use by or in connection with the instruction execution system, apparatus, or device. The computer-usable medium may include a propagated data signal with the computer-usable program code (e.g., the aforementioned prog_ins) or data to create the program code embodied therewith, either in baseband or as part of a carrier wave. The computer usable program code or data to create the program may be transmitted using any appropriate medium, including but not limited to wireless, wireline, optical fiber cable, RF, etc.

In various embodiments, the program code (or data to create the program code) described herein may be stored in one or more of a compressed format, an encrypted format, a fragmented format, a packaged format, etc. The program code or data to create the program code as described herein may require one or more of installation, modification, adaptation, updating, combining, supplementing, configuring, decryption, decompression, unpacking, distribution, reassignment, etc. in order to make them directly readable and/or executable by a computing device and/or other machine. For example, the program code or data to create the program code may be stored in multiple parts, which are individually compressed, encrypted, and stored on separate computing devices, wherein the parts when decrypted, decompressed, and combined form a set of executable instructions that implement the program code or the data to create the program code, such as those described herein. In another example, the program code or data to create the program code may be stored in a state in which they may be read by a computer, but require addition of a library (e.g., a dynamic link library), a software development kit (SDK), an application programming interface (API), etc. in order to execute the instructions on a particular computing device or other device. In another example, the program code or data to create the program code may need to be configured (e.g., settings stored, data input, network addresses recorded, etc.) before the program code or data to create the program code can be executed/used in whole or in part. In this example, the program code (or data to create the program code) may be unpacked, configured for proper execution, and stored in a first location with the configuration instructions located in a second location distinct from the first location. The configuration instructions can be initiated by an action, trigger, or instruction that is not co-located in storage or execution location with the instructions enabling the disclosed techniques. Accordingly, the disclosed program code or data to create the program code are intended to encompass such machine readable instructions and/or program(s) or data to create such machine readable instruction and/or programs regardless of the particular format or state of the machine readable instructions and/or program(s) when stored or otherwise at rest or in transit. The program code and/or the prog_ins may execute entirely on the system 2400, partly on the system 2400 as a stand-alone software package, partly on the system 2400 and partly on a remote computer (e.g., remote system 2455), or entirely on the remote computer (e.g., remote system 2455). In the latter scenario, the remote computer may be connected to the system 2400 through any type of network (e.g., network 2450)

The program code and/or the prog_ins for carrying out operations of the present disclosure may be implemented as software code to be executed by one or more processors using any suitable computer language such as, for example, Python, PyTorch, NumPy, Ruby, Ruby on Rails, Scala, Smalltalk, Java™, C++, C#, “C”, Kotlin, Swift, Rust, Go (or “Golang”), ECMAScript, JavaScript, TypeScript, Jscript, ActionScript, Server-Side JavaScript (SSJS), PHP, Pearl, Lua, Torch/Lua with Just-In Time compiler (LuaJIT), Accelerated Mobile Pages Script (AMPscript), VBScript, JavaServer Pages (JSP), Active Server Pages (ASP), Node.js, ASP.NET, JAMscript, Hypertext Markup Language (HTML), extensible HTML (XHTML), Extensible Markup Language (XML), XML User Interface Language (XUL), Scalable Vector Graphics (SVG), RESTful API Modeling Language (RAML), wiki markup or Wikitext, Wireless Markup Language (WML), Java Script Object Notion (JSON), Apache® MessagePack™ Cascading Stylesheets (CSS), extensible stylesheet language (XSL), Mustache template language, Handlebars template language, Guide Template Language (GTL), Apache® Thrift, Abstract Syntax Notation One (ASN.1), Google® Protocol Buffers (protobuf), Bitcoin Script, EVM® bytecode, Solidity™, Vyper (Python derived), Bamboo, Lisp Like Language (LLL), Simplicity provided by Blockstream™, Rholang, Michelson, Counterfactual, Plasma, Plutus, Sophia, Salesforce® Apex®, Salesforce® Lightning®, and/or any other programming language, markup language, script, code, etc. In some implementations, a suitable integrated development environment (IDE) or SDK may be used to develop the program code or software elements discussed herein such as, for example, Android® Studio™ IDE, Apple® iOS® SDK, or development tools including proprietary programming languages and/or development tools.

While only a single computing device 2400 is shown, the computing device 2400 may include any collection of devices or circuitry that individually or jointly execute a set (or multiple sets) of instructions to perform any one or more of the operations discussed above. Computing device 2400 may be part of an integrated control system or system manager, or may be provided as a portable electronic device configurable or operable to interface with a networked system either locally or remotely via wireless transmission. Some of the operations described previously may be implemented in software and other operations may be implemented in hardware. One or more of the operations, processes, or methods described herein may be performed by an apparatus, device, or system similar to those as described herein and with reference to the illustrated figures.

### 12. Example Implementations

Additional examples of the presently described embodiments include the following, non-limiting example implementations. Each of the non-limiting examples may stand on its own, or may be combined in any permutation or combination with any one or more of the other examples provided below or throughout the present disclosure.

Example A01 includes a method comprising: determining or identifying one or more features from training websites with known classifications; training a machine learning (ML) model with the features and known classifications; determining or identifying the features from an unclassified website with an unknown classification; and applying the features from an unclassified website to the trained computer learning model to predict a classification for the unclassified website.

Example A02 includes the method of example A01 and/or some other example(s) herein, further comprising: generating a first set of vectors representing the features of the training websites; using the first set of vectors and known classifications of the training websites to train the computer learning model; generating a second set of vectors representing the features of the unclassified website; and applying the second set of vectors to the trained computer learning model to classify the unclassified website.

Example A03 includes the method of examples A01-A02 and/or some other example(s) herein, wherein one of the features identifies structural semantics of webpages in the websites.

Example A04 includes the method of example A03 and/or some other example(s) herein, further comprising: crawling the webpages of the unclassified website to identify links between the webpages on the website and links with other webpages on the same website and links with webpages on other websites; and determining or identifying the structural semantics of the website based on the identified links.

Example A05 includes the method of examples A01-A04 and/or some other example(s) herein, further comprising: generating one of the features that identify content semantics of webpages in the websites.

Example A06 includes the method of example A05 and/or some other example(s) herein, further comprising: crawling the webpages of the unclassified website to identify types of content and topics in the webpages; and determining or identifying the content semantics of the website based on the identified types of content and topics in the webpages.

Example A07 includes the method of examples A01-A06 and/or some other example(s) herein, further comprising: generating one of the features that identify content interaction behavior with webpages in the websites.

Example A08 includes the method of example A07 and/or some other example(s) herein, further comprising: determining or identifying events associated with the webpages of the websites; determining or identifying types of user interactions with the webpages identified in the events; and determining or identifying the content interaction behavior based on the types of user interactions with the webpages.

Example A09 includes the method of examples A01-A08 and/or some other example(s) herein, further comprising: generating one of the features that identifies types of users accessing webpages in the websites.

Example A10 includes the method of example A09 and/or some other example(s) herein, further comprising: determining or identifying events associated with the webpages of the websites; determining or identifying types of users associated with the events; and determining or identifying the types of users accessing the webpages based on the types of users identified in the events.

Example A11 includes a method comprising: determining or identifying a website semantic feature for a website; determining or identifying a website behavioral feature for the website; and predicting a classification for the website based on the website semantic feature and the website behavioral feature.

Example A12 includes the method of example A11 and/or some other example(s) herein, further comprising: generating a first vector representing the website semantic feature of the website; generating a second vector representing the website behavioral feature of the website; and feeding the first and second vector into a computer learning model to predict the classification for the website.

Example A13 includes the method of examples A11-A12 and/or some other example(s) herein, further comprising: generating the website semantic feature for the website based on links between webpages on the website.

Example A14 includes the method of example A13 and/or some other example(s) herein, further comprising: generating the website semantic feature for the website based on content and topics in the webpages on the website.

Example A15 includes the method of examples A11-A14 and/or some other example(s) herein, further comprising: generating the website behavioral feature for the website based on types of user interactions with webpages on the website.

Example A16 includes the method of example A15 and/or some other example(s) herein, further comprising: generating the website behavioral feature for the website based on types of businesses accessing the webpages on the website

Example B01 includes a method of machine learning (ML) comprising: determining or identifying one or more features from training data comprising a set of information objects (InObs) with known classifications, each InOb of the set of InObs comprising one or more nodes, the one or more features including structural semantics for respective InObs of the set of InObs, the structural semantics comprising a data structure representative of relationships between the one or more nodes of the respective InObs; training an ML model to identify classifications of InObs not among the set of InObs based on the features identified from the training data and the known classifications of the set of InObs; determining or identifying features from an unclassified InOb with an unknown classification, the identified features of the unclassified InOb including a set of nodes of the unclassified InOb; and applying the identified features of the unclassified InOb to the trained ML model to predict a classification for the unclassified InOb based on structural semantics of the unclassified InOb, the structural semantics of the unclassified InOb being based on relationships among nodes of the set of nodes.

Example B02 includes the method of example B01 and/or some other example(s) herein, further comprising: generating a first set of vectors representing the features of the set of InObs; using the first set of vectors and known classifications of the set of InObs to train the ML model; generating a second set of vectors representing the features of the unclassified InOb; and applying the second set of vectors to the trained ML model to classify the unclassified InOb.

Example B03 includes the method of examples B01-B02 and/or some other example(s) herein, wherein the structural semantics of the respective InObs includes relationships between nodes making individual InObs and relationships between nodes of different InObs.

Example B04 includes the method of example B03 and/or some other example(s) herein, further comprising: crawling the webpages of the unclassified InOb to identify links between the webpages on the InOb and links with other webpages on the same InOb and links with webpages on other InObs; and determining or identifying the structural semantics of the unclassified InOb based on the identified links.

Example B05 includes the method of examples B01-B04 and/or some other example(s) herein, wherein the one or more features further comprise content semantics of the one or more nodes of the set of InObs.

Example B06 includes the method of example B05 and/or some other example(s) herein, further comprising: crawling the webpages of the unclassified InOb to identify content types and topics in the webpages; and determining or identifying the content semantics of the unclassified InOb based on the identified content types and topics in the webpages of the unclassified InOb.

Example B07 includes the method of examples B01-B06 and/or some other example(s) herein, wherein the one or more features further comprise content interaction behavior features with webpages in the one or more nodes of the set of InObs.

Example B08 includes the method of example B07 and/or some other example(s) herein, further comprising: determining or identifying user interaction events generated by the one or more nodes based on interactions with the one or more nodes of the set of InObs; determining or identifying user interaction types based on the user interaction events; and determining or identifying the content interaction behavior features based on the user interaction types of the set of webpages.

Example B09 includes the method of examples B01-B08 and/or some other example(s) herein, wherein the one or more features further comprise types of users accessing the one or more nodes of the set of InObs, the types of users including device types used for accessing the one or more nodes.

Example B10 includes the method of example B09 and/or some other example(s) herein, further comprising: determining or identifying network session events generated by the one or more nodes based on accesses of the one or more nodes the InObs; determining or identifying user data from the network session events; and determining or identifying the types of users accessing the webpages based on the determined user data.

Example B11 includes a method comprising: determining or identifying, using a trained machine learning (ML) model, one or more structural features of a InOb, the trained ML model being trained on a training data set including a set of InObs, each InOb of the set of InObs comprising one or more nodes, and the trained ML model includes a data object indicating structural features of respective InObs of the set of InObs, the structural features are relationships between the one or more nodes of the respective InObs, and the data object is a representation of the relationships; and predicting a classification for the InOb based on the identified one or more structural features of the InOb.

Example B12 includes the method of example B11 and/or some other example(s) herein, further comprising: determining or identifying user interaction events generated by the InOb or users that interact with the InOb; determining or identifying user interaction types based on the user interaction events; determining or identifying one or more content interaction behavior features for the InOb based on the determined user interaction types, the one or more content interaction behavior features being patterns of user interaction with content of the InOb.

Example B13 includes the method of example B12 and/or some other example(s) herein, further comprising: generating a structural feature vector comprising the one or more structural features of the InOb; generating a content interaction behavior feature vector comprising the one or more content interaction behavior features of the InOb; and feeding the structural feature vector and the content interaction behavior feature vector into the ML model to predict the classification for the InOb.

Example B14 includes the method of example B13 and/or some other example(s) herein, wherein the user interaction events indicate an event type and an engagement metric, and each content interaction behavior feature in the content interaction behavior feature vector represents a percentage or average value of the engagement metric for an associated event type for a time period.

Example B15 includes the method of examples B13, B14, and/or some other example(s) herein, wherein the one or more content interaction behavior features include one or more of a time of day, day of week, date, total amount of content consumed by respective users, percentages of different device types used for accessing the InOb, duration of time users spend on individual webpages of the InOb, total engagement the respective users have on the individual webpages, a number of distinct user profiles accessing the individual webpages versus a total number of user interaction events for the individual webpages, a dwell time, a scroll depth, a scroll velocity, and variance in content consumption over time.

Example B16 includes the method of examples B13-B15 and/or some other example(s) herein, wherein generating the structural feature vector comprises: generating respective structural feature vectors for each individual webpage of the InOb; and averaging the respective structural feature vectors for each individual webpage to obtain the structural feature vector for the InOb.

Example B17 includes the method of examples B13-B16 and/or some other example(s) herein, wherein generating the content interaction behavior feature vector comprises: generating respective content interaction behavior feature vectors for each individual webpage of the InOb; and averaging the respective content interaction behavior feature vectors for each individual webpage to obtain the content interaction behavior feature vector for the InOb.

Example B18 includes the method of examples B12-B17 and/or some other example(s) herein, further comprises: generating the one or more content interaction behavior features for the InOb based on types of businesses accessing webpages of the InOb.

Example B19 includes the method of examples B11-B18 and/or some other example(s) herein, further comprises: determining or identifying the one or more structural features of the InOb based on links between webpages of the InOb and links to other webpages of other InObs from the webpages of the InOb.

Example B20 includes the method of example B19 and/or some other example(s) herein, further comprises: crawling the webpages of the InOb to identify the links between the webpages of the InOb and the links to the other webpages.

Example B21 includes the method of examples A01-A23, B01-B20, and/or some other example(s) herein, wherein the network addresses is/are internet protocol (IP) addresses, telephone numbers in a public switched telephone number, a cellular network addresses, internet packet exchange (IPX) addresses, X.25 addresses, X.21 addresses, Transmission Control Protocol (TCP) or User Datagram Protocol (UDP) port numbers, media access control (MAC) addresses, Electronic Product Codes (EPCs), Bluetooth hardware device addresses, a Universal Resource Locators (URLs), and/or email addresses.

Example Z01 includes one or more computer readable media comprising instructions, wherein execution of the instructions by processor circuitry is to cause the processor circuitry to perform the method of any one of examples A01-A23, B01-B21, and/or some other example(s) herein. Example Z02 includes a computer program comprising the instructions of example Z01. Example Z03a includes an Application Programming Interface defining functions, methods, variables, data structures, and/or protocols for the computer program of example Z02. Example Z03b includes an API or specification defining functions, methods, variables, data structures, protocols, etc., defining or involving use of any of examples A01-A23, B01-B21, or portions thereof, or otherwise related to any of examples A01-A23, B01-B21, or portions thereof. Example Z04 includes an apparatus comprising circuitry loaded with the instructions of example Z01. Example Z05 includes an apparatus comprising circuitry operable to run the instructions of example Z01. Example Z06 includes an integrated circuit comprising one or more of the processor circuitry of example Z01 and the one or more computer readable media of example Z01.

Example Z07 includes a computing system comprising the one or more computer readable media and the processor circuitry of example Z01. Example Z08 includes a computing system of example Z07 and/or one or more other example(s) herein, wherein the computing system is a System-in-Package (SiP), Multi-Chip Package (MCP), a System-on-Chips (SoC), a digital signal processors (DSP), a field-programmable gate arrays (FPGA), an Application Specific Integrated Circuits (ASIC), a programmable logic device (PLD), a complex PLD (CPLD), a Central Processing Unit (CPU), a Graphics Processing Unit (GPU), and/or the computing system comprises two or more of SiPs, MCPs, SoCs, DSPs, FPGAs, ASICs, PLDs, CPLDs, CPUs, GPUs interconnected with one another

Example Z09 includes an apparatus comprising means for executing the instructions of example Z01. Example Z10 includes a signal generated as a result of executing the instructions of example Z01. Example Z11 includes a data unit generated as a result of executing the instructions of example Z01. Example Z12 includes the data unit of example Z11 and/or some other example(s) herein, wherein the data unit is a datagram, network packet, data frame, data segment, a Protocol Data Unit (PDU), a Service Data Unit (SDU), a message, or a database object. Example Z13 includes a signal encoded with the data unit of examples Z11 and/or Z12. Example Z14 includes an electromagnetic signal carrying the instructions of example Z01. Example Z15 includes an apparatus comprising means for performing the method of any one of examples A01-A23, B01-B21, and/or some other example(s) herein.

Any of the above-described examples may be combined with any other example (or combination of examples), unless explicitly stated otherwise. Implementation of the preceding techniques may be accomplished through any number of specifications, configurations, or example deployments of hardware and software. It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together, but may comprise disparate instructions stored in different locations which, when joined logically together, comprise the component or module and achieve the stated purpose for the component or module. Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center), than that in which the code is deployed (e.g., in a computer embedded in a sensor or robot). Similarly, operational data may be identified and illustrated herein within components or modules, and may be embodied in any suitable form and organized within any suitable type of data structure. The operational data may be collected as a single data set, or may be distributed over different locations including over different storage devices, and may exist, at least partially, merely as electronic signals on a system or network. The components or modules may be passive or active, including agents operable to perform desired functions.

### 13. Terminology

The terminology used herein is for the purpose of describing particular embodiments only and is not intended to be limiting of the disclosure. The present disclosure has been described with reference to flowchart illustrations and/or block diagrams of methods, apparatus (systems), and/or computer program products according to embodiments of the present disclosure. In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” which may each refer to one or more of the same or different embodiments. Furthermore, the terms “comprising,” “including,” “having,” and the like, as used with respect to embodiments of the present disclosure, are synonymous.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “circuitry” refers to a circuit or system of multiple circuits configurable or operable to perform a particular function in an electronic device. The circuit or system of circuits may be part of, or include one or more hardware components, such as a logic circuit, a processor (shared, dedicated, or group) and/or memory (shared, dedicated, or group), an ASIC, a FPGA, programmable logic controller (PLC), SoC, SiP, multi-chip package (MCP), DSP, etc., that are configurable or operable to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. The term “processor circuitry” may refer to one or more application processors, one or more baseband processors, a physical CPU, a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “memory” and/or “memory circuitry” as used herein refers to one or more hardware devices for storing data, including RAM, MRAM, PRAM, DRAM, and/or SDRAM, core memory, ROM, magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data. “Computer-readable storage medium” (or alternatively, “machine-readable storage medium”) may include all of the foregoing types of memory, as well as new technologies that may arise in the future, as long as they may be capable of storing digital information in the nature of a computer program or other data, at least temporarily, in such a manner that the stored information may be “read” by an appropriate processing device. The term “computer-readable” may not be limited to the historical usage of “computer” to imply a complete mainframe, mini-computer, desktop, wireless device, or even a laptop computer. Rather, “computer-readable” may comprise storage medium that may be readable by a processor, processing device, or any computing system. Such media may be any available media that may be locally and/or remotely accessible by a computer or processor, and may include volatile and non-volatile media, and removable and non-removable media.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “element” refers to a unit that is indivisible at a given level of abstraction and has a clearly defined boundary, wherein an element may be any type of entity including, for example, one or more devices, systems, controllers, network elements, modules, etc., or combinations thereof. The term “device” refers to a physical entity embedded inside, or attached to, another physical entity in its vicinity, with capabilities to convey digital information from or to that physical entity. The term “entity” refers to a distinct component of an architecture or device, or information transferred as a payload. The term “controller” refers to an element or entity that has the capability to affect a physical entity, such as by changing its state or causing the physical entity to move.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configurable or operable to share computing and/or networking resources.

The term “architecture” as used herein refers to a computer architecture or a network architecture. A “network architecture” is a physical and logical design or arrangement of software and/or hardware elements in a network including communication protocols, interfaces, and media transmission. A “computer architecture” is a physical and logical design or arrangement of software and/or hardware elements in a computing system or platform including technology standards for interacts therebetween.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “cloud computing” or “cloud” refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like). The term “computing resource” or simply “resource” refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, etc.), operating systems, virtual machines (VMs), software/applications, computer files, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The terms “instantiate,” “instantiation,” and the like as used herein refers to the creation of an instance. An “instance” also refers to a concrete occurrence of an object, which may occur, for example, during execution of program code.

The term “information object” (or “InOb”) refers to a data structure that includes one or more data elements. each of which includes one or more data values. Examples of InObs include electronic documents, database objects, data files, resources, webpages, web forms, applications (e.g., web apps), services, web services, media, or content, and/or the like. InObs may be stored and/or processed according to a data format. Data formats define the content/data and/or the arrangement of data elements for storing and/or communicating the InObs. Each of the data formats may also define the language, syntax, vocabulary, and/or protocols that govern information storage and/or exchange. Examples of the data formats that may be used for any of the InObs discussed herein may include Accelerated Mobile Pages Script (AMPscript), Abstract Syntax Notation One (ASN.1), Backus-Naur Form (BNF), extended BNF, Bencode, BSON, ColdFusion Markup Language (CFML), comma-separated values (CSV), Control Information Exchange Data Model (C2IEDM), Cascading Stylesheets (CSS), DARPA Agent Markup Language (DAML), Document Type Definition (DTD), Electronic Data Interchange (EDI), Extensible Data Notation (EDN), Extensible Markup Language (XML), Efficient XML Interchange (EXI), Extensible Stylesheet Language (XSL), Free Text (FT), Fixed Word Format (FWF), Cisco® Etch, Franca, Geography Markup Language (GML), Guide Template Language (GTL), Handlebars template language, Hypertext Markup Language (HTML), Interactive Financial Exchange (IFX), Keyhole Markup Language (KML), JAMscript, Java Script Object Notion (JSON), JSON Schema Language, Apache® MessagePackTM, Mustache template language, Ontology Interchange Language (OIL), Open Service Interface Definition, Open Financial Exchange (OFX), Precision Graphics Markup Language (PGML), Google® Protocol Buffers (protobuf), Quicken® Financial Exchange (QFX), Regular Language for XML Next Generation (RelaxNG) schema language, regular expressions, Resource Description Framework (RDF) schema language, RESTful Service Description Language (RSDL), Scalable Vector Graphics (SVG), Schematron, Tactical Data Link (TDL) format (e.g., J-series message format for Link 16; JREAP messages; Multifuction Advanced Data Link (MADL), Integrated Broadcast Service/Common Message Format (IBS/CMF), Over-the-Horizon Targeting Gold (OTH-T Gold), Variable Message Format (VMF), United States Message Text Format (USMTF), and any future advanced TDL formats), VBScript, Web Application Description Language (WADL), Web Ontology Language (OWL), Web Services Description Language (WSDL), wiki markup or Wikitext, Wireless Markup Language (WML), extensible HTML (XHTML), XPath, XQuery, XML DTD language, XML Schema Definition (XSD), XML Schema Language, XSL Transformations (XSLT), YAML (“Yet Another Markup Language” or “YANL Ain't Markup Language”), Apache® Thrift, and/or any other data format and/or language discussed elsewhere herein.

Additionally or alternatively, the data format for the InObs may be document and/or plain text, spreadsheet, graphics, and/or presentation formats including, for example, American National Standards Institute (ANSI) text, a Computer-Aided Design (CAD) application file format (e.g., “.c3d”, “.dwg”, “.dft”, “.iam”, “.iaw”, “.tct”, and/or other like file extensions), Google® Drive® formats (including associated formats for Google Docs®, Google Forms®, Google Sheets®, Google Slides®, etc.), Microsoft® Office® formats (e.g., “.doc”, “.ppt”, “.xls”, “.vsd”, and/or other like file extension), OpenDocument Format (including associated document, graphics, presentation, and spreadsheet formats), Open Office XML (OOXML) format (including associated document, graphics, presentation, and spreadsheet formats), Apple® Pages®, Portable Document Format (PDF), Question Object File Format (QUOX), Rich Text File (RTF), TeX and/or LaTeX (“.tex” file extension), text file (TXT), TurboTax® file (“.tax” file extension), You Need a Budget (YNAB) file, and/or any other like document or plain text file format.

Additionally or alternatively, the data format for the InObs may be archive file formats that store metadata and concatenate files, and may or may not compress the files for storage. As used herein, the term “archive file” refers to a file having a file format or data format that combines or concatenates one or more files into a single file or InOb. Archive files often store directory structures, error detection and correction information, arbitrary comments, and sometimes use built-in encryption. The term “archive format” refers to the data format or file format of an archive file, and may include, for example, archive-only formats that store metadata and concatenate files, for example, including directory or path information; compression-only formats that only compress a collection of files; software package formats that are used to create software packages (including self-installing files), disk image formats that are used to create disk images for mass storage, system recovery, and/or other like purposes; and multi-function archive formats that can store metadata, concatenate, compress, encrypt, create error detection and recovery information, and package the archive into self-extracting and self-expanding files. For the purposes of the present disclosure, the term “archive file” may refer to an archive file having any of the aforementioned archive format types. Examples of archive file formats may include Android® Package (APK); Microsoft® Application Package (APPX); Genie Timeline Backup Index File (GBP); Graphics Interchange Format (GIF); gzip (.gz) provided by the GNU Project™; Java® Archive (JAR); Mike O′Brien Pack (MPQ) archives; Open Packaging Conventions (OPC) packages including OOXML files, OpenXPS files, etc.; Rar Archive (RAR); Red Hat® package/installer (RPM); Google® SketchUp backup File (SKB); TAR archive (“.tar”); XPlnstall or XPI installer modules; ZIP (.zip or .zipx); and/or the like.

The term “data element” refers to an atomic state of a particular object with at least one specific property at a certain point in time, and may include one or more of a data element name or identifier, a data element definition, one or more representation terms, enumerated values or codes (e.g., metadata), and/or a list of synonyms to data elements in other metadata registries. Additionally or alternatively, a “data element” may refer to a data type that contains one single data. Data elements may store data, which may be referred to as the data element's content (or “content items”). Content items may include text content, attributes, properties, and/or other elements referred to as “child elements.” Additionally or alternatively, data elements may include zero or more properties and/or zero or more attributes, each of which may be defined as database objects (e.g., fields, records, etc.), object instances, and/or other data elements. An “attribute” may refer to a markup construct including a name-value pair that exists within a start tag or empty element tag. Attributes contain data related to its element and/or control the element's behavior.

The term “database object”, “data structure”, or the like may refer to any representation of information that is in the form of an object, attribute-value pair (AVP), key-value pair (KVP), tuple, etc., and may include variables, data structures, functions, methods, classes, database records, database fields, database entities, associations between data and/or database entities (also referred to as a “relation”), blocks and links between blocks in block chain implementations, and/or the like. The term “information element” refers to a structural element containing one or more fields. The term “field” refers to individual contents of an information element, or a data element that contains content. The term “data frame” or “DF” may refer to a data type that contains more than one data element in a predefined order.

The term “personal data,” “personally identifiable information,” “PII,” or the like refers to information that relates to an identified or identifiable individual. Additionally or alternatively, “personal data,” “personally identifiable information,” “PII,” or the like refers to information that can be used on its own or in combination with other information to identify, contact, or locate a person, or to identify an individual in context. The term “sensitive data” may refer to data related to racial or ethnic origin, political opinions, religious or philosophical beliefs, or trade union membership, genetic data, biometric data, data concerning health, and/or data concerning a natural person's sex life or sexual orientation. The term “confidential data” refers to any form of information that a person or entity is obligated, by law or contract, to protect from unauthorized access, use, disclosure, modification, or destruction. Additionally or alternatively, “confidential data” may refer to any data owned or licensed by a person or entity that is not intentionally shared with the general public or that is classified by the person or entity with a designation that precludes sharing with the general public.

The term “pseudonymization” or the like refers to any means of processing personal data or sensitive data in such a manner that the personal/sensitive data can no longer be attributed to a specific data subject (e.g., person or entity) without the use of additional information. The additional information may be kept separately from the personal/sensitive data and may be subject to technical and organizational measures to ensure that the personal/sensitive data are not attributed to an identified or identifiable natural person.

The term “application” may refer to a complete and deployable package, environment to achieve a certain function in an operational environment. The term “AI/ML application” or the like may be an application that contains some AI/ML models and application-level descriptions. The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure. The term “session” refers to a temporary and interactive information interchange between two or more communicating devices, two or more application instances, between a computer and user, or between any two or more entities or elements.

The term “network address” refers to an identifier for a node or host in a computer network, and may be a unique identifier across a network and/or may be unique to a locally administered portion of the network. Examples of network addresses include telephone numbers in a public switched telephone number, a cellular network address (e.g., international mobile subscriber identity (IMSI), mobile subscriber ISDN number (MSISDN), Subscription Permanent Identifier (SUPI), Temporary Mobile Subscriber Identity (TMSI), Globally Unique Temporary Identifier (GUTI), Generic Public Subscription Identifier (GPSI), etc.), an internet protocol (IP) address in an IP network (e.g., IP version 4 (Ipv4), IP version 6 (IPv6), etc.), an internet packet exchange (IPX) address, an X.25 address, an X.21 address, a port number (e.g., when using Transmission Control Protocol (TCP) or User Datagram Protocol (UDP)), a media access control (MAC) address, an Electronic Product Code (EPC) as defined by the EPCglobal Tag Data Standard, Bluetooth hardware device address (BD_ADDR), a Universal Resource Locator (URL), an email address, and/or the like.

The term “organization” or “org” refers to an entity comprising one or more people and/or users and having a particular purpose, such as, for example, a company, an enterprise, an institution, an association, a regulatory body, a government agency, a standards body, etc. Additionally or alternatively, an “org” may refer to an identifier that represents an entity/organization and associated data within an instance and/or data structure.

The term “intent data” may refer to data that is collected about users' observed behavior based on web content consumption, which provides insights into their interests and indicates potential intent to take an action. The term “engagement” refers to a measureable or observable user interaction with a content item or InOb. The term “engagement rate” refers to the level of user interaction that is generated from a content item or InOb. For purposes of the present disclosure, the term “engagement” may refer to the amount of interactions with content or InObs generated by an organization or entity, which may be based on the aggregate engagement of users associated with that organization or entity.

The term “session” refers to a temporary and interactive information interchange between two or more communicating devices, two or more application instances, between a computer and user, or between any two or more entities or elements. Additionally or alternatively, the term “session” may refer to a connectivity service or other service that provides or enables the exchange of data between two entities or elements. A “network session” may refer to a session between two or more communicating devices over a network, and a “web session” may refer to a session between two or more communicating devices over the Internet. A “session identifier,” “session ID,” or “session token” refers to a piece of data that is used in network communications to identify a session and/or a series of message exchanges.

Although the various example embodiments and example implementations have been described herein, it will be evident that various modifications and changes may be made to these aspects without departing from the broader scope of the present disclosure. Many of the arrangements and processes described herein can be used in combination or in parallel implementations. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. The present disclosure is not to be taken in a limiting sense, and the scope of various aspects is defined only by the appended claims, along with the full range of equivalents to which such claims are entitled.

1. One or more non-transitory computer readable media (NTCRM) comprising instructions for machine learning (ML), wherein execution of the instructions by a hardware processor is to cause the hardware processor to:
identify one or more features from training data comprising a set of information objects (InObs) with known classifications, each InOb of the set of InObs comprising one or more nodes, the one or more features including structural semantics for respective InObs of the set of InObs, the structural semantics comprising a data structure representative of relationships between the one or more nodes of the respective InObs;
train an ML model to identify classifications of InObs not among the set of InObs based on the features identified from the training data and the known classifications of the set of InObs;
identify features from an unclassified InOb with an unknown classification, the identified features of the unclassified InOb including a set of nodes of the unclassified InOb; and
apply the identified features of the unclassified InOb to the trained ML model to predict a classification for the unclassified InOb based on structural semantics of the unclassified InOb, the structural semantics of the unclassified InOb being based on relationships among nodes of the set of nodes.

2. The one or more NTCRM of claim 1, wherein the set of instructions, when executed by a hardware processor, further cause the hardware processor to:
generate a first set of vectors representing the features of the set of InObs;
use the first set of vectors and known classifications of the set of InObs to train the ML model;
generate a second set of vectors representing the features of the unclassified InOb; and apply the second set of vectors to the trained ML model to classify the unclassified InOb.

3. The one or more NTCRM of claim 1, wherein the structural semantics of the respective InObs includes relationships between nodes making individual InObs and relationships between nodes of different InObs.

4. The one or more NTCRM of claim 3, wherein the set of instructions, when executed by a hardware processor, further cause the hardware processor to:
analyze the InObs of the unclassified InOb to identify links between the InObs on the InOb and links with other InObs on the same InOb and links with InObs on other InObs; and
determine the structural semantics of the unclassified InOb based on the identified links.

5. The one or more NTCRM of claim 1, wherein the one or more features further comprise content semantics of the one or more nodes of the set of InObs.

6. The one or more NTCRM of claim 5, wherein the set of instructions, when executed by a hardware processor, further cause the hardware processor to:
analyze the InObs of the unclassified InOb to identify content types and topics in the InObs; and
identify the content semantics of the unclassified InOb based on the identified content types and topics in the InObs of the unclassified InOb.

7. The one or more NTCRM of claim 1, wherein the one or more features further comprise content interaction behavior features with InObs in the one or more nodes of the set of InObs.

8. The one or more NTCRM of claim 7, wherein the set of instructions, when executed by a hardware processor, further cause the hardware processor to:
identify user interaction events generated by the one or more nodes based on interactions with the one or more nodes of the set of InObs;
determine user interaction types based on the user interaction events; and
identify the content interaction behavior features based on the user interaction types of the set of InObs.

9. The one or more NTCRM of claim 1, wherein the one or more features further comprise types of users accessing the one or more nodes of the set of InObs, the types of users including device types used for accessing the one or more nodes.

10. The one or more NTCRM of claim 9, wherein the set of instructions, when executed by a hardware processor, further cause the hardware processor to:
identify network session events generated by the one or more nodes based on accesses of the one or more nodes the InObs;
determine user data from the network session events; and
identify the types of users accessing the InObs based on the determined user data.

11. An apparatus, comprising:
processor circuitry; and memory circuitry communicatively coupled to the processor circuitry, the memory circuitry having instructions stored thereon that, in response to execution by the processor circuitry, are operable to cause the processor circuitry to:
identify, using a trained machine learning (ML) model, one or more structural features of an information object (InOb), the trained ML model being trained on a training data set including a set of InObs, each InOb of the set of InObs comprising one or more nodes, and the trained ML model includes a data object indicating structural features of respective InObs of the set of InObs, the structural features are relationships between the one or more nodes of the respective InObs, and the data object is a representation of the relationships; and
predict a classification for the InOb based on the identified one or more structural features of the InOb.

12. The apparatus of claim 11, wherein the instructions, in response to execution by the processor circuitry, are further operable to cause the processor circuitry to:
identify user interaction events generated by the InOb or users that interact with the InOb,
determine user interaction types based on the user interaction events;
identify one or more content interaction behavior features for the InOb based on the determined user interaction types, the one or more content interaction behavior features being patterns of user interaction with content of the InOb.

13. The apparatus of claim 12, wherein the instructions, in response to execution by the processor circuitry, are further operable to cause the processor circuitry to:
generate a structural feature vector comprising the one or more structural features of the InOb;
generate a content interaction behavior feature vector comprising the one or more content interaction behavior features of the InOb; and
feed the structural feature vector and the content interaction behavior feature vector into the ML model to predict the classification for the InOb.

14. The apparatus of claim 13, wherein the user interaction events indicate an event type and an engagement metric, and each content interaction behavior feature in the content interaction behavior feature vector represents a percentage or average value of the engagement metric for an associated event type for a time period .

15. The apparatus of claim 13, wherein the one or more content interaction behavior features include one or more of a time of day, day of week, date, total amount of content consumed by respective users, percentages of different device types used for accessing the InOb, duration of time users spend on individual InObs of the InOb, total engagement the respective users have on the individual InObs, a number of distinct user profiles accessing the individual InObs versus a total number of user interaction events for the individual InObs, a dwell time, a scroll depth, a scroll velocity, and variance in content consumption over time.

16. The apparatus of claim 13, wherein, to generate the structural feature vector, the instructions, in response to execution by the processor circuitry, are further operable to cause the processor circuitry to:
generate respective structural feature vectors for each individual InOb of the InOb; and
average the respective structural feature vectors for each individual InOb to obtain the structural feature vector for the InOb.

17. The apparatus of claim 13, wherein, to generate the content interaction behavior feature vector, the instructions, in response to execution by the processor circuitry, are further operable to cause the processor circuitry to:
generate respective content interaction behavior feature vectors for each individual InOb of the InOb; and
average the respective content interaction behavior feature vectors for each individual InOb to obtain the content interaction behavior feature vector for the InOb.

18. The apparatus of claim 12, wherein the instructions, in response to execution by the processor circuitry, are further operable to cause the processor circuitry to: generate the one or more content interaction behavior features for the InOb based on types of businesses accessing InObs of the InOb.

19. The apparatus of claim 11, wherein the instructions, in response to execution by the processor circuitry, are further operable to cause the processor circuitry to: determine the one or more structural features of the InOb based on links between InObs of the InOb and links to other InObs of other InObs from the InObs of the InOb.

20. The apparatus of claim 19, wherein the instructions, in response to execution by the processor circuitry, are further operable to cause the processor circuitry to: analyze the InObs of the InOb to identify the links between the InObs of the InOb and the links to the other InObs.
